(19) United States
(12) Patent Application Publication
(10) Pub. No.: US 2025/0262517 A1
(43) Pub. Date: Aug. 21, 2025

(54) DEVICE AND METHODS FOR MEASURING AND ANALYZING GEOMETRY IN ICE SKATE BLADES

(71) Applicant: Velasa Sports, Inc., Acton, MA (US)

(72) Inventors: Joseph Patrick Tracy, Hutchinson, MN (US); Russell K. Layton, JR., Acton, MA (US); Daniel A. Beaudet, Lexington, MA (US); Ivan Perez-Petkov, Boston, MA (US); David Michael Lewis, JR., Burlington, MA (US)

(21) Appl. No.: 18/856,569

(22) PCT Filed: Apr. 14, 2023
(86) PCT No.: PCT/US2023/018655

§ 371 Date: Oct. 11, 2024

Related U.S. Application Data
(60) Provisional application No. 63/380,744, filed on Oct. 24, 2022.
(60) Provisional application No. 63/363,095, filed on Apr. 15, 2022.
(60) Provisional application No. 63/363,098, filed on Apr. 15, 2022.

(51) Int. Cl. A63C 3/10; A63C 1/30; B24B 3/00; B24B 47/22; B24B 49/12; G01B 5/00; G01B 11/27

(52) U.S. Cl. CPC A63C 3/10; A63C 1/303; B24B 3/003; B24B 47/22; B24B 49/12; G01B 5/0023; G01B 11/272

(57) ABSTRACT

An ice skate blade measurement device comprising a frame configured to couple to an ice skate blade; a measurement system configured to obtain measurement data associated with the ice skate blade; and a control system with computer-executable instructions configured to, when executed: determine, one or more measurements associated with geometry of the ice skate blade, and generate, an output based at least in part on the one or more measurements.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims the benefit of U.S. Provisional Patent Application No. 63/380,744, filed Oct. 24, 2022, U.S. Provisional Patent Application No. 63/363,095, filed Apr. 15, 2022, and U.S. Provisional Patent Application No. 63/363,098, filed Apr. 15, 2022, the entire contents of which are hereby incorporated by reference in its entirety.

### BACKGROUND

### Field

The present disclosure relates to the field of measuring geometry of ice skate blades.

### Description of the Related Art

In the area of ice skating, whether it is hockey, figure skating or other, the blades used on the skates are a critical component in the performance of the skater/athlete. The blades are generally sharpened and profiled to exact specifications. These specifications will be determined based on many factors, including but not limited to the skater's height, weight, ability, role, ice conditions (e.g., temperature), etc. These exact specifications may be different for each skater and will be key factors in the performance yielded from the blades.

Because of the criticality of the exact sharpening specifications, skate sharpeners typically have a calibration or alignment process performed prior to sharpening a skate blade. This usually involves the use of one of more devices being inserted into the sharpener machine to confirm alignment of the machine's critical components. Because mistakes can be made in these alignment steps and there are inaccuracies in the fabrication of components involved in the alignment process, including in the skate sharpener machine itself, users of skate sharpeners often confirm the final results of a skate sharpening operation with a separate device after the skate blade has been sharpened. A commonly accepted method of measuring a sharpened skate blade is with an edge checker. The common edge checker is a simple mechanical device that includes a measurement bar (a.k.a. a “tilt bar”) that is placed across the edges of the skate blade and this tilt bar is compared to a reference line on a static device (a.k.a. a “datum plate”) clamped to the blade being measured. When the edges are even, the bar will line up with indicator lines or features on the static device that is clamped to the skate blade. When the edges are uneven, the bar will be at a visible angle to the lines on the static device clamped to the blade. The amount of offset or displacement of the measurement bar can be correlated to a given amount of skate blade edge unevenness.

The skate blade sharpening industry is a large industry, with many technologies available for the sharpening of skates to precise specifications. However, there is a need for technologies to accurately, easily, and economically measure and track key parameters of the sharpening process and the resulting sharpened skate, as well as critical use and response statistics and provide feedback to the sharpener operator to allow precise adjustments to be made to the sharpening machine to achieve the desired results.

### SUMMARY

The present disclosure relates to an improved measurement device that can be used to measure the height difference between the edges of a skate blade. Since the measurement device is separate from the skate sharpening machine and is a reliable mechanical device, the measurement device can be relied upon by users to verify the final outcome of a skate sharpening operation. Even if a skate sharpener could be designed with the intention of always producing even edges after a skate sharpening, for example by including components that claim to provide automatic calibration or alignment of the skate sharpener to the skate blade, it will still be desirable to use the measurement device to determine the true measurement of the skate edges and verify that the skate edges are even. In other words, the external measurement device may operate as a final arbiter of accuracy of a skate sharpening operation.

According to some embodiments, the measurement device can be used to measure the edges of a skate blade without the need for user interpretation of angles or measurement lines. Additionally, according to some embodiments, the measurement device can indicate to the user the magnitude and direction of the adjustments necessary to configure a skate sharpening machine to produce even edges. Furthermore, the measurement device can be used in tandem with the skate sharpener to “zero” the calibration and alignment tool used by the skate sharpener machine so that any alignment process of the skate sharpener, either manual or automatic, would result in a measurement device reading of even edges when the sharpener was set up to produce even edges.

According to some embodiments, the measurement device utilizes an optical laser measurement design with customized software to characterize geometrical aspects of a skate blade which are important to the performance of the skater. These measurements can be used as feedback to the sharpening process to improve the skater's performance in ways that are not available with current technology. The measurement device may be capable of making the measurements on a skate with a skate blade attached or a skate blade without a skate boot attached.

According to some embodiments, a software application run on a user device may be used to receive and/or interpret measurements taken by the measurement device and to calculate adjustments needed for the sharpening machine to achieve desired skate sharpening results. According to some embodiments, the adjustments needed may be presented to the user of the measurement device via the user device and/or via an onboard display present on the measurement device. According to some embodiments, the measurement device may wireless communicate with one or more user device, which may be configured to run the software application. In some embodiments, the software application or a related software application may be embedded in the measurement device.

According to some embodiments, the measurement device is configured to be a “handheld” device. For example, the user will usually hold the measurement device in one hand and the skate blade in the other. The user may then place the device onto the skate blade. Once in the desired measurement location on the skate blade, the user may affix the measurement device to the skate blade with a clamping feature on the device.

### BRIEF DESCRIPTION OF THE DRAWINGS

The foregoing aspects and many of the attendant advantages of this disclosure will become more readily appreciated as the same become better understood by reference to the following detailed description, when taken in conjunction with the accompanying drawings. The accompanying drawings, which are incorporated in, and constitute a part of, this specification, illustrate embodiments of the disclosure. Embodiment of the present disclosure are illustrated by way of example, and not by way of limitation, in the figures of the accompanying drawings and in which like references indicate similar elements. According to common practice, the various features of the drawings discussed below are not necessarily drawn to scale. The drawings are provided to illustrate example embodiments described herein and are not intended to limit the scope of the disclosure.

FIG. 1A illustrates an example schematic side profile of a skate blade;

FIG. 1B illustrates a perspective view of a skate blade with a magnified view of a hollow in the bottom portion of the skate blade;

FIG. 1C illustrates an example schematic section view of the back of the skate blade;

FIG. 1D illustrates an example schematic section view of the back of the six skate blades;

FIG. 2A illustrates a side schematic view of a skate blade and a grinding wheel;

FIG. 2B illustrates a sharpening of a skate blade when the grinding wheel is centered on the width of the skate blade;

FIG. 2C illustrates a sharpening of a skate blade when the grinding wheel is not centered on the width of the skate blade;

FIG. 2D illustrates an example schematic views of skate blades with even edges and uneven edges;

FIG. 3A illustrates a front view of an embodiments an edge checker interacting with a skate blade;

FIG. 3B illustrates a perspective view of the edge checker of FIG. 3A interacting with the skate blade;

FIG. 3C illustrates a perspective view of the edge checker of FIG. 3A interacting with the skate blade;

FIG. 4A illustrates a schematic side view of a spherical lens;

FIG. 4B illustrates a schematic side view of an aspherical lens;

FIG. 5A illustrates a schematic diagram of an optic measurement system;

FIG. 5B illustrates a schematic diagram of an optic measurement system with a beamsplitter;

FIG. 6A illustrates a front perspective view of an embodiment of a measurement device;

FIG. 6B illustrates a front view of the measurement device of FIG. 6A;

FIG. 6C illustrates a back view of the measurement device of FIG. 6A;

FIG. 6D illustrates a left side view of the measurement device of FIG. 6A;

FIG. 6E illustrates a right side view of the measurement device of FIG. 6A;

FIG. 6F illustrates a top view of the measurement device of FIG. 6A;

FIG. 6G illustrates a bottom view of the measurement device of FIG. 6A;

FIG. 6H illustrates a back view of the measurement device of FIG. 6A with select components removed;

FIG. 6I illustrates the measurement device of FIG. 6A interacting with a skate blade;

FIG. 7A illustrates a schematic diagram of an optic measurement system at a first tilt bar angle;

FIG. 7B illustrates a schematic diagram of an optic measurement system at a second tilt bar angle;

FIG. 7C illustrates a schematic diagram of an optic measurement system at a third tilt bar angle;

FIG. 8A illustrates a method of using the measurement device of FIG. 6A to determine the delta height H between edges of a skate blade;

FIG. 8B illustrates a method of calibrating a skate sharpening machine using the measurement device of FIG. 6A;

FIG. 9A illustrates a top left side perspective view of a tilt bar;

FIG. 9B illustrates an exploded view of the tilt bar of FIG. 9A;

FIG. 9C illustrates a front view of the tilt bar of FIG. 9A;

FIG. 9D illustrates a back view of the tilt bar of FIG. 9A;

FIG. 9E illustrates a left side view of the tilt bar of FIG. 9A;

FIG. 9F illustrates a right side of the tilt bar of FIG. 9A;

FIG. 9G illustrates a top view of the tilt bar of FIG. 9A;

FIG. 9H illustrates a bottom view of the tilt bar of FIG. 9A;

FIG. 10A illustrates an inside isolation view of the front housing of the measurement device of FIG. 6A;

FIG. 10B illustrates an inside isolation view of the rear housing of the measurement device of FIG. 6A;

FIG. 10C illustrates the isolation view of FIG. 10A with an outline of the frame of the measurement device of FIG. 6A;

FIG. 10D illustrates the isolation view of FIG. 10B with an outline of the frame of the measurement device of FIG. 6A;

FIG. 11A illustrates a first user interface being presented on a user device;

FIG. 11B illustrates a second user interface being presented on a user device;

FIG. 11C illustrates a third user interface being presented on a user device;

FIG. 11D illustrates a fourth user interface being presented on a user device;

FIG. 11E illustrates a fifth user interface being presented on a user device;

FIG. 12 illustrates an embodiment of a computing system which may implement example embodiments of one or more components of the measurement device and/or affiliated systems.

FIG. 13A illustrates a generated geometric data user interface displayed on a user device;

FIG. 13B illustrates a blade profile user interface displayed on a user device;

FIG. 13C illustrates a sharpening response user interface displayed on a user device;

FIG. 14 illustrates a front perspective view of an embodiment of a measurement device interacting with a skate blade;

FIG. 15A illustrates a rear perspective view of an embodiment of a measurement device interacting with a skate blade;

FIG. 15B illustrates a front perspective view of the measurement device of FIG. 15A interacting with a skate blade;

FIG. 16A illustrate an embodiment of a measurement device being used to illustrate the image processing features of a software application;

FIG. 16B illustrates a skate blade analysis user interface being presented on a user device;

FIG. 16C illustrates a close up view of the measurement device of FIG. 16C to illustrate the image processing features of a software application;

FIG. 17A-17D illustrate skate blades including different profiles;

FIG. 17E illustrates a skate blade with a desired profile line;

FIG. 17F illustrates a skate blade with two tilt profile lines;

FIG. 18 illustrates an embodiment of a profiling component with a linear actuator of a computer-controlled profiling system; and

FIG. 19 illustrates an embodiment of a profiling component with a rotary actuator of a computer-controlled profiling system.

### DETAILED DESCRIPTION OF SOME EMBODIMENTS

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” or “another embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

### A. Overview

a. Skate Blade

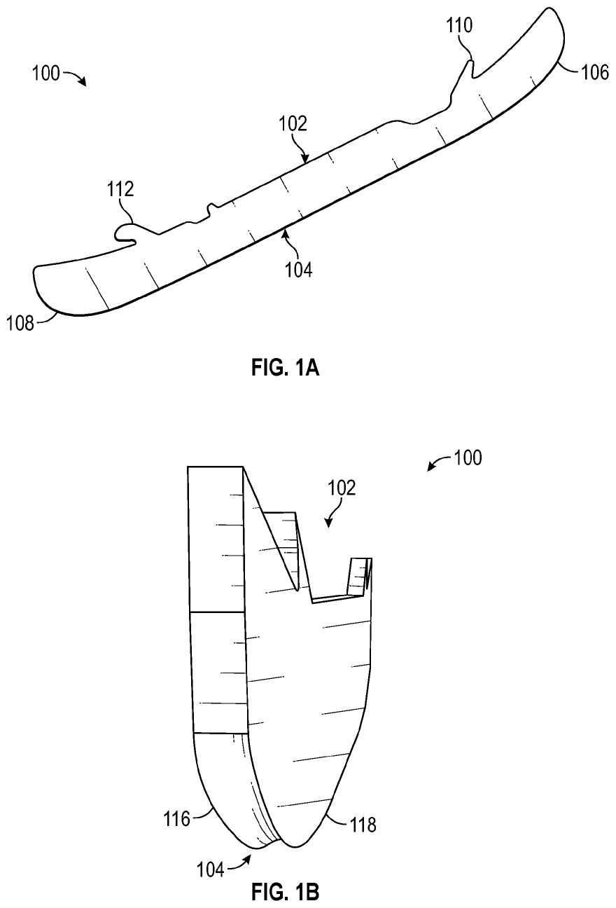

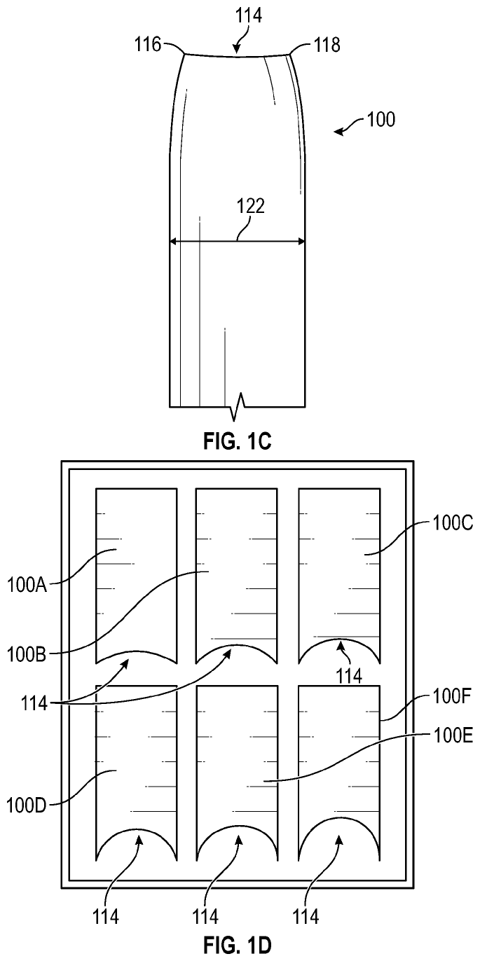

FIGS. 1A-1D illustrate different views and components of a skate blade 100.

FIGS. 1A-1D are provided for illustrative purposes only. FIG. 1A illustrates an example schematic side profile of the skate blade 100. The skate blade 100 comprises a top portion 102, a bottom portion 104, a front portion/toe 106, a back portion/heel 108. The top portion 102 comprises a toe plate 110 and a heel plate 112. The toe plate 110 and the heel plate 112 are configured to be inserted into the toe and heel of a skate boot respectively. Generally, the skate blade 100 is removable from the skate boot. For example, the skate blade 100 may be removed from the skate boot prior to being sharpened. As shown in FIG. 1C, the skate blade 100 has a blade thickness 122.

FIG. 1B illustrates a perspective view of the skate blade 100 with a magnified view of a hollow 114 in the bottom portion 104. The hollow 114 may also be referred to as a Radius of Hollow 114 or a ROH 114. The hollow 114 extends along the length of the bottom portion 104 between the toe 106 and the heel 108. The hollow 114 comprises two edges, an inside edge 116 and an outside edge 118. For example, the hollow 114 may be considered a groove between the edges 116, 118. In use, the edges 116, 118 of the skate blade 100 contact the ice, allowing the user to skate across the ice.

FIG. 1C illustrates an example schematic section view of the back of the skate blade 100. As shown in FIG. 1C, the hollow 114 between edges 116, 118 of the skate blade 100 has a small radius, which may be a result of use of the skate blade 100. As the skate blade 100 is continually used, the edges 116, 118 wear down over time, reducing the radius of the hollow 114. A skate blade 100 with overused edges and minimal hollow 114 does not perform as well as a sharpened skate blade.

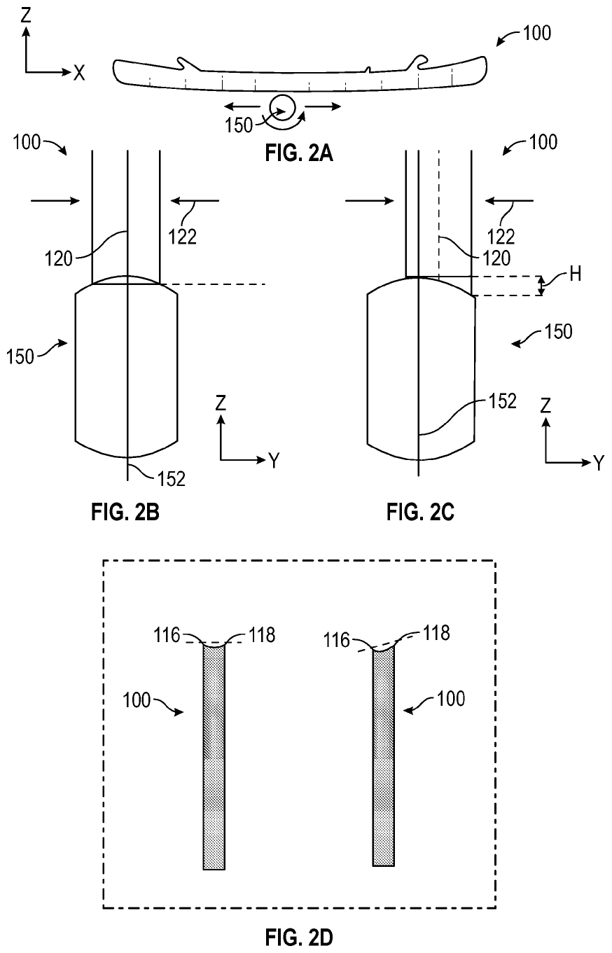

FIG. 1D illustrates an example schematic section view of the back of the six skate blades 100A-100F. Each skate blade 100 in FIG. 1D includes a hollow 114 with a different radius. As explained with reference to FIG. 2A, a grinding wheel can be used to grind a plurality of different radius size hollows 114 into the bottom portion 104 of the skate blades 100. Blade 100A comprises a hollow 114 of 1 inch, blade 100B comprises a hollow 114 of ¾ of an inch, blade 100C comprises a hollow 114 of ⅝ of an inch, blade 100D comprises a hollow 114 of ½ of an inch, blade 100E comprises a hollow of 7/16 of an inch, and blade 100F comprises a hollow of ⅜ of an inch. As shown in FIG. 1D, a small radius size of the hollow 114 is a result of less skate blade material between the edges 116, 118. Generally, a smaller radius size of the hollow 114 allows the skate blade to bite into the ice better, which may allow a skater to have tighter turns and quicker acceleration. However, because the edges 116, 118 are digging deeper into the ice, there is greater friction between the skate blade 100 and the ice, which may result in a loss of glide speed. Generally, skaters select a specific radius size for the hollow 114 for their specific needs, which may depend on their skating type, use of the skate (e.g., for figure skating, hockey, etc.), body type, and/or the like.

b. Grinding Wheel—Skate Blade Relationship

FIG. 2A illustrates a side schematic view of the skate blade 100 and a grinding wheel 150. Generally, skate sharpening devices include an abrasive/grinding wheel 150 that can be used to contact the skate blade 100 to grind the radius into the hollow 114 of the skate blade 100. In order to create the hollow 114, or reduce the radius of the hollow 114, the grinding wheel 150 rotates in the plane of the skate blade 100 and contacts the bottom portion 104 of the skate blade 100 where blade material is to be removed. The grinding wheel 150 may also translate across the length of the skate blade 100 (e.g., from left to right and right to left in FIG. 2A), either by automated or manual means.

In skate sharpening, one of the critical parameters that affects the quality of the sharpening is the ability to accurately grind the hollow 114 (or any other shape) into the bottom portion 104 of the skate blade 100 that is nominally centered on the width W of the blade. Grinding the hollow 114 in an accurate manner to produce even edges 116, 118 is made difficult by the production tolerances of the components that make up the sharpening machine. An assembly of mechanical parts will generally be inaccurate to the desired nominal dimensions due to the inherent inaccuracy of the production/fabrication methods used. The stack-up of the inaccuracies in the parts will cause the edges 116, 118 of the sharpened skate blade 100 to also be imperfect. Even if a system is built to autocorrect for these inaccuracies, there may still be imperfections in those autocorrect or auto-alignment systems. If the hollow 114 being ground into the skate blade 100 is off center, due to, for example, the aforementioned inaccuracies, one edge 116/118 will be ground to a different height then the other edge 116/118. This condition will make it difficult to skate effectively even for the most elite skater.

FIGS. 2B and 2C illustrate front schematic views of the skate blade 100 and grinding wheel 150. The skate blade 100 has a central axis 120 that extends along the length of the skate blade 100 and is at the center of the width W and the blade thickness 122. Similarly, the grinding wheel 150 has a central axis 152. FIG. 2B illustrates a sharpening of the skate blade 100 when the grinding wheel 150 is centered on the width W of the skate blade 100. That is, the central axis 152 of the grinding wheel 150 is aligned with the central axis 120 of the skate blade 100. When the grinding wheel 150 and the skate blade 100 are aligned in this manner, the sharpening process results in the skate blade 100 having even edges 116, 118. For most skaters, even edges 116, 118 is desirable and may be considered a successful sharpening. For further clarity, edges 116, 118 are considered “even” when the delta height H between the edges 116, 118 is zero, substantially zero, or within an acceptable tolerance. For example, an acceptable tolerance may be a delta height H of less than 2 thou (0.002 inches).

FIG. 2C illustrates a sharpening of the skate blade 100 when the grinding wheel 150 is not centered on the width W of the blade. That is, the central axis 152 of the grinding wheel 150 in not aligned with the central axis 120 of the skate blade 100. When the grinding wheel 150 and the skate blade 100 are misaligned or offset in this manner, the sharpening process results in the skate blade 100 having uneven edges 116, 118. As noted above, the difference in height between the inside edge 116 and the outside edge 118 is referred to as the delta height H. For most skaters, uneven edges 116, 118 is not desirable and may be considered an unsuccessful sharpening. An unsuccessful sharpening may result from the delta height H being greater than the acceptable tolerance, for example, greater than 2 thou. It is recognized that the acceptable tolerance can vary between different skates, different skaters, and different skate sharpening machines, and the ranges provided for the acceptable tolerance are for example only. The acceptable tolerance can be referred to as sharpening threshold.

FIG. 2D illustrates an example front schematic view of the skate blade 100 with an acceptable sharpening result (e.g., even edges 116, 118 where the delta height H is at or below a sharpening threshold) on the left, and an example front schematic view of the skate blade 100 with an unacceptable sharpening result (e.g., uneven edges 116, 118 where the delta height H exceeds a sharpening threshold) on the right.

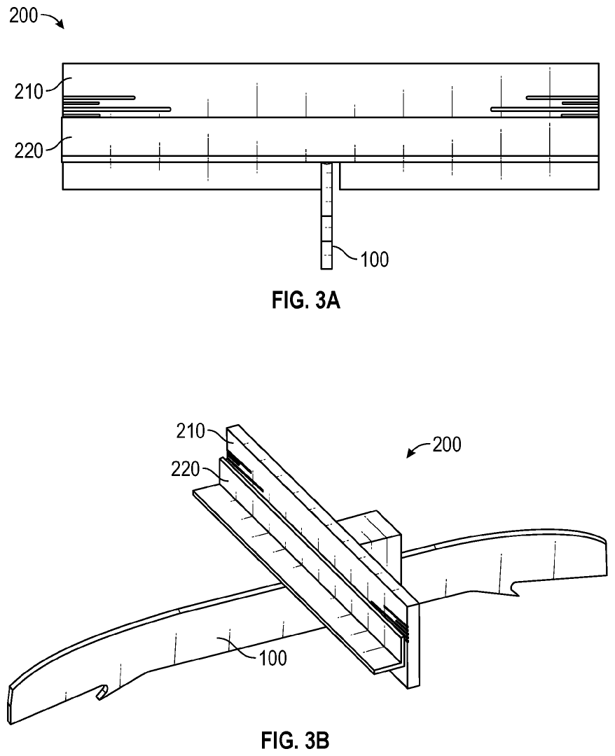

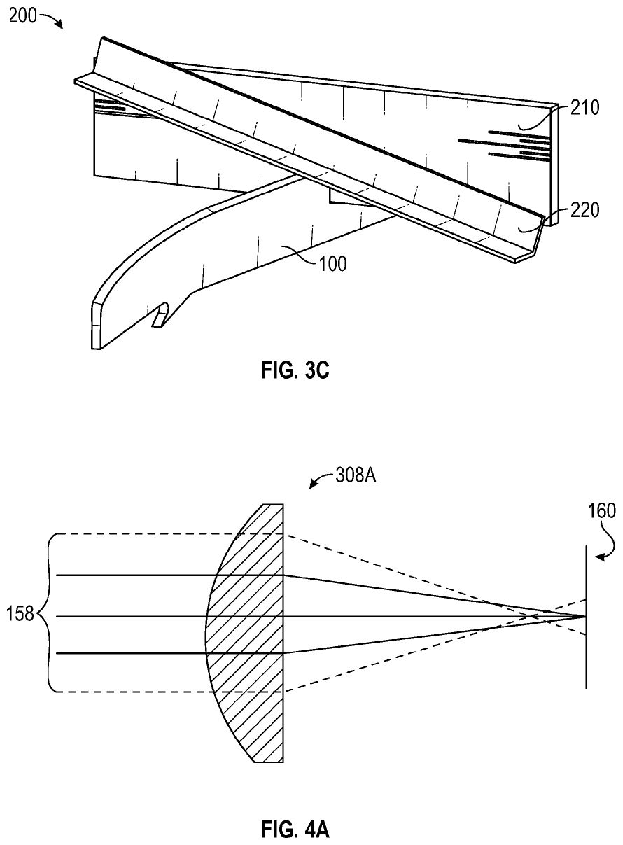

FIGS. 3A-3C illustrate embodiments an edge checker 200 interacting with the skate blade 100. The edge checker 200 represents the current state of the art in measuring the difference in edge heights of a skate blade. FIGS. 3A and 3B illustrate the edge checker 200 being used to measure the difference in height between the edges 116, 118 of the skate blade 100. In FIGS. 3A and 3B, the edges 116, 118 are even. In FIG. 3C, the edges 116, 118 are uneven. It is recognized that FIG. 3C shows an exaggerated view of uneven edges 116, 118 for illustrative purposes only.

The edge checker 200 can be used to measure this delta height H of the edges 116, 118. As noted above, the delta height H refers to the relative difference in height of the inside edge 116 and the outside edge 118. This technology is a very simple combination of a datum plate 210 that is clamped to the skate combined with a separate tilt bar 220 that rests on the edges 116, 118 of the skate blade 100. If the edge heights are not equal, the tilt bar 220 shows an angle relative to the datum plate 210. For example, the angle of the separate tilt bar 220 relative to the datum plate 210 in FIG. 3C illustrates the edges 116, 118 are not even and that a delta height H exists.

There are several limitations of the current state of the art for edge checking (i.e., by using the edge checker 200). One limitation of using the edge checker 200 is the resolution of the measurement. The tilt bar method relies on the user to visually look at the angle of the tilt bar 220 relative to the lines on the datum plate 210. As a result, the measurement process is limited to what the human eye can detect in addition to being a subjective process that varies between different users. Further, there is a finite delta height H that a user can detect. Use of the edge checker 200 can result in a skate blade having a delta height H that is outside of an acceptable tolerance range (e.g., a sharpening threshold) that is undetected by the user.

Another drawback of the edge checker 200 is that a user must attempt to use the reading displayed on the separate tilt bar 220 to determine how to adjust skate sharpening equipment in order to produce even edges 116, 118. There are several factors that make this determination difficult as each factor affects the adjustment needed. For example, some factors can include: the orientation of the skate blade 100 in the sharpener, the orientation of the edge checker 200 on the skate blade 100, the size of the hollow 114 being ground in, and the specific method of adjustment for the sharpener.

Use of the edge checker 200 often results in a skate sharpener (i.e., the user operating the machine) running through an iterative process of sharpening the skate blade 100, edge checking (e.g., measuring the delta height H) using the edge checker 200, interpreting the results of the edge checker 200, adjusting or calibrating the skate sharpener for another sharpening operation, and so forth. Edge checking is part of this process as operators of skate sharpening machines and users of the skates will want verification that the sharpener performed the sharpening operation accurately.

Interpreting the results of the edge checker 200 and determining the modifications necessary for the skate sharpening machine based on the results requires skill and has many shortcomings as noted above and further detailed here. For example, to interpret the edge checker 200 and determine the required skate sharpening device modifications, the user must have intimate knowledge of how the skate sharpening machine works and how the machine can be adjusted. The user of the edge checker 200 must understand both the magnitude of the edge checker 200 reading and the magnitude and direction of any adjustments to the sharpener. Because of the inaccurate nature of all of the user estimates involved, the iterative process described above is generally repeated many times before a desired sharpening results. Further disadvantages of using the edge checker 200 include: users often miscalculating or incorrectly estimating the corrections to the skate sharpener needed, which leads to users producing bad sharpening results, the confusion is frustrating for the operator of the sharpening machine and the person waiting for their skates, often leading to a longer skate sharpening process than necessary, and the constant recalibrating and re-sharping results in a waste of the steel of the skate blade 100 and a waste of the grinding wheel 150, often reducing the lifetime of both the skate blade 100 and the grinding wheel 150 unnecessarily.

### B. Measurement Devices

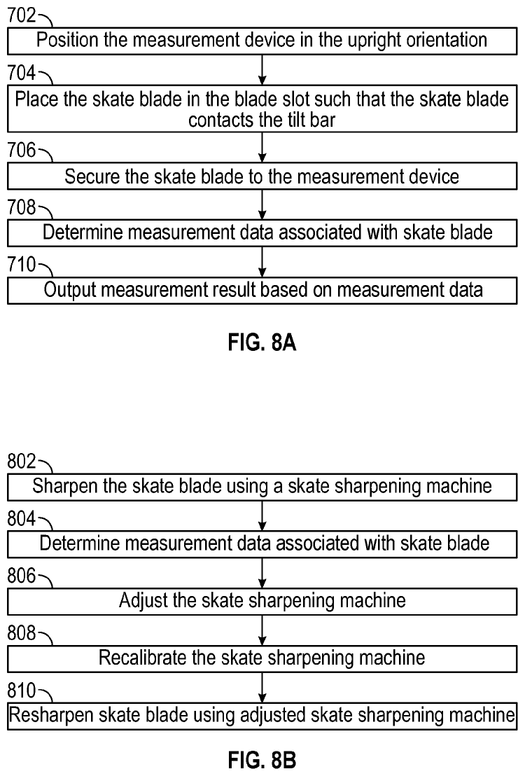

One or more of the disadvantages/limitations of the using the edge checker 200 in skate sharpening discussed above may be overcome or eliminated by use of a measurement devices described herein. For example, as discussed further herein, the measurement devices can be used to eliminate confusion in the sharpening process and deliver a more precise skate sharpening. For example, the measurement devices may be configured to measure the amount of height difference (e.g., the delta height H) between the two edges 116, 118 of a sharpened skate blade with a high degree of precision. In another example, measurement devices may be configured to determine the delta height H without the need for a user to interpret a visible indicator (e.g., the tilt bar 220) against a measurement grid (e.g., the datum plate 210). In some examples, the measurement devices described herein may be used with additional associated software (e.g., a sharpener application run on a computing device) to receive a digital reading from the measurement device, combine the digital reading with other data (e.g., radius of the hollow 114 of a sharpening, sharpener adjustment parameters, the direction of skate blade 100 in a sharpener, direction of measurement devices on the skate blade 100, etc.) to determine the adjustments necessary for the sharpener to provide a skate sharpening with even edges 116, 118. In some examples, the adjustments to the skate sharpener may be performed manually, semi-automatically, and/or automatically as described further herein, particularly with reference to FIGS. 8A and 8B.

a. Lens Behavior

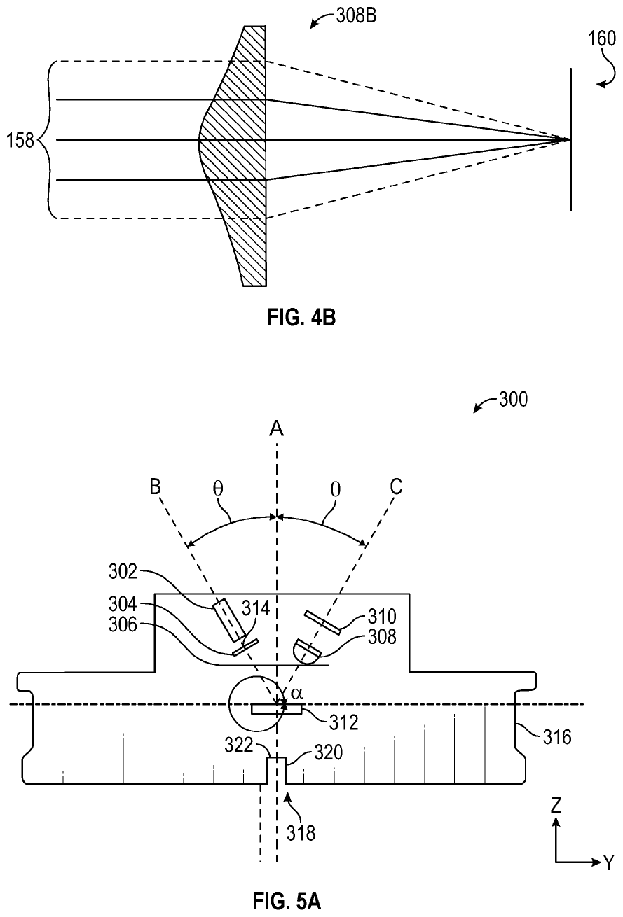

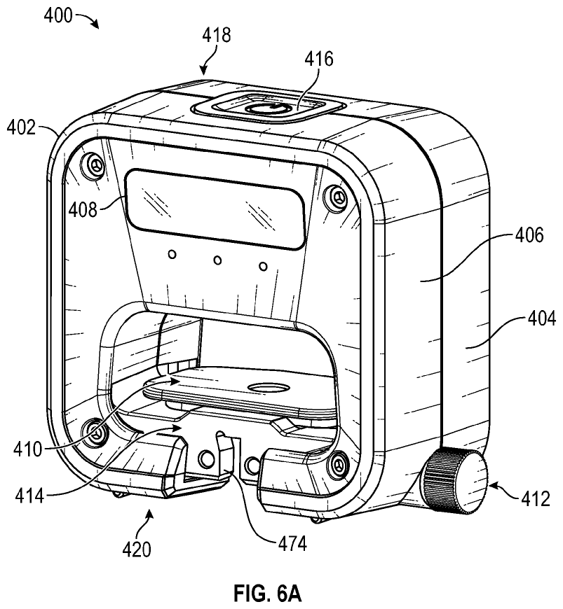

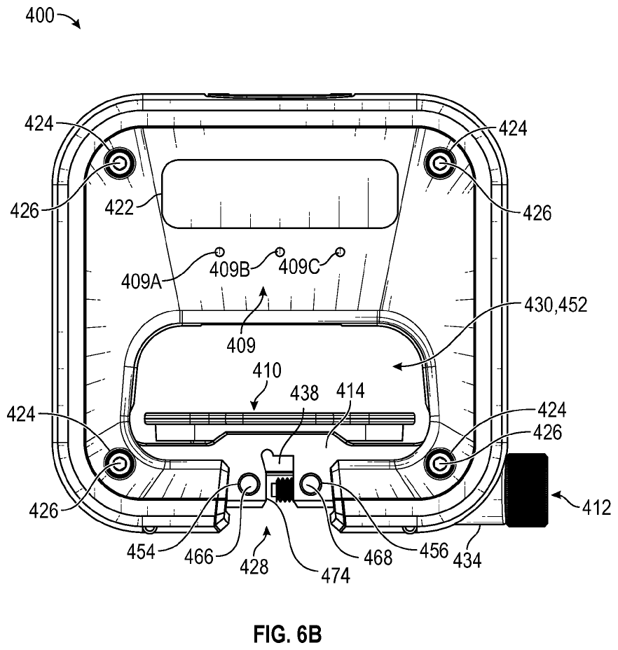

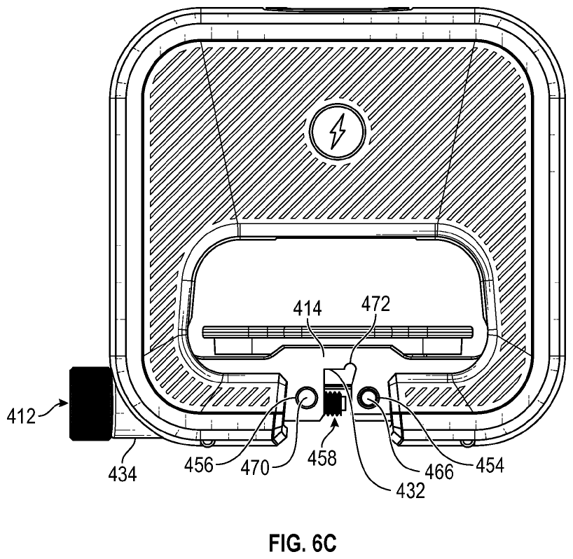

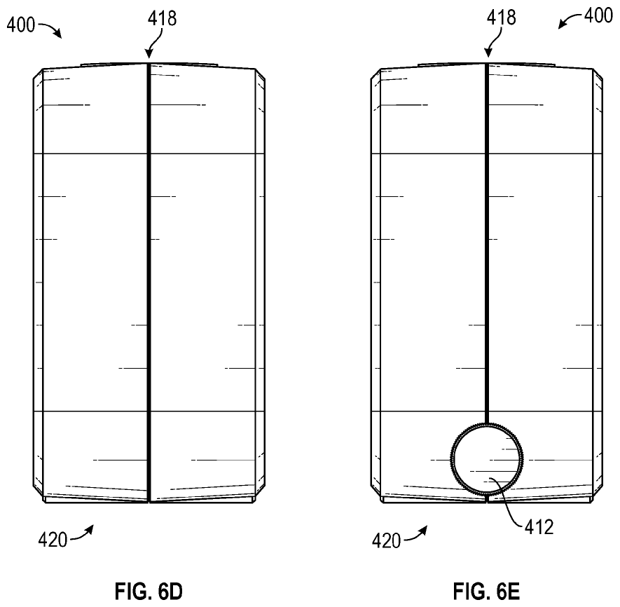

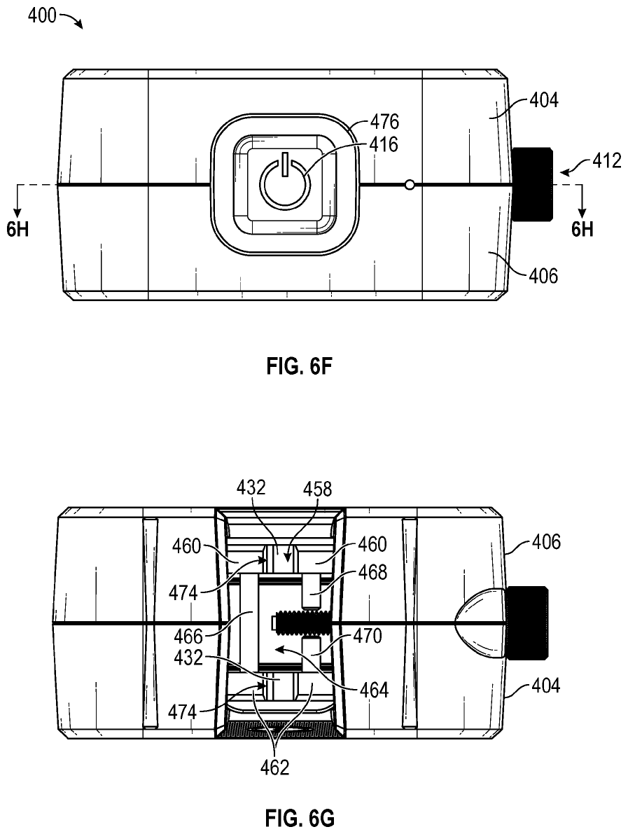

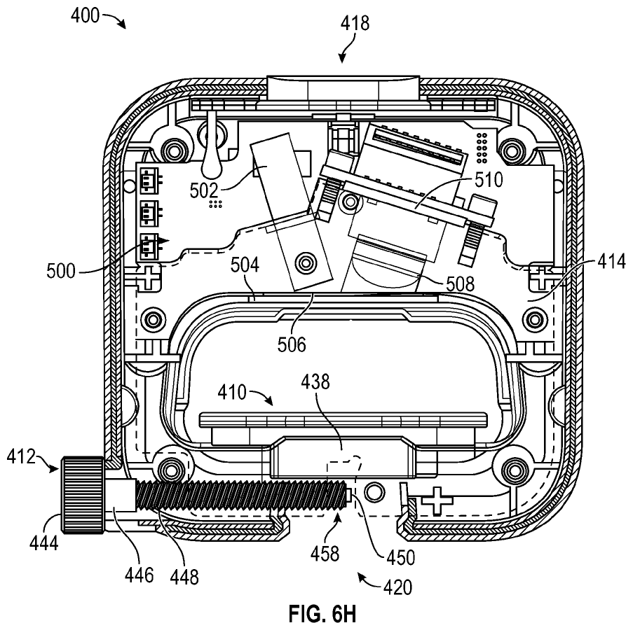

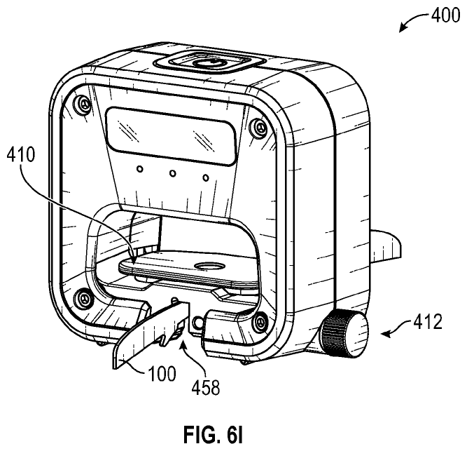

FIGS. 4A and 4B illustrate schematic side view of lens 308A and 308B respectively. As described further herein, some embodiments of the measurement devices (e.g., measurement device 400) include a lens 508 (see e.g., FIG. 6H). The lens 308A is a spheric lens and the lens 308B is an aspheric lens. Generally, the measurement device 400 includes an aspheric lens similar to the lens 308B. Use of the lens 508 in the measurement device 400 is described further with reference to at least FIG. 6H.

As shown in FIG. 4A, with the spheric lens 308A, light rays 158 entering the spheric lens 308A parallel but offset to each other create a spherical aberration where the light rays 158 are not focused at the same point on an image plane 160. In the measurement devices described herein, it is generally desirable that light rays 158 entering the lens 508 at a constant angle be focused to the same point (i.e., no spherical aberrations). Since the spheric lens 308A does not behave in this manner, it is generally desirable to use an aspheric lens, such as aspheric lens 308B.

As shown in FIG. 4B, with the aspheric lens 308B, light rays 158 entering the aspheric lens 308B parallel but offset to each other do not create a spherical aberration, such that the light rays 158 are focused at the same point on the image plane 160. This behavior is a result of the curvature of the aspheric lens 308B. For example, the aspheric lens 308B is shaped to ensure that parallel light rays 158 contacting the lens at different locations, will be focused to the same point. In some configurations, the measurement devices disclosed herein utilize this behavior of aspheric lens 308B. As described further herein, the measurement devices may use the aspheric lens 308B to provide for use of a custom optical path design which positions the angle of a light emitting source (e.g., see laser 502 in FIG. 6H) incident on the target relative to the angle of the aspheric lens' 308B focal axis, and positioning the focal axis of the aspheric lens 308B perpendicular to the plane of a sensor.

b. Measurement Device Schematic Diagrams

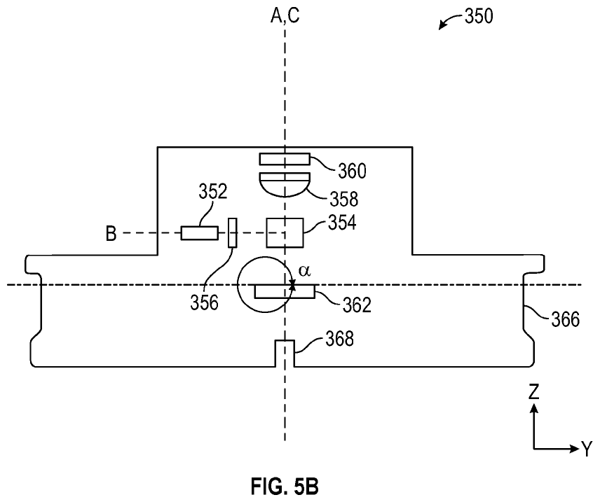

FIG. 5A illustrates a schematic diagram of an optic measurement system 300. FIG. 5B illustrates a schematic diagram of an optic measurement system 350. Either the optic measurement system 300 or the optic measurement system 350 can be utilized in the measurement devices described herein (e.g., measurement device 400 of FIG. 6A). Both the optic measurement system 300 and the optic measurement system 350 may utilize the principle of autocollimation. For example, the optic measurement system 300 and the optic measurement system 350 can include optical setups or arrangement where a collimated beam leaves an optical system and is reflected back into the same system by a reflective surface. Autocollimation can be desirable for measuring small tilting angles of the reflective surface.

With reference to FIG. 5A, the optic measurement system 300 includes a light emitting source, such as laser 302, an aperture plate 304, a filter 306, a lens 308, a sensor 310, a target 312, and a datum plate 316. The light emitting source may be any suitable light emitting source that can generate a beam of light or a laser beam. In some examples, it may be desirable for the light emitting source to be a collimated laser. A collimated laser can be configured to generate a collimated beam of light that propagates in homogeneous mediums (e.g., air) with a low beam divergence. Low beam divergence may be desirable so that the beam radius does not undergo significant changes within moderate propagation distances.

The aperture plate 304 can include an aperture 314. The aperture 314 can be configured to reduce the spot size of the laser 302 on the target 312. Reducing the spot size of the laser 302 on the target 312 may be desirable because if the spot size on the target 312 is too large. In which case, the imaged spot on the sensor 310 can take up too much area of the sensor 310 and can make it difficult to resolve small changes in an angle α of the target 312. In some examples, the aperture 314 may be approximately circular shaped and may have a diameter between 250 μm and 1000 μm, between 350 μm and 850 μm, between 500 μm and 700 μm, or any other values or ranges of values between the foregoing. It is recognized that the size of the aperture 314 may vary between different embodiments of the measurement devices described herein and may be dependent on the type of laser 302, filter 306, lens 308, sensor 310, and/or the target 312 used in the measurement device. The size of the aperture 314 may also be dependent on the relative angles and distances between the components of the optic measurement system 300. Generally, the aperture 314 can be used to reduce the spot size of the laser 302 to a size that is proportional to the sensor 310 area and resolution required by the optic measurement system 300.

The filter 306 may be any suitable optical filter, such as, for example, a polarizing filter. The filter 306 may be configured to optimize the measurement of the position of the laser spot on the sensor 310. For example, the filter 306 may be used to optimize the signal to noise ratio. In the optic measurement system 300, the “signal” is the laser beam that is reflected from the target 312 into the sensor 310 and the “noise” is any other light or additional portion of the reflected light that can make it difficult for the hardware and/or software of the sensor 310 to accurately determine the center of the laser beam. Noise in the optic measurement system 300 may be generated in a number of ways. For example, noise may comprise light in the environment where the measurement device is being used that is not generated from the laser 302, such as light from the sky, light from room lights, etc. In another example, noise may comprise light from the laser 302 itself that is unstructured or “messy”, such as reflected light from the target 312. In some example, the signal can be made stronger, and the noise can be reduced by using the filter 306 to filter at least a portion of the light going into the sensor 310 and/or at least a portion of the light generated by the laser 302. For example, to filter the light going into the sensor 310, the filter 306 may be configured to filter out wavelengths of light other than the wavelength(s) of the light generated by the laser 302. In another example, to filter out the unstructured portions of the laser beam itself, the filter 306 can be polarized, which may be desirable when using a collimated laser 302. For example, the polarizing filter 306 can help to prevent laser light that is reflected from the target 312 from spreading out into other directions, which may make the reflected laser spot on the sensor 310 messy.

While the example optic measurement system 300 shown in FIG. 5A includes the filter 306, the filter 306 is not required. However, it may be desirable for the optic measurement system 300 to include a filter 306 to prevent the sensor 310 from being over-saturated. Saturation, as the term is used herein, can refer to the level of light intensity incident on the sensor 310, relative to the level of light intensity the sensor 310 can process while generating accurate results. Similar to a person's eyes, if the light is too bright, the eyes will be over-saturated, and the person will have a difficult time seeing. If the intensity of the light is reduced to levels the human eye can handle, the person will be able to see better.

The lens 308 may use any suitable lens. For example, the lens 308 may be a spherical lens, an aspheric lens, and/or the like. As described above with reference to FIGS. 4A and 4B, in some embodiments, it may be desirable to for the lens 308 to be aspheric to eliminate spherical aberration of the laser beam generated by the laser 302.

The sensor 310 may be any suitable sensor for receiving the laser beam generated by the laser 302. For example, the sensor 310 may be a position sensitive detector (“PSD”), a charge coupled device (“CCD”), a complementary metal-oxide semiconductor (“CMOS”) device, and/or the like. When the sensor 310 receives the reflected laser beam, the light imaged onto the sensor 310 from the laser beam, referred to as the laser spot, can be converted into electrical signals. The type of electrical signal may be dependent on the electrical design specification for the particular sensor 310 used. The electrical signal may then be used to create an “image” of the light on the sensor 310. In some examples, the sensor 310 may be configured to determine the center of mass of a laser spot, and output the determined center of mass directly. In another example, the sensor 310 may be configured to output raw image values and the sensor's 310 software may then resolve the center of mass of the laser spot.

The target 312 may be any suitable material that is configured to reflect light. For example, the target 312 may be smooth, have a highly polished surface, have free electrons, and/or a surface having properties that result in a reflective surface. The target 312 may be, for example, a reflective bar that rests across the edges of a skate blade. In the example of FIG. 5A, the target 312 is a separate component that can rest on the skate blade (not shown). In some examples, the target 312 may be a separate component configured to couple to and/or be place adjacent to the skate blade (not shown). The datum plate 316 may include a slot 318 on a bottom portion of the datum plate 316. The slot 318 may be a generally rectangularly shaped recess of the datum plate 316. A sidewall 320 of the slot 318 may comprise the datum X and the top wall 322 of the slot 318 may comprise the datum Z. The sidewall 320 is configured to be at a 90 degree angle relative to the top wall 322.

The components of the optic measurement system 300 may be arranged relative a central axis A. The central axis A extends along and defines the vertical/z-axis. In FIG. 5A, components to the right of the central axis A are in the positive y-direction and components to the left of the central axis A are in the negative y-direction. In the optic measurement system 300, the laser 302 may be positioned on the left side of the central axis A with a laser axis B of the laser 302 being at an angle θ relative to the central axis A. The laser 302 is configured to generate a laser beam that travels along the laser axis B. The aperture plate 304 may be positioned below the laser 302 and at the same angle θ relative to the central axis A. In this orientation, the laser aperture 314 is aligned along the laser axis B and is configured to receive the laser beam. The sensor 310 may be positioned on the right side of the central axis A with a sensor axis C of the sensor 310 being at the angle θ relative to the central axis A. As noted above, the sensor 310 is configured to receive the laser beam that reflects off the target 312. When the target 312 is perpendicular to the central axis A (i.e., at a zero angle relative to the y-axis), the reflected laser beam travels along the sensor axis C and is received by the sensor 310. The lens 308 may be positioned on the right side of the central axis A below the sensor 310 and at the same angle θ relative to the central axis A. In this orientation, the lens 308 is aligned along the sensor axis C and is configured to receive the reflected laser beam before the sensor 310. The filter 306 may be positioned below the aperture plate 304 and below the lens 308 such that the filter 306 is between the aperture plate 304 and the target 312. In some examples, the filter 306 may be perpendicular to the central axis A (i.e., at a zero angle relative to the y-axis). The target 312 is positioned below the laser 302, aperture plate 304, filter 306, lens 308, and sensor 310. In use, the target 312 would be resting on a skate blade (not shown). For example, the target 312 operates in a similar manner to a portion of the tilt bar 410 (see e.g., FIGS. 6A-6G). The target 312 may be centered on the central axis A when the target 312 is at a zero angle relative to the y-axis. In this orientation, the central axis of the slot 318 is also aligned with the central axis A. The target 312 is configured to rotate about the y-axis (e.g., when the target 312 is a portion of a tilt bar) such that the target 312 can be at an angle α relative to the y-axis. When the target 312 is at a positive or negative angle, the reflected laser beam does not travel along the sensor axis C.

In operation, the laser 302 generates a laser beam that travels along the laser beam axis B through the aperture 314 of the aperture plate 304 and through the filter 306. The laser beam travels towards and is reflected by the target 312. The reflected laser light then travels through the filter 306 and the lens 308 and is received by the sensor 310. The optical path design of the laser 302, lens 308, and sensor 310 provides the ability to measure the angle α of the target 312 (and corresponding tilt bar). Once the sensor 310 receives the reflect laser beam, a control system (not shown) utilizing sensor software can determine the angle α of the target 312. For example, the control system may analyze data from the sensor 310 and determine the weighted center of mass of the laser spot received by the sensor 310. The weighted center of mass allows for the determination of the angle α of the target 312 based on the laser spot appearing at different locations on the sensor 310 as the angle of the target 312 changes. As explained further herein, the optic measurement system 300 can be used to determine a delta height H between the edges 116, 118 of the skate blade 100 when the skate blade 100 is inserted into the slot 318 and the target 312 is balanced on the edges 116, 118 via the top wall 322. When the edges 116, 118 of the skate blade 100 are even, the angle α of the target 312 will be approximately zero. Conversely, when the edges 116, 118 of the skate blade 100 are uneven, the angle α of the target 312 will be non-zero.

In the example illustrated in FIG. 5A, the angle θ of the laser 302 optical path (i.e., the laser axis B) relative to the central axis A is equal to the angle θ of the lens 308 and the sensor 310 optical path (i.e., the sensor axis C) relative to the central axis A. In other examples, the angle of the laser axis B relative to the central axis A may be different from the angle of the sensor axis C. When the angles are not equal, either a calibration routine or processing software can account for the offset in order to provide accurate measurements.

FIG. 5B illustrates a schematic diagram of the optic measurement system 350. The optic measurement system 350 includes light emitting source, such as a laser 352, a beam splitter 354, a filter 356, a lens 358, a sensor 360, a target 362 (which may be positioned on a tilt bar (not shown) or may represent the tilt bar itself), and a datum plate 366. The laser 352, filter 356, lens 358, sensor 360, target 362, and datum plate 366 of the optic measurement system 350 may be similar or identical to the laser 302, filter 306, lens 308, sensor 310, target 312, and datum plate 316 of the optic measurement system 300 respectively. For examples, the components of both the optic measurement system 300 and the optic measurement system 350 may operate in a similar manner. The optic measurement system 350 includes the beam splitter 354, which allows the components of the optic measurement system 350 to be mounted at right angles to each other.

The beam splitter 354 may comprise a cube or other suitable shape and may be formed from two triangular prisms that are coupled together. For example, the two triangular prisms may be glued together at their base using polyester, epoxy, urethane-based, and/or the like adhesives. Using the beam splitter 354 can have, potential advantages in mounting and setup compared to the optic measurement system 300. For example, the 90-degree configuration can make it easier to mount and align components of the optic measurement system 350 during assembly.

The components of the optic measurement system 350 may be arranged relative to a central axis A. The central axis A extends along and defines the vertical/z-axis. In FIG. 5B, components to the right of the central axis A are in the positive y-direction and components to the left of the central axis A are in the negative y-direction. In the optic measurement system 350, the laser 352 may be positioned on the left side of the central axis A with a laser axis B of the laser 302 being at a 90 degree angle relative to the central axis A. The laser 352 is configured to generate a laser beam that travels along the laser axis B. In an example where the optic measurement system 350 includes an aperture plate, the aperture plate would be positioned between the laser 352 and the filter 356 at the same 90 degree relative to the central axis A. In this orientation, the laser aperture would be aligned along the laser axis B and would be configured to receive the laser beam. The filter 356 may be positioned to the right of laser 352 on the laser axis B and between the beam splitter 354 and the laser 352. The beam splitter 354 may be positioned such that the beam splitter 354 is centrally aligned with both the central axis A and the laser axis B. The beam splitter 354 may be positioned between the lens 358 and the target 362 on the central axis A.

The lens 358 may be positioned above the beam splitter 354 centrally on the central axis A below the sensor 360 and at a 90 degree angle relative to the central axis A. In this orientation, the lens 358 is aligned along the central axis A and is configured to receive the reflected laser beam before the sensor 360. The sensor 360 may be positioned above the lens 358 and centrally on the central axis A such that a sensor axis C is aligned with the central axis A. The sensor 360 is configured to receive the laser beam that reflects off the target 362 and travels through the beam splitter 354. When the target 362 is perpendicular to the central axis A (i.e., at a zero angle relative to the y-axis), the reflected laser beam travels along the central axis A and is received by the sensor 360. The target 362 is positioned below the laser 352, beam splitter 354, filter 356, lens 358, and sensor 360. The target 362 may be centered on the central axis A when the target 362 is at a zero angle relative to the y-axis. In this orientation, the central axis of the slot 368 is also aligned with the central axis A. The target 362 is configured to rotate about the y-axis such that the target 362 can be at an angle α relative to the y-axis. When the target 362 is at a positive or negative angle, the reflected laser beam does not travel along the central axis A.

In operation, the laser 352 generates a laser beam that travels along the laser beam axis B (optionally through an aperture of an aperture plate) through the filter 356. The laser beam travels towards and is reflected by the beam splitter 354 and travels towards the target 362. The reflected laser light then travels back through the beam splitter 354, through the lens 358 and is received by the sensor 360. The optical path design of the laser 352, lens 358 and sensor 360 provides the ability to measure the angle α of the target 362. Once the sensor 360 receives the reflect laser beam, a control system (not shown) utilizing sensor software can determine the angle α of the target 362. For example, the control system may analyze data from the sensor 360 and determine the weighted center of mass of the laser spot received by the sensor 360. The weighted center of mass allows for the determination of the angle α of the target 362 based on the laser spot appearing at different locations on the sensor 360 as the angle of the target 362 changes. As explained further herein, the optic measurement system 350 can be used to determine a delta height H between the edges 116, 118 of the skate blade 100 when the skate blade 100 is inserted into the slot 368 of the datum plate 366 and the target 362 is balanced on the edges 116, 118 via the top wall 322. When the edges 116, 118 of the skate blade 100 are even, the angle α of the target 362 will be approximately zero. Conversely, when the edges 116, 118 of the skate blade 100 are uneven, the angle α of the target 362 will be non-zero.

c. Measurement Device

FIGS. 6A-6H illustrate an embodiment of a measurement device 400. FIG. 6A illustrates a front perspective view of the measurement device 400. The measurement device 400 includes an external housing 402, a tilt bar 410, a securing mechanism 412, an internal frame 414 (also referred to herein as the frame 414), a power button 416, an optics system 500 (e.g., see FIG. 6H), and a control system (not shown). In some embodiments, the measurement device 400 may include a digital display, which may disposed within a portion or all of the area 408 illustrated in FIGS. 6A-6H. It is recognized that the measurement device 400 does not require a display and, in some examples, including the embodiment illustrated, the area 408 may be a deboss area which can be used to place a logo on, such as, for example, a sticker. In the example illustrated in FIGS. 6A-6H, the securing mechanism comprises a thumb screw 412. However, as explained further herein, the securing mechanism can comprise any suitable component that can be configured to secure the skate blade 100 within the blade slot 458 of the measurement device 400.

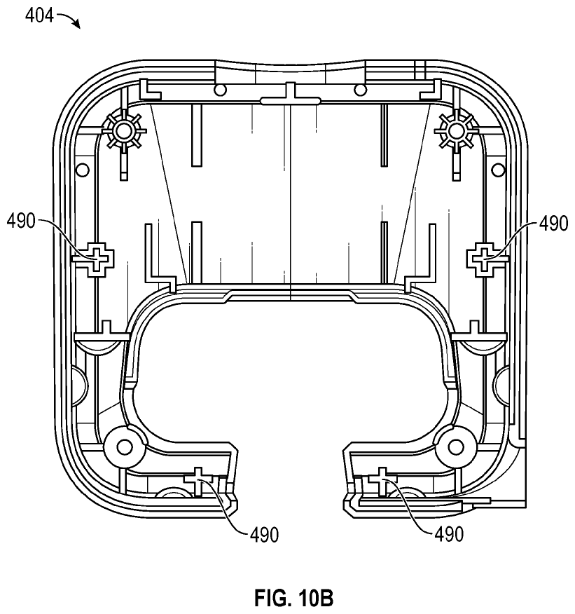

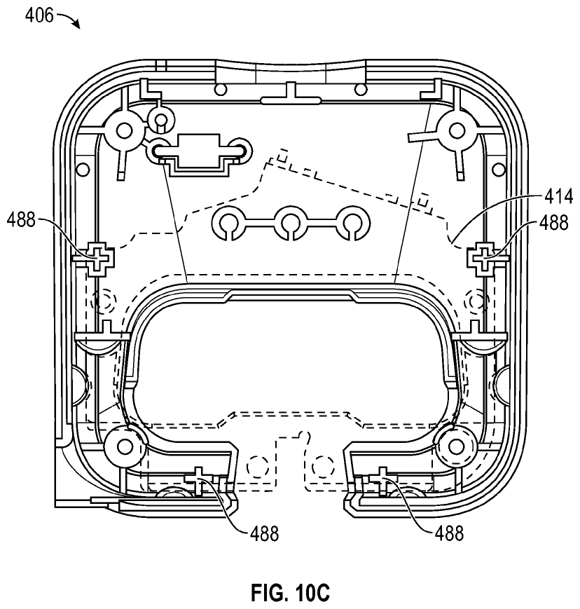

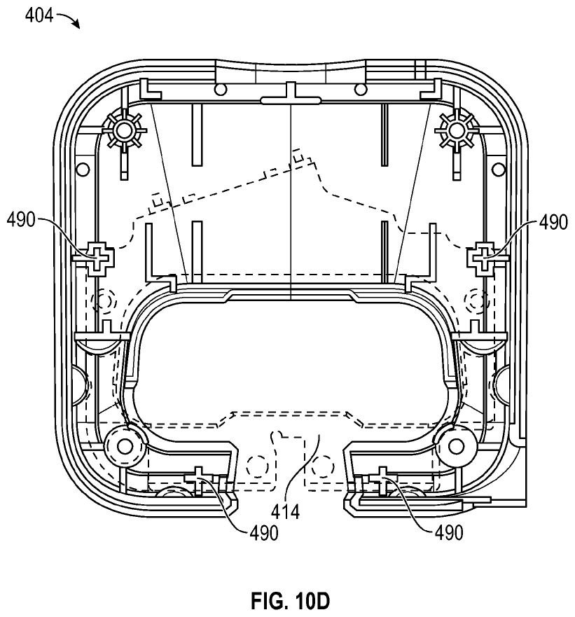

FIG. 6B illustrates a front view of the measurement device 400 and FIG. 6C illustrates a back view of the measurement device 400. As shown, the external housing 402 may comprise a rear housing 404 and a front housing 406. The external housing 402 may be roughly square shaped with rounded edges. However, it is recognized that the external housing 402 may be any suitable shape. The external housing 402 may be manufactured using any suitable material, such as, for example, one or more of: a plastic, a metal, a molded plastic, a rubber, a liquid silicone rubber molding, an over-molded rubber-like material, and/or the like. In some cases, it may be desirable for the measurement device 400 to be resistant to damage when the measurement device 400 is dropped from a normal operating height (e.g., less than 6 feet). As shown in FIGS. 6D and 6E, which illustrate a left side view and a right side view of the measurement device 400 respectively, the rear housing 404 and the front housing 406 may be coupled together to form the external housing 402. The external housing 402 may include a top side 418, a bottom side 420, an external aperture 430, and a screw extension 434. The external aperture 430 includes a hole extending through both the rear housing 404 and the front housing 406. The external aperture 430 may be any suitable shape. In the example illustrated in FIGS. 6A-6H, the external aperture 430 is roughly rectangularly shaped with rounded edges. The bottom side 420 includes an external gap 428. The external gap 428 may be joined to the external aperture 430 such that a continuous hole extends through the external housing 402 when the frame 414 is not positioned between the rear housing 404 and the front housing 406. The screw extension 434 may include a circular extension shaped to form a hole (not shown) extending out of the right side of the external housing 402 near the bottom side 420. The screw extension 434 is configured to be positioned around the thumb screw 412 and may be aligned with a hole (not shown) of the frame 414. Generally, there can be a clearance between the hole of the screw extension 434 and the thumb screw 412 such that the thumb screw 412 does not contact the screw extension 434 or the external housing 402 at all, even when the frame 414 moves within the measurement device 400, such as, when the measurement device 400 is dropped. This concept is explained further with reference to FIGS. 10A-10D.

The front housing 406 may include a recess 422 and a plurality of fastener holes 424. The recess 422 may include a recessed portion of the front housing to place a logo or a sticker. It is recognized that the recess 422 is optional and embodiments of the measurement device 400 may not include this feature. The plurality of fastener holes 424 may be recessed into the front housing 406. The plurality of fastener holes 424 are configured to receive the plurality of fasteners 426. The plurality of fasteners 426 may be bolts, screws, and/or other types of fasteners that are configured to secure the rear housing 404 to the front housing 406, with the frame 414 positioned between the rear housing 404 and front housing 406. In an embodiment of the measurement device 400 that includes a display, the display may be positioned in the recess 422.

FIG. 10A illustrates an inside isolation view of the front housing 406. The inside of the front housing 406 may comprise a plurality of front resilient members 488. In the example illustrated, the front housing 406 includes two front resilient members 488 on the bottom side and one front resilient member 488 on each the left side and the right side. However, it is recognized that the front housing 406 may include any number of front resilient members 488 in any number of different positions. The front resilient members 488 are configured to provide vibrational isolation to the frame 414, which houses the optics system 500. For example, the front resilient members 488 may be formed from or include a compliant material. In another example, the front resilient members 488 may include posts that are configured to receive a compliant material. In another example, the front resilient members 488 may be springs or a material with spring-like properties. As shown in FIG. 10C, an outline of the frame 414 is illustrated in position on the inside of the front housing 406. The front resilient members 488 engage with or are received within slots (not shown) in the sides of the frame 414, such that the frame 414 may be suspended between the resilient members 488, 490. As a result of this arrangement, the frame 414 can, under load, move relative to the external housing 402. For example, relative movement of the frame 414 may help to dissipate any shocks received by the measurement device 400. For example, if the measurement device 400 is dropped, the frame 414 can move relative to the external housing 402 as a result of the resilient members 488, 490, acting to dissipate the shock received and protect the optics system 500.

Similarly, FIG. 10B illustrates an inside isolation view of the rear housing 404. The inside of the rear housing 404 may include a plurality of rear resilient members 490. In the example illustrated, the rear housing 404 includes two rear resilient members 490 on the bottom side and one rear resilient member 490 on each the left side and the right side. However, it is recognized that the rear housing 404 may include any number of rear resilient members 490 in any number of different positions. The front rear resilient members 490 are configured to provide vibrational isolation to the frame 414, which houses the optics system 500. For example, like the front resilient members 488, the resilient members 490 may be a compliant material or may include posts that are configured to receive a compliant material. In another example, the resilient members 490 may include springs or a material with spring-like properties. As shown in FIG. 10D, an outline of the frame 414 is illustrated in position on the inside of the rear housing 404. The rear resilient members 490 engage with or are received within slots (not shown) in the sides of the frame 414, such that the frame 414 may be suspended between the resilient members 488, 490. As described above, this arrangement can protect the frame 414, by allowing the frame 414 to move, under load, relative to the external housing 402. Further, if the measurement device 400 is dropped, the rear resilient members 490 may act to dissipate the shock received by the measurement device 400 to protect the frame 414 and the optics system 500.

Referring back to FIGS. 6A and 6B, in some embodiments, the measurement device 400 may include one or more measurement indicators 409. For example, the measurement device 400 may include a first measurement indicator 409A, a second measurement indicator 409B, and a third measurement indicator 409C. It is recognized that the measurement device 400 can include any number of measurement indicators 409. The measurement indicators 409 may comprise lights such as, for example, LED lights, and may be controlled by the control system. The measurement indicators 409 may be configured to indicate to the user whether the edges 116, 118 of the skate blade 100 are even or uneven. In some examples, the measurement indicators 409 may further indicate how uneven edges 116, 118 are and/or which edge 116/118 is taller. In one example, the second measurement indicator 409B may be configured to indicate that the edge measurement was successful and the edges 116, 118 are within the acceptable tolerance (e.g., the delta height H is at or below a sharpening threshold). For example, the measurement indicators 409 may turn green (or any other color as desired) after the user measures the skate blade 100 edges 116, 118 to indicate to the user that the edges 116, 118 are within the acceptable tolerance (e.g., the sharpening threshold). The first measurement indicator 409A may be configured to indicate that the edges 116, 118 are not even and that the edge on the left side of the measurement device 400 is higher than the edge on the right side. Similarly, the third measurement indicator 409C may be configured to indicate that the edges 116, 118 are not even and that the edge on the right side of the measurement device 400 is higher than the edge on the left side. The measurement device 400 may include multiple thresholds configured to indicate different levels of the delta H measurements. For example, a first threshold may indicate that the blade edges are substantially even, and a second threshold may indicate that the edges are slightly uneven. For example, the measurement indicator 409A, 409C may turn a first color, such as green to, indicate that the edges 116, 118 are substantially even (e.g., the delta height H is satisfies a first sharpening threshold), a second color, such as yellow, to indicate that the edges 116, 118 are slightly uneven (e.g., the delta height H satisfies a second sharpening threshold and does not satisfy a first sharpening threshold), and may turn a third color, such as red, to indicate that the edges 116, 118 are significantly uneven (e.g., the delta height H not satisfy a first or second sharpening threshold) after the user measures the skate blade 100 edges 116, 118. It is recognized that the foregoing colors are used as example only and any colors for the measurement indicators 409 can be used.

In an embodiment where the measurement device 400 includes a display, the display may comprise an electronic screen that is configured to display measurements and other information generated by the control system. Any suitable display device can be used for the display.

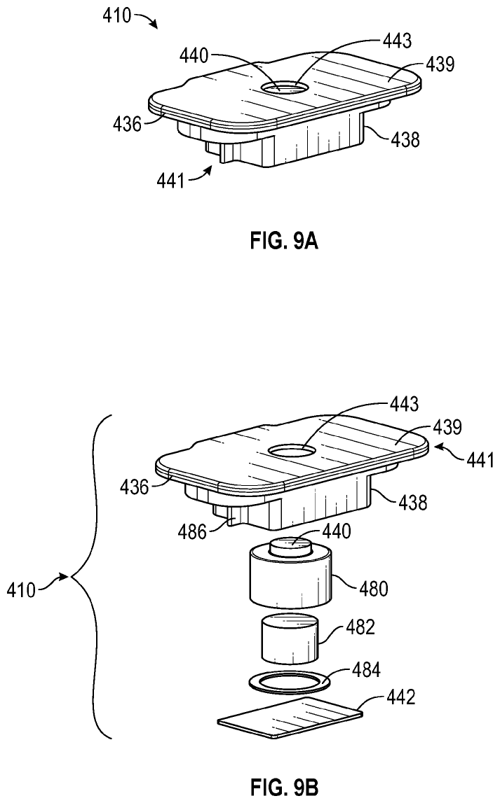

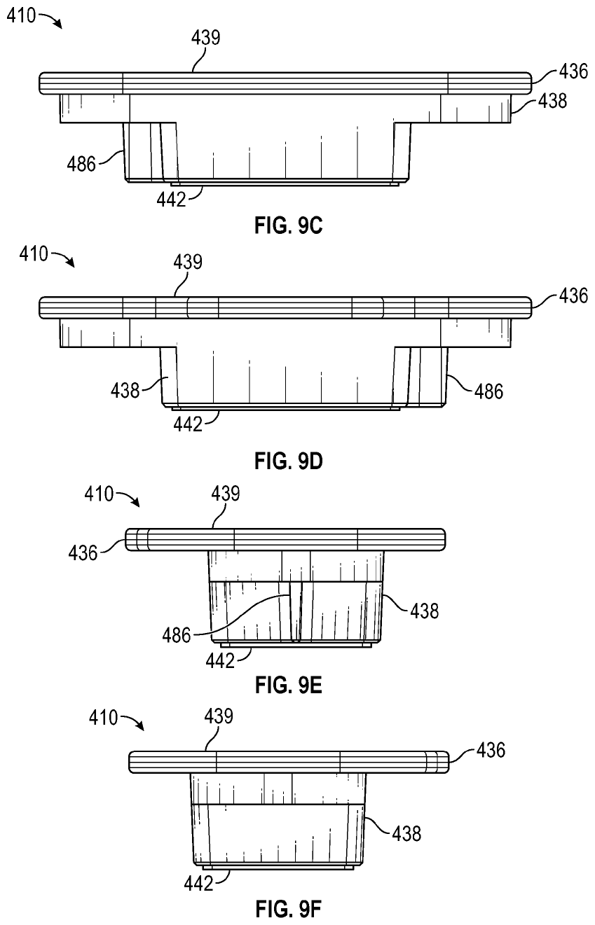

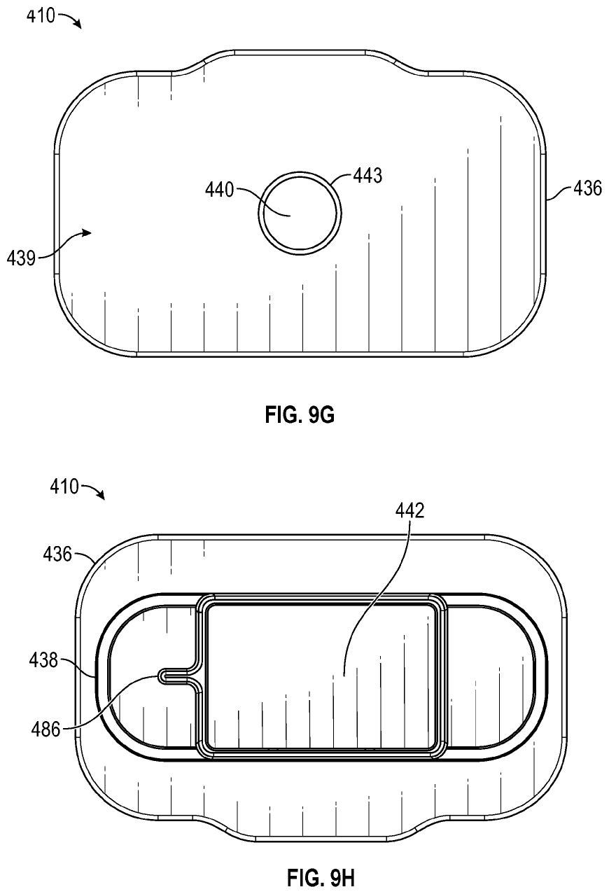

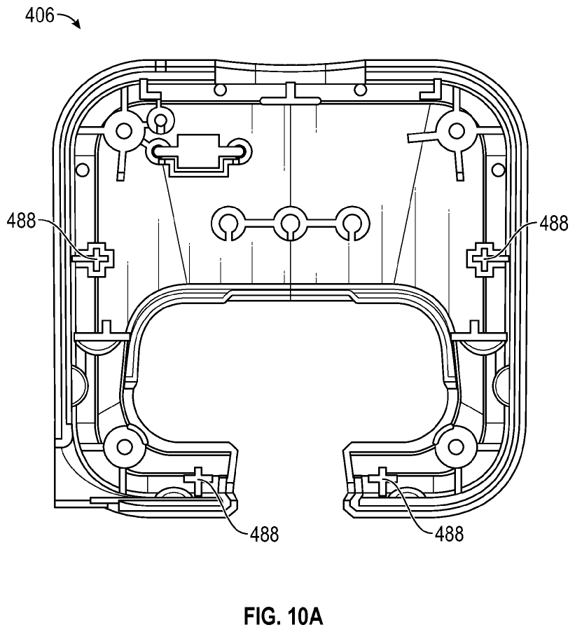

FIGS. 9A-9H illustrate an embodiment of the tilt bar 410. FIG. 9A illustrates a top left side perspective view of the tilt bar 410. The tilt bar 410, may include an external body 441 comprising a top portion 436 and a bottom portion 438. The top portion 436 may have a larger width than the bottom portion 438 such that the tilt bar 410 is roughly t-shaped. In some examples, a t-shape or other suitable shape may desirably allow the top portion 436 to be supported by the frame 414 while the bottom portion 438 extends through the frame 414 into the external] gap 428 and internal gap 464. For example, the top portion 436 may have a greater width than the internal gap 464. However, as described further herein, generally, the tilt bar 410 is not supported by the frame 414. The top portion 436 includes a top side 439 and may include a reflective section 440. In some examples, the top side 439 includes the reflective section 440. In other examples, including the example illustrated in FIG. 6A, the top side 439 has a hole 443 configured to receive a core 480 of the tilt bar 410 that includes the reflective section 440.

FIG. 9B illustrates an exploded view of the tilt bar 410. As shown, the tilt bar 410 may include the external body 441 discussed above in addition to the core 480, a magnet 482, a ring 484, and a wear plate 442. The core 480 may be any suitable material such as, for example, steel and is configured to be inserted into the external body 441 of the tilt bar 410. In one example, the core 480 may be generally cylindrical shaped and may include a bottom cylinder body and a top cylinder body comprising the reflective section 440. The core 480 may be partially hollow such that core 480 can receive the magnet 482. The reflective section 440 may be the same material as the tilt bar 410 or may comprise an additional material. For example, the reflective section 440 may be any suitable material that is configured to reflect light. For example, the reflective section 440 may be smooth, have a highly polished surface, have free electrons, and/or properties that result in a highly reflective surface. In some examples, the reflective section 440 spans the entire top side of the top portion 436. In other examples, the reflective section 440 includes a portion (e.g., a square, circular, diamond, and/or the like shaped portion) of the top side 439. In some examples, including the example illustrated, the reflective section 440 is part of the core 480 and is configured to extend partially into the hole 443 of the top side 439, as shown in FIG. 9G, which illustrates a top side view of the tilt bar 410. By having the reflective section 440 positioned within the hole 443/below the top side 439, the reflective section 440 may be protected from damage, such as scratches if, for example, the tilt bar 410 is dropped, set on an abrasive surface, and/or the like. In some embodiments, the reflective section 440 may be flush with the top side 439. In an embodiment where the reflective section 440 is flush with the top side 439, the top side 439 may include raised edges that extend around the reflective section 440 to create a raised lip around the entire reflective section 440. In this example, the raised edges serve to protect the reflective section 440 from being scratch if the tilt bar 410 is dropped, set on an abrasive surface, and/or the like. The raised edge example may also allow the tilt bar 410 and specifically the reflective section 440 to be cleaned easier and may prevent debris from accumulating on the reflective section 440, which could negatively affect the measurement.

The magnet 482 may be a generally cylindrical body that is configured to be inserted into the core 480. Generally, the magnet 482 much be a sufficiently strong magnet to cause the tilt bar 410 to remain magnetically coupled to support pins 466, 468, 470 (described below) when the measurement device 400 is in any orientation. However, the magnet 482 cannot be so strong such that a user cannot lift the tilt bar 410 with the skate blade 100 as required to measure the edges 116, 118 of the skate blade 100. The magnet 482 may also allow the tilt bar 410 to be magnetically coupled to the skate blade 100 when the measurement device 400 is being used to measure the edges 116, 118 of the skate blade 100. The ring 484 may be any suitable material, such as, for example, a die cut pressure sensitive adhesive component. The ring 484 may be configured to adhere the wear plate 442 to the core 480. In some examples, the core 480 may be adhered to the external body 441 of the tilt bar 410 by a press fit tolerance, adhesive on the core 480, or both. In some examples, the external body 441 may include one or more glue moats with one or more inlets (not shown) on either side of the external body around the core 480. In this example, the inlets may be sized for a standard needle gauge (e.g., an 18 gauge dispensing needle), which may allow for easy assembly of the tilt bar 410.

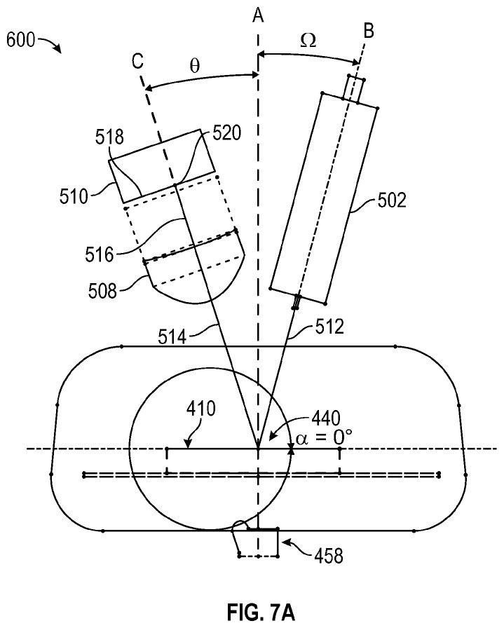

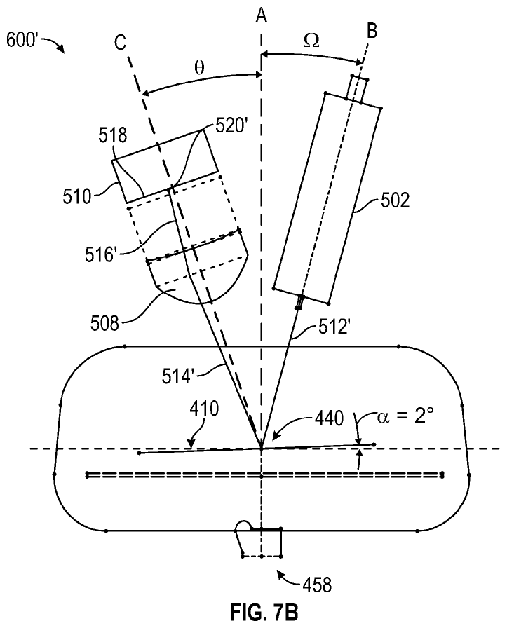

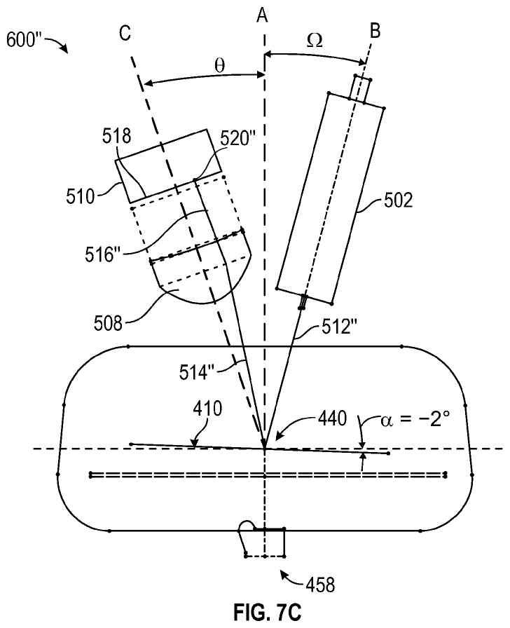

The bottom portion 438 may comprise partially hollow body and may include a key 486. The key 486 may project out of the left side of the bottom portion 438 and may be configured to be received within a slot (not shown) of the frame 414. Notably, the bottom portion 438 includes the key 486 on one side of the tilt bar 410 to help ensure that the tilt bar 410 is always inserted into the frame 414 is the same orientation by the user. This feature is shown more clearly in FIGS. 9C-9F, which illustrate a front side view, a back side view, a left side view, and a right side view of the tilt bar 410 respectively. As described further herein with reference to at least FIGS. 6H and 7A-7C, the optics system 500 of the measurement device 400 may be calibrated for the specific measurement device 400. To ensure that the system is properly calibrated, the tilt bar 410 must be inserted in the same orientation each time the measurement device 400 is used to prevent any discrepancies in the tilt bar 410 from altering the calibration. By including the key 486 and a single slot in the frame 414, the tilt bar 410 can only be inserted in a single properly calibrated orientation. It is recognized that the key 486 is only one example of a feature of the tilt bar 410 that can prevent the tilt bar 410 from being inserted into the measurement device 400 in an incorrect orientation. For example, any feature of the tilt bar 410 (or the measurement device 400 as a whole) that ensures the tilt bar 410 is correctly inserted may be used in the measurement device 400.

The wear plate 442 may comprise a generally rectangular plate that is configured to be coupled to the bottom side of the bottom portion 438, as shown in FIG. 9H, which illustrates a bottom side view of the tilt bar 410. The wear plate 442 may be the same material as the tilt bar 410 or may include an additional plate coupled to the bottom side of the bottom portion 438. Generally, it is desirable for the wear plate 442 to comprise a material that is harder than an ice skate blade to prevent significant damage to the wear plate 442. For example, damage to the wear plate 442, such as cuts from the skate blade 100, may result in incorrect measurements over time. As described further herein, the wear plate 442 is configured to contact the edges 116, 118 of the skate blade 100. Generally, it is desirable for the reflective section 440, the top side 439, and the wear plate 442 to be parallel to each other, which may be desirable for determining the delta height H of the edges 116, 118 of the skate blade 100, as described further herein. However, as described further herein, the measurement device 400 is calibrated based on the specific components used in a specific measurement device 400, as such, even is the reflective section 440, the top side 439, and the wear plate 442 are not parallel to each other, the calibration will still allow for accurate measurements.

Referring back to FIGS. 6A-6H, and specifically FIG. 6H, the securing mechanism illustrated is the thumb screw 412, which includes a head 444, a shank 446, a thread 448, and a clamp portion 450. While the thumb screw 412 is one example of a securing mechanism used in the measurement device 400, it is recognized that any suitable securing mechanism can be used to secure the skate blade in position. In some example, the head 444, the shank 446, the thread 448, and the clamp portion 450 comprise a single unit. The head 444 is at the proximal end of the thumb screw 412 and the clamp portion 450 is at the distal end of the thumb screw 412. The thumb screw 412 may comprise any suitable material such, as, for example, a metal or a plastic. Generally, it is desirable for the thumb screw 412, and particularly the clamp portion 450, to experience a range of compressive forces without bending. A user may rotate the thumb screw 412 using the head 444. As noted above, the external housing 402 includes the screw extension 434 that is configured to cover a portion of the thumb screw 412 without contacting the thumb screw 412 and the frame 414 includes a hole (not shown) that is configured to receive the thumb screw 412. In some examples, the hole of the frame 414 may be threaded to engage with the thread 448 of the thumb screw 412. The clamp portion 450 may be generally perpendicular to the wear plate 442. As explained further herein, the most accurate measurements of the delta height H of the edges 116, 118 of the skate blade 100 may be achieved when the clamp portion 450 provides sufficient force on the skate blade 100 such that the skate blade 100 is flush to the first clamp datum 474 and the second clamp datum 432. In some embodiments, when the frame 414 is rigidly secured to the external housing 402, it may be desirable for the hole of the screw extension 434 to be smooth to engage with shank 446 of the thumb screw 412. In this example, it may be desirable for the screw extension 434 and the shank 446 to have a transition fit, such that the screw extension 434 supports the thumb screw 412 and maintains the orientation of the thumb screw 412 without unduly limiting the movement of the thumb screw 412 relative to the measurement device 400. However, as noted above, generally, it is desirable to prevent contact between the thumb screw 412 and the screw extension 434. In some examples, the thumb screw 412 may comprise a ferrous metal or a metal that is magnetically attracted to skate blade 100.

In some embodiments, the securing mechanism 412 may comprise an alternative component configured to secure the skate blade 100 within the blade slot 458. For example, the securing mechanism 412 may include a bolt, a fastener, spring-loaded projection, a magnet, and/or other type of securing mechanism. In some embodiments, the measurement device 400 may not include a securing mechanism 412.

The frame 414 can be shaped to fit within the external housing 402 and may be connected to or suspended between at least one of the rear housing 404 and the front housing 406, as described with reference to FIGS. 10A-10D. In some embodiments, the frame 414 may be securely coupled to the measurement device 400. The frame 414 may be any suitable material. For example, in some cases, the frame 414 may be a plastic or a metal. As described further herein, the frame 414 is configured to support additional components of the measurement device 400, such as components of the optics system 500 and the control system. The frame 414 may include an internal aperture 452, first pin holes 454, second pin holes 456, and a blade slot 458. The internal aperture 452 includes a hole through the frame 414. The internal aperture 452 can be configured to be at least partially aligned with the external aperture 430 of the external housing 402. The first pin holes 454 are positioned on the left side of the blade slot 458 and the second pin holes 456 are positioned on the right side of the blade slot 458. The first pin holes 454 may be configured to receive a first support pin 466 and each second pin hole 456 may be configured to receive one of the second support pin 468 and the third support pin 470, as discussed further below. As shown more clearly in FIG. 6G, which illustrates a bottom view of the measurement device 400, the frame 414 may further include a front bottom portion 460 and a rear bottom portion 462 with an internal gap 464 therebetween. The internal gap 464 may be partially aligned with the external gap 428. The blade slot 458 may include a cutout in the frame 414 and may be any suitable shape. In the example illustrated in FIGS. 6A-6H, the blade slot 458 is rectangular with a notch 472. The notch 472 may be configured to accommodate (e.g., receive) any burs on the edges 116, 118 of the skate blade 100. The blade slot 458 includes a first clamp datum 474 and a second clamp datum 432. As shown in FIG. 6G, the first clamp datum 474 is formed from the front bottom portion 460 and the rear bottom portion 462 such that the internal gap 464 extends through the first clamp datum 474. The first clamp datum 474 may be generally parallel to the clamp portion 450. Generally, it is desirable for the first clamp datum 474 to be perpendicular to the wear plate 442 and the reflective section 440. However, as noted herein, even when the first clamp datum 474 is not perfectly aligned, the measurement device 400 can still produce accurate measurements due to the calibration process. The second clamp datum 432 comprises the top portion of the blade slot 458 and is formed from the front bottom portion 460 and the rear bottom portion 462 such that the internal gap 464 extends through the second clamp datum 432. In some examples, the second clamp datum 432 may be perpendicular to the first clamp datum 474 and parallel to the wear plate 442 and the reflective section 440.

With continued reference to FIG. 6G, the measurement device 400 may further include the first support pin 466, the second support pin 468, and the third support pin 470. The support pins 466, 468, 470 may be press fit into the first pin holes 454 and the second pin hole 456. The support pins 466, 468, 470 may be configured to support the tilt bar 410 and may comprise any suitable material. Generally, it is desirable for the support pins 466, 468, 470 to be a ferrous metal or a metal that is magnetically attracted to the magnet 482 so that the tilt bar 410 remains magnetically coupled to the support pins 466, 468, 470 and does not shift in position (e.g., fall into the apertures 430, 452) when the measurement device 400 is used. For example, when the measurement device 400 is upside down, the tilt bar 410 remains coupled to the support pins 466, 468, 470.

FIG. 6F illustrates a top view of the measurement device 400. As shown in FIG. 6F, the power button 416 may be located on the top side of external housing 402. The power button 416 is configured to power on and power off the control system. While the power button 416 is positioned on the top side of the external housing 402, it is recognized that the power button 416 can be located on any side of the external housing 402. In the example, illustrated the power button 416 is positioned within a recess 476 of the external housing 402. The power button 416 may be configured to be partially compressed when the user pushes on the power button 416.

When the measurement device 400 is in an assembled configuration, as shown in FIGS. 6A-6G, the rear housing 404 is coupled to the front housing 406 with the frame 414, the optics system 500, and the control system positioned within the external housing 402. As noted above, the external housing 402 may be coupled to the rear housing 404 using the plurality of fasteners 426. In some examples, the plurality of fasteners 426 are slotted through the plurality of fastener holes 424 and secured to holes (e.g., threaded holes) in the rear housing 404. In some embodiments, the frame 414 includes holes to allow the plurality of fasteners 426 to pass through the frame 414, while in other embodiments, the frame 414 is shaped such that the plurality of fasteners 426 can extend between the front housing 406 and the rear housing 404 without contacting the frame 414.

With reference to FIG. 6G, in the assembled configuration, the first support pin 466 is positioned in the first pin holes 454 such that the first support pin 466 extends between the first pin hole 454 in the front bottom portion 460 and the first pin hole 454 in the rear bottom portion 462. In some examples, the first support pin 466 may be recessed into the first pin holes 454 of the front bottom portion 460 and the rear bottom portion 462. The second support pin 468 is positioned in the second pin hole 456 in the front bottom portion 460 such that the second support pin 468 extends in a direction towards the rear bottom portion 462. Similarly, the third support pin 470 is positioned in the second pin hole 456 in the rear bottom portion 462 such that the third support pin 470 extends in a direction towards the front bottom portion 460. When positioned in this manner, the second support pin 468 and the third support pin 470 are cantilevered relative to the front bottom portion 460 and rear bottom portion 462 respectively, with a gap therebetween. The gap allows portions of the thumb screw 412 (e.g., the clamp portion 450 and the thread 448) to extend between the second support pin 468 and the third support pin 470. This arrangement may be desirable as it allows the height of the blade slot 458 to minimized, as opposed to not including the gap and positioning the thumb screw 412 below the support pins 466, 468, 470. This arrangement optimizes the height of the blade slot 458. For example, having a shorter blade slot 458 may allow the measurement device 400 to measure very short skate blades without interfering with the skate blade holders of most hockey and figures skates. In the assembled configuration, the thumb screw 412 is positioned partially within the screw extension 434 such that the shank 446 does not contact the hole of the screw extension 434 and the thread 448 is at least partially engaged with the threads of the hole in the frame 414. The head 444 of the thumb screw 412 remains outside of the external housing 402 in the assembled configuration. A user may rotate the thumb screw 412 using the head 444 about a rotational axis of the thumb screw 412 in a first direction and in an opposite second direction. Rotation of the thumb screw 412 in the first direction causes the thumb screw 412 to move in a distal direction such that the clamp portion 450 moves towards the first clamp datum 474 as the thread 448 engages with the threads of the frame 414. Rotation of the thumb screw 412 in the second direction causes the thumb screw 412 to move in a proximal direction such that the clamp portion 450 moves away from first clamp datum 474. By rotating the thumb screw 412 in the first direction, the user can clamp the skate blade 100 in the blade slot 458 between the clamp portion 450 and the first clamp datum 474, with the edges 116, 118 against the second clamp datum 432, such that the skate blade 100 is secured within the blade slot 458 and secured to the measurement device 400. The user provides the force to align and cause the edges 116, 118 to contact the second clamp datum 432 (e.g., by lifting the tilt bar 410), and the clamp portion 450 provides the clamping force to cause the skate blade 100 to contact the first clamp datum 474. By rotating the thumb screw 412 in the second direction, the user can release the skate blade 100 from the measurement device 400 as the clamp portion 450 moves away from the first clamp datum 474.

With continued reference to FIGS. 6A and 6G, in the assembled configuration, the tilt bar 410 is positioned at least partially within the external aperture 430 and the internal aperture 452. In this position, the bottom portion 438 of the tilt bar 410 extends at least partially through the external gap 428 and the internal gap 464. The bottom portion 438 extends between the front bottom portion 460 and the rear bottom portion 462 such that the wear plate 442 contacts and is supported by/magnetically coupled to the first support pin 466, the second support pin 468, and the third support pin 470. In this position, the bottom portion 438 and the wear plate 442 extend at least partially into the blade slot 458. For further clarity, the tilt bar 410 may not be secured to the measurement device 400 except for being magnetically coupled to the support pins 466, 468, 470 and with the exception of any contact between the tilt bar 410 and the frame 414. For example, the tilt bar 410 does not move between different positions within the measurement device 400, even when the orientation of the measurement device 400 changes. For example, the tilt bar 410 may be supported by the support pins 466, 468, and 470 when the measurement device 400 is in an upright orientation. The measurement device 400 is in the upright orientation when the bottom side 420 is roughly parallel with the ground and the top side 418 is above the bottom side and is parallel with the ground. In the upright orientation, the magnet 482 of the tilt bar 410 causes the tilt bar 410 to be magnetically attracted to and supported by one or both the support pins 466, 468, and 470, and the frame 414. When the measurement device 400 is in an upside-down orientation, the tilt bar 410 remains magnetically coupled to the support pins 466, 468, and 470. The measurement device 400 may be in an upside-down orientation when the bottom side 420 is above the top side 418 and the bottom side 420 and the top side 418 of the measurement device 400 are roughly parallel with the ground.

As explained above, the tilt bar 410 is not fixed to the measurement device 400 and, as such, the depth of the extension of the bottom portion 438 into the blade slot 458 is variable. When the measurement device 400 is in upright orientation, the measurement device 400 can be used to measure the delta height H of the edges 116, 118 of the skate blade 100. The tilt bar 410 is configured to move between a first/storage configuration and a second/measurement configuration. In the storage configuration, the tilt bar 410 is at its lowest depth relative to the top side 418 of the measurement device 400 and the bottom portion 438 is at a maximum extension into the blade slot 458. In the storage configuration, the tilt bar 410 is supported by and magnetically coupled to the support pins 466, 468, and 470. As explained further herein, the tilt bar 410 moves to the measurement configuration when the skate blade 100 is inserted into the blade slot 458 and pushed into contact with the first clamp datum 474 and the tilt bar 410 by the user and the clamp portion 450. The skate blade 100 may be pushed into contact with the first clamp datum 474 and the second clamp datum 432. For example, FIG. 6I illustrates the skate blade 100 positioned within the blade slot 458 of the measurement device 400. As the skate blade 100 is inserted into the blade slot 458, the edges 116, 118 of the skate blade 100 contact the wear plate 442 of the tilt bar 410, causing the tilt bar 410 to magnetically coupled to the skate blade 100 and move upwards away from the bottom side 420 of the measurement device 400 as the skate blade 100 extends further vertically into the blade slot 458. As noted above, the skate blade 100 can be secured to the measurement device 400 by rotating the thumb screw 412 until the skate blade 100 is clamped between the clamp portion 450 and the first clamp datum 474. In the measurement configuration, the bottom portion 438 of the tilt bar 410 extends into the blade slot 458 less than the maximum extension. In the measurement configuration, the tilt bar 410 is supported via the wear plate 442 by the edges 116, 118 of the skate blade 100 such that the tilt bar 410 balances on the edges 116, 118 of the skate blade 100. When the edges 116, 118 of the skate blade 100 are even (i.e., the delta height H of the edges 116, 118 are within the acceptable tolerance), the reflective section 440 will be approximately parallel to a horizontal axis defined by the axis of reflective section 440 when the measurement device 400 was calibrated. Conversely, when the edges 116, 118 of the skate blade 100 are uneven (i.e., the delta height H is outside of the acceptable tolerance), the reflective section 440 will be at an angle relative to the horizontal axis. For further clarity, in one example, a user may place the measurement device 400 on the skate blade 100 such that the skate blade 100 is received within the blade slot 458 with the edges 116, 118 directed upwards and towards the tilt bar 410. The user may provide vertical pressure on the skate blade 100 or downwards pressure on the measurement device 400, or both, until the edges 116, 118 contact the second clamp datum 432. As a result of these forces, the tilt bar 410 moves into the measurement configuration and is resting on the edges 116, 118 of the skate blade 100. It should be noted that the skate blade 100 does not need to contact the second clamp datum 432 to provide for an accurate measurement. As long as the skate blade 100 is aligned with the first clamp datum 474 and the tilt bar 410 is being supported by the skate blade 100 and not the frame 414, the user may be able to accurately measure the delta height H using the measurement device 400. Next, the user secure the skate blade against the first clamp datum 474 using a securing mechanism (e.g., the thumb screw 412) to provide a clamping force against the side of the skate blade 100 until the skate blade 100 is securely positioned against the first clamp datum 474. At this point, the user can measure the edges 116, 118 of the skate blade 100 using the measurement device 400.

FIG. 6H illustrates a back view of the measurement device 400 with select components of the measurement device 400 (e.g., the rear housing 404, components of the control system, etc.) removed to better illustrate the optics system 500. The optics system 500 may comprise a light emitting source 502, a filter plate 504, a filter 506, a lens 508, and a sensor 510. Like components of the optics system 500 may be similar or identical to like components of the optic measurement system 300. For example, the components of both the optic measurement system 300 and the optics system 500 may operate and be arranged in a similar manner.

With continued reference to FIG. 6H, the light emitting source 502 may comprise any suitable light source that can transmit light that can be received by the sensor 510. The light source can emit light within the visible spectrum of light or outside the visible spectrum of light. In the illustrated embodiment, the light emitting source comprises a laser 502. In this example, the laser 502 may be any suitable laser that can generate a beam of light or a laser beam. In some examples, it may be desirable for the laser 502 to be a collimated laser. A collimated laser is configured to generate a collimated beam of light that propagates in homogeneous mediums (e.g., air) with a low beam divergence. Low beam divergence may be desirable so that the beam radius does not undergo significant changes within moderate propagation distances.

In some embodiments, the measurement device 400 may include an alternative energy emitting source rather than a light emitting source. For example, the measurement device 400 may utilize any energy emitting source that could cause a disruption or modification of the generated signal that could be detected by a corresponding sensor, such as sensor 510.

The filter plate 504 may comprise any suitable material that can support the filter 506 and allow the laser beam to pass through it without compromising the laser beam. For example, the filter plate 504 may comprise a glass plate. The filter 506 may comprise any suitable optical filter, such as, for example, a polarizing filter. The filter 506 may be configured to optimize the measurement of the position of the laser spot on the sensor 510. For example, the filter 506 may be used to optimize the signal to noise ratio. In the optics system 500, the “signal” is the laser beam that is reflected from the reflective section 440 of the tilt bar 410 into the sensor 510 and the “noise” is any other light or additional portion of the reflected light that can make it difficult for the control system to accurately determine the center of the laser beam. Noise in the optics system 500 may be generated in a number of ways. For example, noise may comprise light in the environment where the measurement device is being used that is not generated from the laser 502, such as light from the sky, light from room lights, etc. In another example, noise may comprise light from the laser 502 itself, that is unstructured or “messy” such as reflected light from the reflective section 440 of the tilt bar 410. In some examples, the signal can be made stronger, and the noise can be reduced by using the filter 506 to filter at least a portion of the light generated by the laser 502. For example, to filter out the unstructured portions of the laser beam itself, the filter 506 can be polarized, which may be desirable when using a collimated laser 502. For example, the polarizing filter 506 can help to prevent laser 502 light that is reflected from the reflective section 440 of the tilt bar 410 from spreading out into other directions, which may make the reflected laser spot on the sensor 510 messy. In some examples, the optics system 500 may include a second filter the is configured to filter at least a portion of the reflected light going into the sensor 510. For example, to filter the light going into the sensor 510, the second filter may be configured to filter out wavelengths of light other than the wavelength(s) of the light generated by the laser 502. While the example optics system 500 shown in FIG. 5A includes the filter 506, the filter 506 is not required. However, it may be desirable for the optics system 500 to include a filter 506 to prevent the sensor 510 from being over-saturated.

The lens 508 may comprise any suitable lens. For example, the lens 508 may comprise a spherical lens, an aspheric lens, and/or the like. As described above with reference to FIGS. 4A and 4B, in some examples, it may be desirable to for the lens 508 to be aspheric to eliminate spherical aberration of the laser beam generated by the laser 502.

The sensor 510 may comprise any suitable sensor for receiving the laser beam generated by the laser 502. For example, the sensor 510 may comprise a position sensitive detector (“PSD”), a charge coupled device (“CCD”), a complementary metal-oxide semiconductor (“CMOS”) device, and/or the like. When the sensor 510 receives the reflected laser beam, the light imaged onto the sensor 510 from the laser beam, referred to as the laser spot, can be converted into electrical signals. The type of electrical signal may be dependent on the electrical design specification for the particular sensor 510 used. The electrical signal may then be used by the control system to create an “image” of the light on the sensor 510. In some examples, the sensor 510 may be configured to determine the center of mass of a laser spot, and thus output the determined center of mass directly. In another example, the sensor 510 may be configured to output raw image values and the control system may then determine the center of mass of the laser spot. The control system may include software (e.g., computer-executable instructions) written to control the sensor(s) 510 and the software may be customized to each sensor 510 to optimize performance of the sensor 510 for use in the measurement device 400.

The various components of the optics system 500 may be supported by one or more of the frame 414, the rear housing 404, and the front housing 406. Generally, it is desirable for the optics system 500 to be primarily supported by the frame 414 to protect the optics system 500 from shock events, as described with reference to FIGS. 10A-10D. The components of the optics system 500 may be arranged in a similar manner to the components of the optic measurement system 300. For example, the components of the optics system 500 are arranged relative a central axis A. In some examples, the central axis A is the central axis of the measurement device 400. The central axis A extends along and defines the vertical/z-axis. The components of the optics system 500 to the right of the central axis A are in the positive y-direction and the components of the optics system 500 to the left of the central axis A are in the negative y-direction. In the optics system 500, the laser 502 may be positioned on the left side of the central axis A with a laser axis B of the laser 502 being at an angle θ relative to the central axis A. The laser 502 is configured to generate a laser beam that travels along the laser axis B. In some examples, the frame 414 may include a laser aperture (not shown), that may be machined into the frame 414 to align with the laser axis B. The frame 414 laser aperture may be configured to reduce the spot size of the laser 502 on the reflective section 440 of the tilt bar 410. The filter plate 504 may be positioned below the laser 502. In some examples, the filter plate 504 may be at a 90 degree angle (i.e., perpendicular) to the central axis A. In this orientation, the filter 506 is aligned along the laser axis B and is configured to receive the laser beam. The sensor 510 may be positioned on the right side of the central axis A with a sensor axis C of the sensor 510 being at the angle Q relative to the central axis A. In some example, the angle Q is the same as the angle θ, while in other examples the angles n and 0 are not equal. As noted above, the sensor 510 is configured to receive the laser beam that reflects off the reflective section 440 of the tilt bar 410. When the reflective section 440 of the tilt bar 410 is perpendicular to the central axis A (i.e., at a zero angle α relative to the y-axis), the reflected laser beam travels along the sensor axis C and is received by the sensor 510. The lens 508 may be positioned on the right side of the central axis A below the sensor 510 and at the same angle Q relative to the central axis A. In this orientation, the lens 508 is aligned along the sensor axis C and is configured to receive the reflected laser beam before the sensor 510. In examples where the optics system 500 includes a second filter, the second filter may be positioned below the lens 508 (e.g., on the filter plate 504), such that the second filter is between lens 508 and the reflective section 440 of the tilt bar 410. In some examples, the second filter may be perpendicular to the central axis A (i.e., at a zero angle relative to the y-axis).

The tilt bar 410 is positioned below the laser 502, filter plate 504, filter 506, lens 508, and sensor 510. As explained above, the tilt bar 410 is positioned at least partially within the external aperture 430 and the internal aperture 452. In this position, the central axis of the tilt bar 410 is aligned with the central axis A such that the reflective section 440 of the tilt bar 410 is centered on the central axis A and in the path of the laser beam when the tilt bar 410 is at a zero angle α relative to the y-axis. The central axis of the blade slot 458 is also aligned with the central axis A. When the reflective section 440 of the tilt bar 410 is at a positive or negative angle α, the reflect laser beam does not travel along the sensor axis C.

In operation, the laser 502 generates a laser beam that travels along the laser beam axis B through laser aperture (when the frame 414 includes the laser aperture) and through the filter 506. The laser beam travels towards and is reflected by the reflective section 440 of the tilt bar 410. The reflected laser beam then travels through the lens 508 and is received by the sensor 510. When the optics system 500 includes the second filter, the reflected laser beam travels through the second filter prior to the lens 508. The optical path design of the laser 502, lens 508, and sensor 510 provides the ability to measure the angle α of the tilt bar 410. Once the sensor 510 receives the reflect laser beam, the control system determines the angle α of the tilt bar 410. For example, the control system may analyze data from the sensor 510 and determine the weighted center of mass of the laser spot received by the sensor 510. The weighted center of mass allows for the determination of the angle α of the tilt bar 410 based on the laser spot appearing at different locations on the sensor 510 as the angle α of the tilt bar 410 changes. The combination of the optics system 500 and the control system can be used to determine whether a delta height H exists between the edges 116, 118 of the skate blade 100 when the skate blade 100 is inserted into the blade slot 458 such that the tilt bar 410 is balanced on the edges 116, 118 via the wear plate 442. When the edges 116, 118 of the skate blade 100 are even, the angle α of the tilt bar 410 will be approximately zero. Conversely, when the edges 116, 118 of the skate blade 100 are uneven, the angel α of the tilt bar 410 will be non-zero.

While FIG. 6H illustrates the components of the optics system 500 orientated in a particular manner, the position of the optics system 500 can vary between embodiments of the measurement device 400. Various mounting methods such as bolts, screws, fasteners, tape, and/or the like may be used to mount and position the components of the optics system 500 to the measurement device 400. As noted above, generally, the components of the optics system 500 are mounted/fixed to the frame 414. In some examples, the mounting system may give a user flexibility to adjust location and alignment of the components of the optics system 500 relative to each other.

In some configurations, the optics system 500 may not include a laser aperture in the frame 414 and may instead include an aperture plate with a laser aperture that is configured to reduce the spot size of the laser 502 on the reflective section 440 of the tilt bar 410. Reducing the spot size of the laser 502 on the reflective section 440 of the tilt bar 410 may be desirable because if the spot size on the reflective section 440 of the tilt bar 410 is too large, then the imaged spot on the sensor 510 will take up too much area of the sensor 510 and will make it difficult to resolve small changes in the angle α of the reflective section 440 of the tilt bar 410. In some examples, the laser aperture of the optics system 500 may be approximately circular shaped and may have a diameter between 250 μm and 1000 μm, between 350 μm and 850 μm, between 500 μm and 700 μm, or any other values or ranges of values between the foregoing. It is recognized that the size of the laser aperture may vary between different embodiments of the measurement device 400 and may be dependent on the type of laser 502, filter 506, lens 508, sensor 510, and/or the reflective section 440 of the tilt bar 410 used in the measurement device 400. The size of the laser aperture may also be dependent on the relative angles and distances between the components of the optics system 500. Generally, the laser aperture can be used to reduce the spot size of the laser 502 to a size that is proportional to the sensor 510 area and resolution required by the optics system 500, similarly to the laser aperture 314 of the optic measurement system 300.

The measurement device 400 includes a control system. The control system may include the electrical components of the measurement device 400. For example, the control system may include a central processing unit, one or more printed circuit boards (“PCBs”), one or more receiving coils, one or more power sources (e.g., batteries), one or more microprocessors, one or more storage systems, an accelerometer, etc. The components of the control system may be used to power the measurement indicators 409 and the sensor 510. In an embodiment where the measurement device 400 includes a display, such as an LED display, the control system may be configured to cause text or images to be displayed on the display. As explained further herein, the control system may also be configured to connect and transmit data to various other devices using wireless networking technology (e.g., Wi-Fi), Bluetooth, and/or the like. The accelerometer may be configured to monitor shock levels seen by the measurement device 400. For example, if the measurement device 400 is dropped or used is a rough or abusive fashion, the accelerometer may log these shock levels. This feature may provide a benefit of alerting the user when the measurement device 400 has experienced significant shock levels such that the optics system 500 may be damaged or misaligned.

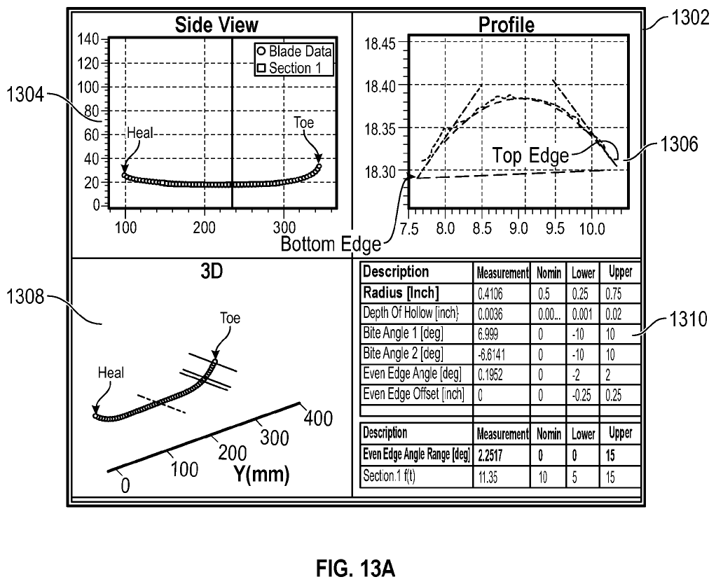

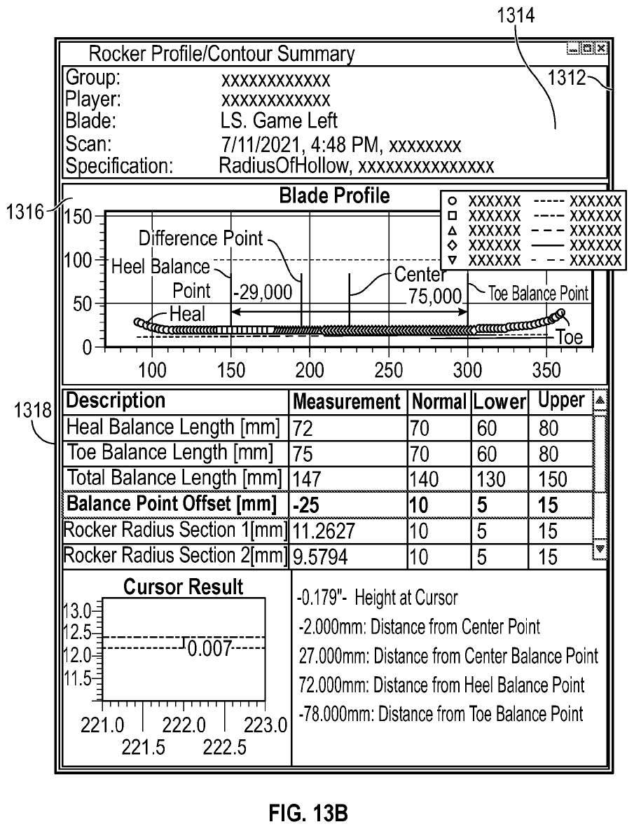

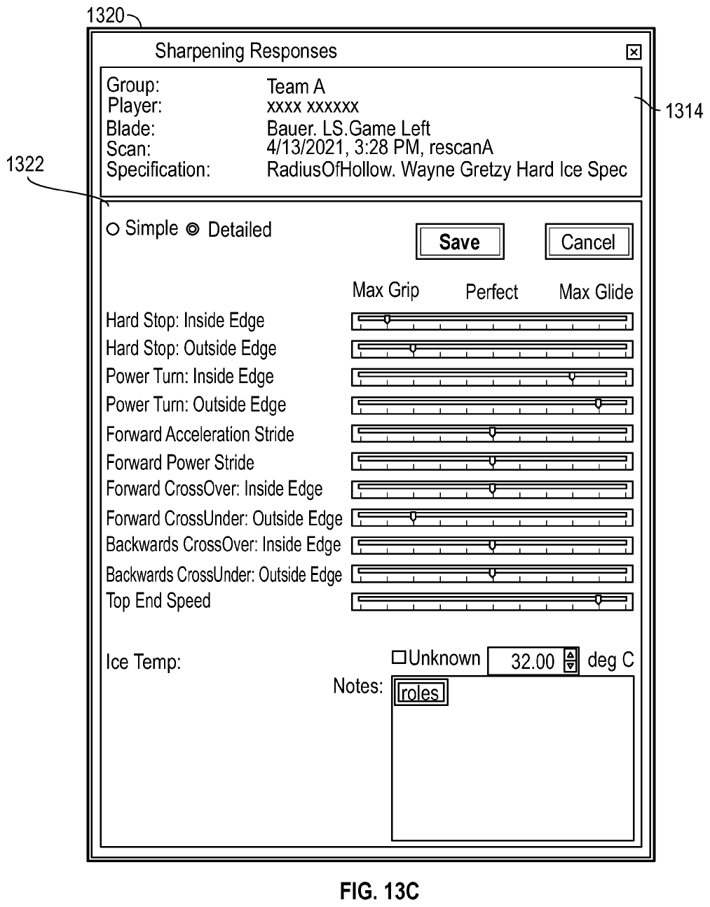

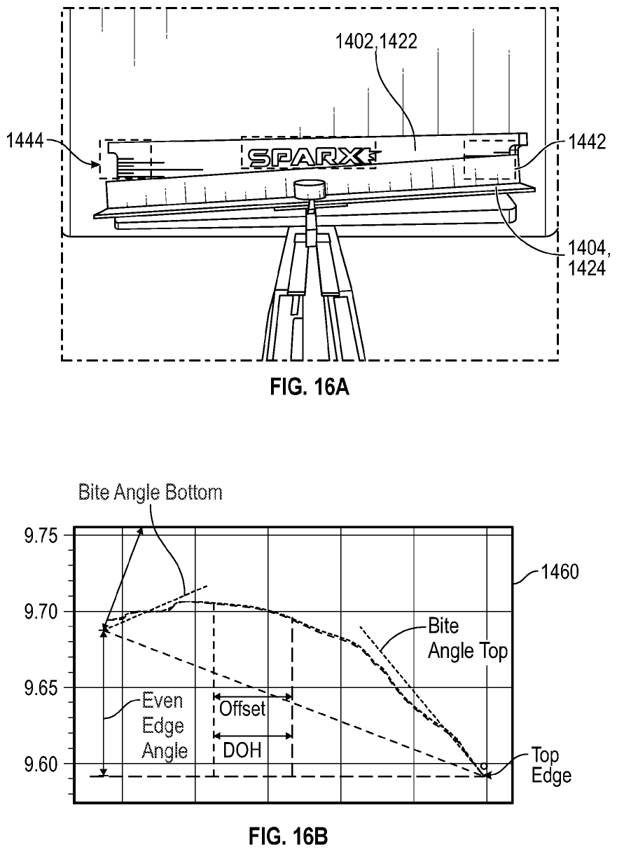

In some embodiments, the laser 502 in the measurement device 400 may include a line laser. In this example, the measurement device 400 may not include a tilt bar 410. Instead, the line laser 502 may direct the line laser beam directly towards the width 122 of the skate blade 100. For example, the line laser beam may span at least the width of the skate blade 100. The reflected line laser beam may then be received by the sensor 510. This example may allow for additional information (e.g., geometry) of the skate blade 100 to be determined. For example, rather than focusing on the two highest points of the skate blade 100 (i.e., the edges 116, 118), the line laser beam can allow for information related to the full width (y-axis) and depth (z-axis) of the skate blade 100, such as, for example, the depth of the hollow 114 in the skate blade 100 to be generated. In this example, the actual skate blade 100 functions in a similar manner to the tilt bar 410. See for example, at least FIGS. 13A, 13B, and 16B, which illustrate example geometric information that may be generated using the line laser example described above.

FIGS. 7A-7C illustrate schematic diagrams of a laser path generated using an embodiment of the optics system 500 at varying tilt bar 410 angles α. For ease of explanation, only select components of the optics system 500 and measurement device 400 are illustrated. FIGS. 7A-7C illustrate the measurement device 400 and the optics system 500 from a front view (i.e., the opposite side of the side illustrated in FIG. 6G). In each of FIGS. 7A-7C, the tilt bar 410 is in the measurement configuration. In some examples, the angle α may be considered the angle of tilt bar 410 (and more specifically the reflective section 440) relative to the tilt bar 410 when the measurement device 400 was calibrated. For example, an angle α of zero would indicate that the tilt bar 410 and the reflective section 440 are in the same position that the tilt bar 410 was when the measurement device 400 was calibrated.

FIG. 7A illustrates schematic diagram 600. In diagram 600, the tilt bar 410 has an angle α of zero relative to the horizontal. As explained herein, when the edges 116, 118 of the skate blade 100 have the same height (i.e., a zero delta height H), the angle α will be approximately zero. As shown in FIG. 7A, the laser 502 generates a laser beam 512 that travels along the laser axis B towards the reflective section 440 of the tilt bar 410. After contacting the reflective section 440, a reflected laser beam 514 travels towards the towards and through the lens 508 and a refracted laser beam 516 exits the lens 508. The refracted laser beam 516 travels towards and contacts a lower surface 518 at a laser spot 520 of the sensor 510. Because the tilt bar 410 has an angle α of zero, the reflected laser beam 514 and the refracted laser beam 516 travel along the sensor axis C. The sensor 510 and the control system use the laser spot 520 to determine the delta height H of the edges 116, 118 of the skate blade 100 and/or the angle α.

FIG. 7B illustrates schematic diagram 600′. In diagram 600′, the tilt bar 410 has an angle α of +2 degrees relative to the horizontal. As explained herein, when the edges 116, 118 of the skate blade 100 have a different height (i.e., a non-zero delta height H), the angle α will be greater or less than zero. As shown in FIG. 7B, the laser 502 generates a laser beam 512 that travels along the laser axis B towards the reflective section 440 of the tilt bar 410. After contacting the reflective section 440, a reflected laser beam 514′ travels towards the towards and through the lens 508 and a refracted laser beam 516′ exits the lens 508. The refracted laser beam 516′ travels towards and contacts a lower surface 518 at a laser spot 520′ of the sensor 510. Because the tilt bar 410 has a non-zero angle α, neither the reflected laser beam 514′ nor the refracted laser beam 516′ travel along the sensor axis C. The sensor 510 and the control system use the laser spot 520′ to determine the delta height H of the edges 116, 118 of the skate blade 100 and/or the angle α. Assuming the blade thickness 122 is 3 mm, the control system would determine that the delta height H between the edges 116, 118 is approximately 0.105 mm based on the tilt bar 410 angle of +2 degrees. Assuming the skate blade 100 is inserted into the measurement device 400 with the inside edge 116 on the left side and the outside edge 118 on the right side, the control system would determine that the inside edge 116 is approximately 0.105 mm shorter than the outside edge 118.

FIG. 7C illustrates schematic diagram 600″. In diagram 600″, the tilt bar 410 has an angle α of −2 degrees relative to the horizontal. As shown in FIG. 7C, the laser 502 generates a laser beam 512 that travels along the laser axis B towards the reflective section 440 of the tilt bar 410. After contacting the reflective section 440, a reflected laser beam 514″ travels towards the towards and through the lens 508 and a refracted laser beam 516″ exits the lens 508. The refracted laser beam 516″ travels towards and contacts a lower surface 518 at a laser spot 520″ of the sensor 510. Because the tilt bar 410 has a non-zero angle α, neither the reflected laser beam 514″ nor the refracted laser beam 516″ travel along the sensor axis C. The sensor 510 and the control system use the laser spot 520″ to determine the delta height H of the edges 116, 118 of the skate blade 100 and/or the angle α. Assuming the blade thickness 122 is 3 mm, the control system would determine that the delta height H between the edges 116, 118 is approximately 0.105 mm based on the tilt bar 410 angle of −2 degrees. Assuming the skate blade 100 is inserted into the measurement device 400 with the inside edge 116 on the left side and the outside edge 118 on the right side, the control system would determine that the inside edge 116 is approximately 0.105 mm taller than the outside edge 118.

As noted above, in some examples, the sensor 510 is configured to determine the weighted center of mass of the laser spot (e.g., laser spot 520) received by the sensor 510. Depending on the angle α of the tilt bar 410, the laser spot will enter/be received by the sensor 510 at different locations across a width of the sensor 510 (see e.g., FIGS. 7A-7C). In the illustrated embodiment, when the laser spot is in the middle of the field of view of the sensor 510, the angle α is zero. When the laser spot is not in the middle of the field of view of the sensor 510, such as to the left or right of the laser axis C in FIGS. 7A-7C, the angle α is non-zero. In some examples, software image processing may be used on the images captured by the sensor 510 to determine the weighted center of mass of the reflected laser light into the sensor. The weighted center of mass may then be used and/or calibrated to an actual angle α value (e.g., in radians or degrees).

In some examples, the optics system 500 within the measurement device 400 may be calibrated such that the delta height H of the skate blade 100 edges 116, 118 can be accurately determined from the laser spot received by the sensor 510. In one example, the optics system 500 may be calibrated by mounting a tilt bar (e.g., tilt bar 410) on a precision rotary stage. The tilt bar 410 may then be rotated through a range of known angle α values while the laser 502 directs a laser beam (e.g., laser beam 512) at the tilt bar 410 and the sensor 510 received the laser spot while the sensor output is captured. Using this information, a regression (e.g., least squares fit) can be performed which will then yield a function that takes the sensor value(s) as inputs, and outputs an actual angle α value or delta height H value. This process can be performed after assembly of each measurement device 400, and the calibration stored in the memory of the control system for each individual measurement device 400. It is recognized that this calibration method is provided for example only and any other conventional laser/sensor calibration method could be used for the measurement device 400.

FIG. 8A illustrates a method 700 of using the measurement device 400 to determine the delta height H between edges 116, 118 of the skate blade 100. It is recognized that there are other embodiments of the measurement device 400 and method 700 which may exclude some of the steps shown and/or may include additional steps not shown. Additionally, the steps discussed may be combined, separated into sub-steps, and/or rearranged to be completed in a different order and/or in parallel.

The method 700 begins at block 702, when a user positions the measurement device 400 in the upright orientation. When the measurement device 400 is in the upright orientation, the tilt bar 410 is in the storage configuration such that the tilt bar 410 is at its lowest depth relative to the top side 418 of the measurement device 400 and the bottom portion 438 of the tilt bar 410 is at a maximum extension into the blade slot 458.

At block 704, the user places the skate blade 100 into the blade slot 458 such that the edges 116, 118 of the skate blade 100 are directed upward (e.g., in a direction away from the ground) and contact the tilt bar. In this position, the edges 116, 118 of the skate blade 100 contact the wear plate 442 of the tilt bar 410, causing the tilt bar 410 to become magnetically coupled to skate blade 100 and move upwards away from the bottom side of the measurement device 400 and into the measurement configuration. Generally, the wear plate 442 can extend partially into the blade slot 458, such that a portion of the bottom portion 438 is visible via the notch 472.

At block 706, the user secures the skate blade 100 to the measurement device 400 using a securing mechanism. The tilt bar 410 in positioned in the measurement configuration. For example, the user may rotate the thumb screw 412 in the first direction until the skate blade 100 is clamped between the clamp portion 450 and the first clamp datum 474. The tilt bar 410 is maintained in the measurement configuration while the skate blade 100 is secured to the measurement device 400.

At block 708, after the skate blade 100 is secured to the measurement device 400, the user may use the measurement device 400 to determine measurement data associated with one or more measurements of the skate blade. The measurement device 400 can determine the delta height H of the skate blade edges. For example, the user may use the power button 416 or another control button to activate a measurement operation. As explained above with reference to FIG. 6G, the measurement system may use a light emitting source, such as laser 502, to generate a laser beam that travels along the laser beam axis B through the filter 506. The laser beam travels towards and is reflected by the reflective section 440 of the tilt bar 410. The reflected laser beam then travels through the lens 508 and is received by the sensor 510. Once the sensor 510 receives the reflected laser beam, the control system determines the angle α of the tilt bar 410. In one example, the control system may analyze data from the sensor 510 and determine the weighted center of mass of the laser spot received by the sensor 510. For example, the weighted center of mass allows for the determination of the angle α of the tilt bar 410 based on the laser spot appearing at different locations on the sensor 510 as the angle α of the tilt bar 410 changes.

When the edges 116, 118 of the skate blade 100 have the same height (i.e., a delta height H of zero or within the acceptable tolerance), the angle α of the tilt bar 410 measured by the measurement device 400 will be zero (e.g., zero or calibrated zero based on the acceptable tolerance). When the edges 116, 118 of the skate blade 100 have different heights (i.e., a delta height H outside of the acceptable tolerance), the angle α of the tilt bar 410 measured by the measurement device 400 will not be zero. The measured angle α and/or delta height H can be used to determine the adjustment needed for the sharpening machine to produce equal edge heights. As noted above, a delta height H within the acceptable tolerance indicates to the user that the edges 116, 118 of the skate blade 100 are even and the skate sharpening was successful, while a delta height H outside of the acceptable tolerance indicates to the user that the edges 116, 118 of the skate blade 100 are uneven and the skate sharpening was unsuccessful.

The calculation of the delta height H of the edges 116, 118 can be a simple geometric calculation using the measured angle α of the tilt bar 410 and the blade thickness 122 of the skate blade 100. In some examples, the blade thickness 122 can be input into the measurement device 400 (e.g., prior to beginning the method 700) by, for example, entering the blade thickness 122 directly into the measurement device 400 or into a software application associated with the measurement device 400. The software application is discussed further herein. In another example, the measurement device 400 may be configured to determine the blade thickness 122 once the skate blade 100 is secured to the measurement device 400. In yet another example, an average value associated with the most common blade thicknesses can be used for the blade thickness 122. For example, the average blade thickness 122 used can be 3 millimeters. Differences in thickness of most common skate blades 100 will generally produce a negligible difference in the calculated delta height H and thus a negligible amount of adjustment needed to correct for measured uneven edges 116, 118. In some examples, the average blade thickness 122 may be selected based on the type of skate blade 100.

With the known or approximated blade thickness 122 and the measured tilt bar 410 angle α, the delta height H of the outside edge 118 and inside edge 116 of the skate blade 100 can be determined using the following equation: delta height=tan(α)×blade thickness.

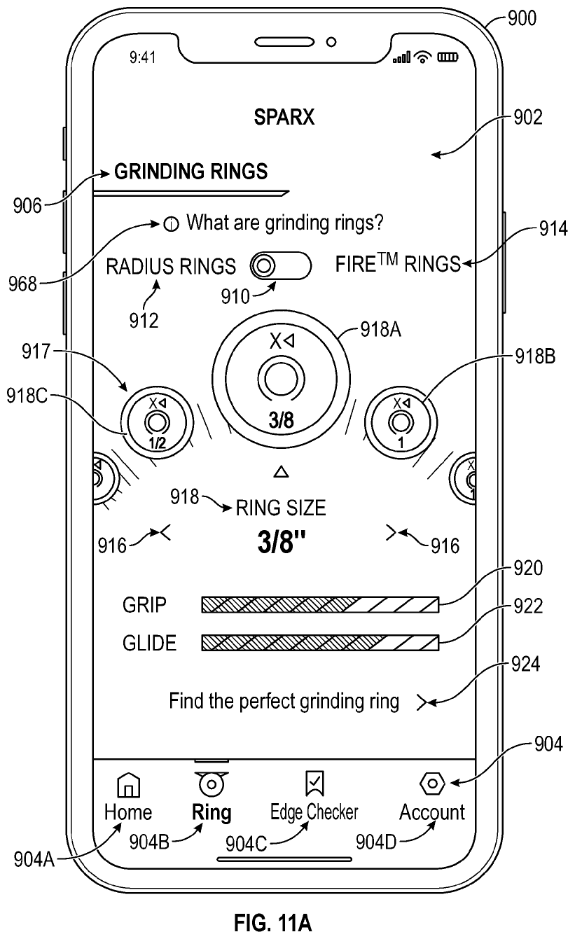

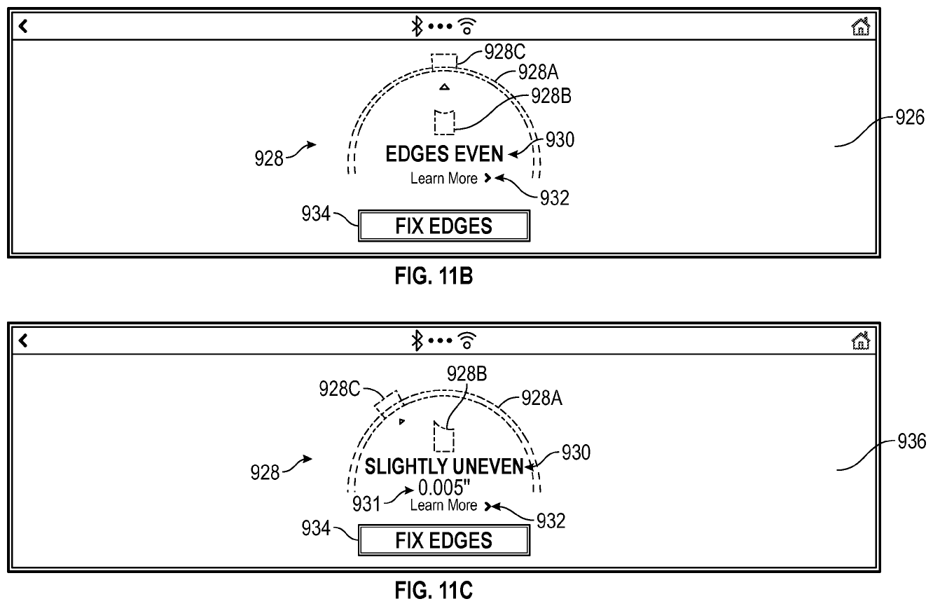

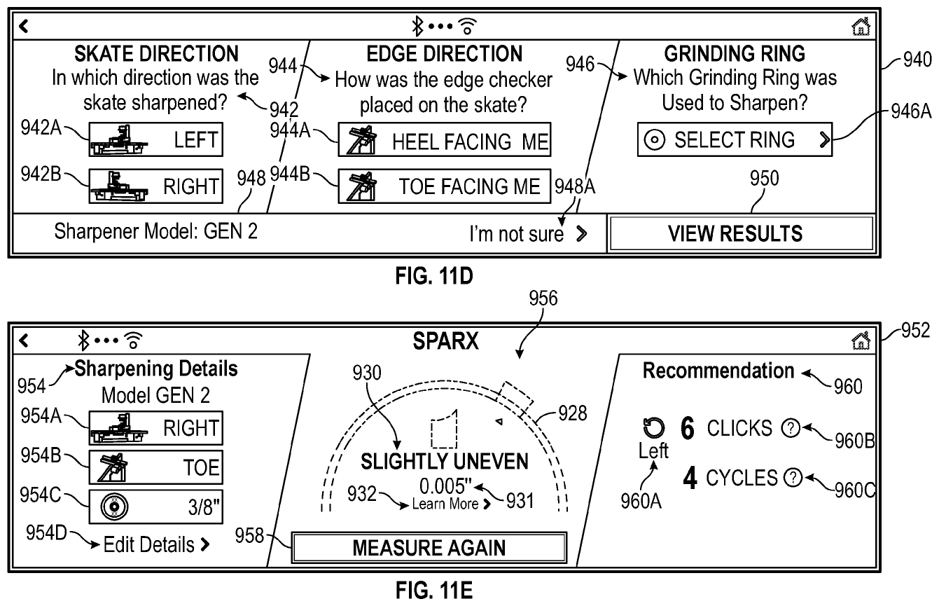

At block 710, the measurement device 400 outputs the measurement result based at least in part on the measurement data. The measurement result can include one or both of the tilt bar 410 angle α and the delta height H of the edges 116, 118. In some examples, the measurement device 400 may include measurement indicators 409, which indicate to the user if the edges 116, 118 are even or uneven, as described above. For example, the measurement indicator 409 may turn a first color, such as green to, indicate that the edges 116, 118 are substantially even (e.g., the delta height H is satisfies a first sharpening threshold), a second color, such as yellow, to indicate that the edges 116, 118 are slightly uneven (e.g., the delta height H satisfies a second sharpening threshold and does not satisfy a first sharpening threshold), and may turn a third color, such as red, to indicate that the edges 116, 118 are significantly uneven (e.g., the delta height H not satisfy a first or second sharpening threshold). In an embodiment where the measurement device 400 includes a display, the output(s) may be displayed on the display of the measurement device 400. In some examples, the output(s) may be transmitted to a software application associated with the measurement device 400 or a third party application (see e.g., FIGS. 11A-11E). In some examples, the output(s) may be transmitted directly to a skate sharpening machine.

As explained further with reference to the method 800 of FIG. 8B, the outputs of the measurement device 400 can be used to calibrate the skate sharpening machine (also referred to herein as a “sharpener”) to produce even edges 116, 118 on the skate blade 100. In some examples, additional information may be required to properly calibrate the skate sharpening machine such as, for example, the model of the sharpener, the orientation of the skate blade 100 in the sharpener, the orientation of the skate blade 100 when measured using the measurement device 400, the grinding wheel 150 size and/or style. Using this information, along with the delta height H calculated, the software app can determine how much the centerline 152 of the grind ring 150 in the machine needs to be adjusted and the prescribed method of adjustment.

FIG. 8B illustrates a method 800 of calibrating a skate sharpening machine based on measurement data generated by the measurement device 400. It is recognized that there are other embodiments of the measurement device 400 and method 800 which may exclude some of the steps shown and/or may include additional steps not shown. Additionally, the steps discussed may be combined, separated into sub-steps, and/or rearranged to be completed in a different order and/or in parallel.

The method 800 begins at block 802, when a user sharpens the skate blade 100 using the skate sharpening machine. The sharpening parameters used by the skate sharpening machine during the sharpening operation can be stored in the sharpener, a third party application, a remote data store (e.g., cloud-based storage). The sharpening parameters may include parameters and settings associated with the sharpener, the skate blade, and/or a user account associated with the sharpener or skate blade. Example sharpening parameters may include, the model of the sharpener, the orientation of the skate blade 100 in the sharpener (e.g., direction of heel 108 or the toe 106 within the sharpener), the grinding wheel 150 size and style, and/or other parameters used by the skate sharpening machine to perform a sharpening operation.

Once the user has sharpened the skate blade 100, at block 804, the measurement device 400 can generate measurement data associated with the skate blade. For example, the measurement data can include the delta height H of the edges 116, 118 of the skate blade 100. The measurement operation can be performed as described with respect to the method 700. In some examples, the delta height H may be displayed on a display of the measurement device 400. In some examples, the delta height H may be transmitted to a software application associated with the measurement device 400 or a third party application (see e.g., FIGS. 11A-11E).

Next, at block 806, the skate sharpening machine is adjusted based on the measurement data. Depending on the type of skate sharpening machine the user is using, the sharpener may be adjusted in at least three different ways. Adjusting the sharpener refers to changing the position of the grinding wheel 150 (e.g., across the width of the skate blade 100) in the machine relative to a pre-set/pre-calibrated position. In a first example, the user may enter information into the sharpener based on the measurement data, such as the delta height H and/or additional information manually into the sharpener. The user may manually adjust the grinding wheel 150 of the sharpener accordingly. In a second example, the measurement device 400 may transmit the measurement data to a sharpener application (e.g., used on a mobile device) and the adjustment information for the grinding wheel 150 can be displayed to the user via the sharpener application. For example, see at least FIG. 11E. Based on the displayed adjustment information, the user can make the necessary adjustments to the sharpener manually. In a third example, the measurement device 400 may transmit the measurement data to the sharpener. For example, the measurement device 400 may transmit the delta height H to a control system locally the sharpener or the measurement device 400 may transmit the measurement data to a sharpener control system remote from the sharpener, which it turn can transmit the measurement data to the sharpener. In the third example, when the adjustment information is relayed wirelessly to the control system, one or more sharpening parameters (e.g., position of the grinding wheel 150) of the sharpener may be automatically adjusted based on the measurement data. For example, the control system may be configured to automatically determine the types of adjustments needed to correct the alignment of the sharpener based on the measurement data.

At block 808, the user may optionally recalibrate the skate sharpening machine. Recalibration can refer to resetting the sharpener's factory nominal or default settings. For example, the recalibration can modify the default centerline 152 of the grinding wheel 150 to a new centerline based on the measurement data output from the measurement device 400. Generally, the recalibration can be performed on the sharpener itself. In some examples, the user may be able to use the sharpener application to recalibrate the sharpener. Generally, it is desirable to recalibrate the sharpener to ensure that future sharpenings on the sharpener produce even edges 116, 118. At block 810, an optional last step, at 810, the user may resharpen the skate blade 100 using the adjusted skate sharpening machine. Because the sharpener has been adjusted and/or recalibrated, the second sharpening of the skate blade 100 should produce even edges 116, 118. Optionally, the user can confirm the edges 116, 118 of the skate blade 100 are even and the delta height H is within the acceptable tolerance. For example, the user may use the measurement device 400 to perform the method 700.

Use of the measurement device 400 to determine the delta height H of edges 116, 118 of the skate blade 100 may provide a number of advantages of existing edge checking systems, such as the edge checker 200. For example, the measurement device 400 may provide a more accurate measurement due in part to the use of the laser 502 and sensor 510 as opposed to using human vision. In another example, the measurement device 400 may improve the adjustment process of the skate sharpening machine based on easy to understand adjustment instructions generated by the measurement device 400 or the sharpener application.

While FIGS. 6A-6H illustrate one example embodiment of the measurement device 400, similar principles and components of the measurement device 400 can be used in any number of additional measurement devices. For example, the shape of the measurement device 400 could be altered, the size of the measurement device 400 could be altered, etc. In one example, the components of the measurement device 400 may be configured for use in a tabletop measurement device. The tabletop measurement device may function in a similar manner to the measurement device 400 but may be configured to be supported by a surface (e.g., a table, the floor, a workbench, etc.) as opposed to being held in the user's hand. In the tabletop measurement device, the user may put the skate blade 100 into the device, instead of mounting the device onto the skate blade 100.

In the example tabletop measurement device, the device may be considered an inverted version of the measurement device 400. For example, the optics system may be positioned near the bottom of the device and be configured to direct the laser beam towards an inverted tilt bar. Because the skate blade 100 is placed into the system from the top side, the datum surface of the tilt bar may be located near the top of the device and configured to engage the edges 116, 118 of the skate blade 100. In some examples, the tilt bar may include a spring system to bias the tilt bar towards the top of the device near the blade slot. In some examples, the tabletop device can also have the ability to move the optics system, manually or motorized, along the length of the blade 100 such that measurements can be taken at different locations along the length of the skate blade 100.

### C. Measurement Device Associated Software

As noted above, in some examples, the measurement devices described herein (e.g., measurement device 400) may be configured to interact with additional devices such as, for example, user devices, skate sharpening machines, third party platforms, and/or the like. In some examples, the measurement devices, user devices, skate sharpening machines, and third party platforms may be configured to communicate over a network. In some examples, the network may comprise one or more networks, including, for example, a local area network (LAN), wide area network (WAN), and/or the Internet, for example, via a wired, wireless, or a combination of wired and wireless, communication links. The network can facilitate communication between the measurement devices, user devices, skate sharpening machines, and third party platforms, and/or additional devices. In addition to or alternatively to communication over the network, in some examples, the various devices may be configured to communicate with each other using Bluetooth, WIFI, and/or the like. User devices, such as user device 900 described below, may include personal computers, laptop computers, phones (e.g., smart phones), tablets, smart watches, and/or the like. The third-party platforms may comprise one database or multiple databases. The third-party platforms may be controlled by a database management system. The third-party platforms may be configured to store sharpening data, sharpening machine data, skate data, information about specific users, and/or the like.

a. Measure Software Application

FIG. 11A illustrates an example first user interface 902 being presented on a user device 900. The first graphical user interface (“UI”) 902 is associated with a software application related to the measurement device 400 being run on the user device 900. For example, a user may use the user device 900 with the associated application to wirelessly communicate with the measurement device 400. While the user device 900 illustrated in FIG. 11A is a smart phone, it is recognized that any other user computing device can be used to run the application.

As shown in FIG. 11A, the software application may include a plurality of user selectable pages 904 related to the user's skate and sharpening equipment (e.g., the user's measurement device 400, skate sharpening machine, skate sharpening accessories, etc.). The selectable pages 904 may include a plurality of pages that can be displayed as UIs on the user device 900. In the example, of FIG. 11A, the user selectable pages 904 include a home page 904A, a ring page 904B, an edge checker page 904C, and an account page 904D. However, it is recognized that the software application could include additional user selectable pages 904. In some examples, the user selectable pages 904 may be displayed on the top, bottom, left side, right side, and/or the like of the user device 900.

In FIG. 11A, the user selected the ring page 904B to display the first user interface 902. The first user interface 902 may include a heading 906, a background information link 908, a ring type selector 910, a grinding ring display 918, and an additional information link 924. The heading 906 may comprise a title or other visual indicator of which page 904 the user has selected. For example, in FIG. 11A, the user selected the ring page 904B, so the heading 906 includes a written heading “Grinding Rings”. The background information link 908 may include additional background information related to the user selected page 904. For example, on the ring page 904B, the background information link 908 may read “What are grinding rings?”. A user could select this text to learn more information about grinding rings. In some examples, by selecting the link (e.g., touching the screen on a touch screen device, clicking the link with a cursor, etc.), the software application may generate an additional UI that includes information about the selected topic. In another example, selecting the link may generate a web link and/or automatically open a web page related to the topic, such as, for example, directing the user to a web page associated with the software application.

The ring type selector 910 may allow a user to choose which type of grinding ring their sharpener is currently using or the grinding ring the user would like to use for a sharpening. For example, the user may be using a first type of ring 912, a second type of ring 914, a third type of ring (not shown), etc. In the example illustrated, the ring type selector 910 allows a user to toggle between the two types of rings 912, 914 shown. However, in another example, the user may be able to make a ring type selection in another manner, such as, for example, by selecting a ring type display using their figure or a cursor, clicking a checkbox, and/or the like.

The grinding ring display 918 may be configured to display the grinding ring size and/or an image of the grinding ring the user has selected that may correspond to the grinding ring the user is currently using in their skate sharpening device. For example, the first user interface 902 may include selectable elements 916 that the user can select to change the ring size. As the ring size is an important factor for skate sharpening, it is important that the user select the correct ring size to successfully calibrate their machine for any edge corrections. In the example first user interface 902, the user has indicated a ⅜ inch ring size. Additionally displayed is the ring image 916A corresponding to the ⅜ inch ring the user indicated they are using in their sharpener. In some examples, the first user interface 902 may include a carrousel 917 of user selectable ring sizes. As the user uses the selectable elements 916 to change the displayed ring size, the carrousel 917 may rotate to display an image of another ring size. For example, by clicking the right selectable element 916, the carrousel 917 may rotate to the left to display the ring image 918B (corresponding to a 1 inch grinding ring) in the center of the first user interface 902. In another example, by clicking the left selectable element 916, the carrousel 917 may rotate to the right to display the ring image 918C (corresponding to a ½ inch grinding ring) in the center of the first user interface 902. By changing the ring size, the first user interface 902 may also be updated to change performance indicators associated with the ring size. In one example, the first user interface 902 may include a grip performance indicator 920, a glide performance indicator 922, and/or additional performance indicators (not shown) related to the grinding ring size. The grip performance indicator 920 may indicate how much grip a user can expect when their skate blade 100 is sharpened using the selected grinding ring. The glide performance indicator 922 may indicate how much glide a user can expect when their skate blade 100 is sharpened using the selected grinding ring. While FIG. 11A illustrates the grip performance indicator 920 and glide performance indicator 922 as fillable bar elements, it is recognized that any other visual indicator could be used such as a pie graph, numerical indicator, alphabetical indicator, and/or the like.

The additional information link 924 may include additional information to assist the user related to the selected page 904. For example, on the ring page 904B, the additional information link 924 may read “Finding the perfect grinding ring”. A user could select this text to learn more information about which grinding ring and grinding ring size is best for their specific use of their skates. In some examples, by selecting the link (e.g., touch the screen on a touch screen device, clicking the link with a cursor, etc.), the software application may generate an additional GUI that includes information about the selected topic. In another example, selecting the link may generate a web link and/or automatically open a web page related to the topic, such as, for example, directing the user to a web page associated with the software application.

FIGS. 11B-11E illustrate example user interfaces associated with the edge checker page 904C. The user may use the edge checker page 904C of the software application after they complete a sharpening of the skate blade 100 and measure the delta height H of the edges 116, 118 using a measuring device, such as the measurement device 400. For example, as described at 710 of the method 700 of FIG. 8B, in some cases the measurement device 400 may transmit measurement data, such as the measured delta height H, to the software application. As described below, the user may use the software application to receive the measurement data and/or determine how to adjust their skate sharpener to remedy uneven edges 116, 118 of their skate blade 100.

FIG. 11B illustrates a second UI 926 displayed on the first user interface 902. As noted above, the second UI 926 may have been generated for display when the user selected the edge checker page 904C. In some examples, by selecting the edge checker page 904C, the software application may be configured to receive and display an output associated with the measurement data, such as edge measurements received from the measurement device 400. In another example, the software application may automatically receive measurement data from the measurement device 400 when the measurement device 400 and a computing device using the software application are in short range communication protocols, such as near field communication, or, for example, operating on the same local area network.

The second UI 926 indicates an even edge measurement. The second UI 926 may include a graphic 928, an edge indicator 930, an information link 932, and a fix edges option 934. The graphic 928 may include a measurement grid 928A, an edge display 928B, and an edge height indicator 928C. The measurement grid 928A may comprise a grid of all possible measurements and an indicator mark corresponding to the location on the ruler that marks the edge height reading. While the measurement grid 928A is illustrated as a semi-circle, it is recognized that any suitable style for the measurement grid 928A could be used, such as, a straight line. In the example of FIG. 11B, the sharpening operation produced even edges and as such, the graphic 928 displays the edge display 928B and the edge height indicator 928C as centrally aligned. The edge display 928B may provide a visual indication of the edges 116, 118 of the skate blade 100. Where the measured edges are even, as in FIG. 11B, the edge display 928B may illustrate even edges. Conversely, when the measured edges are uneven, as in FIG. 11C, the edge height indicator 928C and the edge display 928B may illustrate uneven edges. The edge height indicator 928C may comprise a square or other suitable shaped. In some examples, the edge height indicator 928C may be positioned on the left or right side of the edge display 928B, as an indication of which edge of the skate blade 100 is high or low and also which direction the grinding ring 150 in the skate sharpener needs to be moved to correct the uneven edges. The edge indicator 930 provides an indication of whether the measured edges 116, 118 of the skate blade 100 were even or uneven. In the example of FIG. 11B, the edges were even such that the edge indicator 930 may read “Edges Even”. The information link 932 may be configured to be user selectable such that the user can learn more information about the delta height H measurement, the measurement device 400, how even vs uneven edges affect skating performance, and/or the like. The fix edges option 934 may be configured to be user selectable to generate additional UIs (e.g., additional display screens) of the software application for display on the user device 900. The user may select the fix edges option 934 when they wish to learn how to adjust their skate sharpening machine to correct the edges 116, 118 of their skate blade 100. In the example of FIG. 11B, the user's edges are even, and no correction is necessary. In some examples, the measurement information displayed in the second UI 926/third UI 936 may be automatically updated as the user is using the measurement device 400 to measure the skate blade 100.

FIG. 11C illustrates a third UI 936 displayed on the user device 900. The third UI 936 is similar to the second UI 926 and may have been generated for display when the user selected the edge checker page 904C. However, in the third UI 936, the measured edges 116, 118 of the user's skate blade 100 are uneven. Like the second UI 926, the third UI 936 may include the graphic 928 (e.g., the measurement grid 928A, the edge display 928B, and the edge height indicator 928C), the edge indicator 930, the information link 932, and the fix edges option 934. Additionally, because the edges are uneven in FIG. 11C, the third UI 936 includes a delta height H display 931.

In the example of FIG. 11C, the sharpening operation produced uneven edges and as such, the graphic 928 shows that the edge display 928B and the edge height indicator 928C as not aligned. Similarly, the because the measured edges are uneven, the edge height indicator 928C may illustrate uneven edges and the edge indicator 930 may read “Slightly Uneven”. In some examples, the edge indicator 930 may change depending on the delta height H measured. For example, where the edges are significantly uneven, the edge indicator 930 may read “Uneven” and where the edges are only slightly uneven, the edge indicator 930 may read “Slightly Uneven”. The delta height H display 931 illustrates the measured delta height H received from the measurement device 400. In FIG. 11C, the measured edges 116, 118 had a delta height H of 0.005 inches, which is displayed in the third UI 936. In this example, because the edges are uneven, the user may wish to select the fix edges option 934 to receive instructions on how to adjust their skate sharpener to correct the uneven edges. When the user selects the fix edges option 934, a fourth UI 940, that instructs the user to input additional information to determine the necessary adjustments for the skate sharpener, may be displayed on the user device 900.

FIG. 11D illustrates the fourth UI 940 displayed on the user device 900. The fourth UI 940 provides a series of questions for the user so that the software application can determine how the user should adjust the skate sharpening machine to produce even edges on a next sharpening operation. The fourth UI 940 may include a skate direction section 942, an edge direction section 944, a grinding ring section 946, a sharpener section 948, and a results option 950.

The skate direction section 942 may prompt the user to indicate in which direction the skate was sharpened. The skate direction section 942 may include user selectable options such as a left option 942A and a right option 942B. The user may select either option to indicate the direction in which they sharpened the skate blade 100. In some examples, including the example illustrated, the left option 942A and the right option 942B may include graphics to assist the user in determining the correct option.

The edge direction section 944 may prompt the user to indicate in which direction the edge checker (e.g., the measurement device 400) was placed on the skate blade 100. The edge direction section 944 may include user selectable options such as a heel option 944A and a toe option 944B. The user may select either option to indicate the direction the skate blade 100 was facing when they measure the delta height H using the measurement device 400 (i.e., with the heel 108 or the toe 106 facing the user). In some examples, including the example illustrated, the heel option 944A and the toe option 944B may include graphics to assist the user in determining the correct option.

The grinding ring section 946 may prompt the user to indicate which grinding wheel 150 was used in the skate sharpening machine to sharpen the skate blade 100. The grinding ring section 946 may include a user selectable option such as a select ring option 946A. The select ring option 946A may allow the user to indicate the type and size of grinding wheel 150 the user used. In some examples, selecting the select ring option 946A may cause the software application to generate the ring page 904B discussed above with reference to FIG. 11A. Using the ring page 904B, the user can indicate the type and size of the grinding wheel 150. In some examples, the user may return to the fourth UI 940 by selecting the edge checker page 904C. In another example, the ring page 904B may include a back arrow or some other user selectable option to return to the fourth UI 940.

The sharpener section 948 may include an indication of which skate sharpening machine the user used to sharpen the skate blade 100. For example, the sharpener section 948 may display different sharpener models. In some examples, the user may be able to select a user selectable option in the sharpener section 948 to change or select their current sharpener model. For example, the user may select an option 948A, which may allow the user to select their current sharpener. In some examples, the software application may generate images of the different sharpener models to assist the user with selecting their current model. Once the user has input all of the required information in the different sections of the fourth UI 940, the user may select the results option 950 to view the results. Selecting the results option 950 may cause the software application to generate an additional UI, such as a fifth UI 952, which provides the user with recommendations on how to adjust their specific skate sharpener to achieve even edges on the next sharpening job.

FIG. 11E illustrates the fifth UI 952 displayed on the user device 900. The fifth UI 952 may provide the user with suggestions on how to adjust their skate sharpening machine and how to re-sharpen their skate blade 100 to achieve even edges. The fifth UI 952 may include a sharpening details section 954, a measurement results section 956, a measure again option 958, and a recommendation section 960.

The sharpening details section 954 may provide the user with the sharpening details they provided the software application (e.g., via the fourth UI 940 discussed with reference to FIG. 11D). For example, the sharpening details section 954 may include a skate sharpening indication 954A, an edge direction indication 954B, a grinding ring indication 954C, and an edit details option 954D. The skate sharpening indication 954A may indicate the selection made via the skate direction section 942 in the fourth UI 940 (i.e., whether the skate direction was left or right when the skate blade 100 was sharpened). The edge direction indication 954B may indicate the selection made via the edge direction section 944 (i.e., whether the toe 106 or heel 108 was facing the user when the edges 116, 118 were measured using the measurement device 400). The grinding ring indication 954C may indicate the selection made via the grinding ring section 946 (i.e., the type and size of the grinding ring 150 used to sharpen the skate blade 100). The edit details option 954D may be a user selectable option that allows the user to edit any of the sharpening details. For example, selecting the edit details option 954D may cause the software application to generate the fourth UI 940 so that the user can edit any section as desired.

The measurement results section 956 may provide display the edge measurements received from the measurement device 400. The measurement results section 956 may repeat the information discussed with reference to FIGS. 11B and 11C. For example, the measurement results section 956 may provide the graphic 928, the edge indicator 930, the delta height H display 931, and the information link 932.

The recommendation section 960 may provide the user with recommendations on how to adjust their skate sharpener. For example, the recommendation section 960 may include a direction indicator 960A, a click recommendation 960B, and a cycles recommendation 960C. The direction indicator 960A indicates which direction the grinding wheel y-axis adjustment knob should be adjusted, such as right or left, to cause the grinding wheel 150 to move in the machine relative to the skate blade 100 depending on the sharpening details and the measurement results. The click recommendation 960B may indicate to the user how much to rotate the grinding wheel 150. For example, in some sharpening machines, the grinding wheel 150 may be adjusted a certain number of clicks. The click recommendation 960B provides a recommended number of clicks to adjust the grinding wheel 150 so that the next sharpening job will align the central axis 120 of the skate blade 100 and the central axis 152 of the grinding wheel 150. When the edges 116, 118 have a large delta height H, the number of clicks is greater than when the edges 116, 118 have a small delta height H. The cycles recommendation 960C may indicate to the user how many cycles or passes the skate blade 100 requires under the grinding wheel 150 when the user re-sharpens the skate blade 100. For example, once the user adjusts the sharpening machine based on the recommendation, the user will generally want to re-sharpen their skate blade 100 to fix the edges. The cycles recommendation 960C provide the number of cycles the skate blade 100 requires when re-sharpened to have even edges. In some examples, the recommendation section 960 may include an additional selectable option (not shown) to implement the recommendation on the machine automatically. For example, as described herein, some skate sharpening machines may be automatically adjusted via the software application. By selecting this option, the software application may send an instruction (e.g., over the network) to the skate sharpening machine that causes the skate sharpening machine to automatically adjust the position grinding wheel 150.

The measure again option 958 may provide the user with the option to remeasure the edges 116, 118 of the skate blade 100 after they re-sharpen. For example, once the user re-sharpens the skate blade 100 using the recommendation, the user may wish to measure the delta height H again using the measurement device 400. By selecting the measure again option 958, the software application may be configured to receive another measurement from the measurement device 400 once the user re-measures the skate blade 100. For example, selecting the measure again option 958 may generate a measurement UI similar to those shown in FIGS. 11B and 11C. Generally, where the user properly adjusted their skate machine and resharpened the skate blade 100, the second measurement UI will be similar to the second UI 926 of FIG. 11B and indicate to the user that the edges 116, 118 of the skate blade 100 are now even.

b. Blade Analysis Software Application

FIG. 13A-13C illustrates additional UIs that may be generated by the software application described above or an additional software application for display on the user device 900. In some examples, the user may use the user device 900 to analyze the skate blade 100. In some examples, the skate blade 100 or the actual skate boot itself may include a machine-readable optical label (such as, for example, a QR code or a Barcode). The user may use the user device 900 (e.g., the camera) to scan the machine-readable code, which may cause the software application to display information about the skate blade 100, such as for example, the skate blade thickness, skate blade flatness, blade length, model, size, owner, which skate (such as, right, left), and/or the like. In some embodiments, the skate blade 100 or the skate itself may include multiple QR codes. For example, a first QR code may provide blade 100/skate information, and a second QR code provide information about the user (e.g., desired hollow, player information, etc.).

FIG. 13A illustrates a generated geometric data UI 1302 displayed on the user device 900. In one example, the user may use the software application and the camera on the user device 900 to scan the skate blade 100. In another example, the camera may be separate from the user device 900 (e.g., a phone used to pull in a picture to a browser-based application viewable on a phone, tablet, computer, etc.). In another example, one or more separate device could be used to measure and/or gather data about the skate blade 100 and store this data externally (e.g., in a cloud storage location). The user device 900 may then be used to scan a machine-readable code on the skate blade 100, causing the stored data to be imported into the user device 900. In some examples, the user may rotate the skate blade 100 while the camera captures images of the skate blade 100. Based on the scanning of the skate blade 100, the software application may generate the geometric data UI 1302. The geometric data UI 1302 may include a side view section 1304, a profile section 1306, a 3D section 1308, and a measurement section 1310. The side view section 1304 may illustrate a side view of the skate blade 100. The profile section 1306 may illustrate the profile of the skate blade 100. The 3D section 1308 may illustrate a 3D rendering of the skate blade 100. The measurement section 1310 may illustrate measurements taken of the skate blade 100, such as, for example, the radius of hollow 114, the depth of the hollow 114, a first bite angle, a second bite angle, an even edge angle, an even edge offset, and/or the like.

FIG. 13B illustrates a blade profile UI 1312 displayed on the user device 900. The blade profile UI 1312 displays rocker profile data, which may have been generated by capturing images of the side view of the skate blade 100. The blade profile UI 1312 may include a player section 1314, a blade profile section 1316, and a measurement section 1318. The player section 1314 may include information about the owner of the skate blade and the type of scan performed. For example, the player section 1314 may include the group the player is in, the player name, the type of skate blade 100, the scan time, and a specification of the type of scan performed. The blade profile section 1316 may include a profile of the skate blade 100 and may include information such as the heat balance point, the balance point, the center location of the skate blade 100, the toe balance point, and/or the like. The measurement section 1318 may include measured information about the skate blade 100 such as, for example, the heal balance length, the toe balance length, the total balance length, the balance point offset, the rocker radius of a first section, the rocker radius of a second section, and/or the like.

FIG. 13C illustrates a sharpening response UI 1320 displayed on the user device 900. The UI 1320 may include player specific response data that can be entered into the software application and tracked historically along with the sharpening information in order to help the user optimize performance. This information can be used with a machine learning algorithm to provide the user with trending information, wear analysis, etc. The UI 1320 may include the player section 1314 and a performance section 1322. The performance section 1322 may include measured information about the players performance, such as, for example, a hard inside edge stop, a hard outside edge stop, a power turn inside edge, a power turn outside edge, forward acceleration strip, forward power stride, forward cross under (inside edge and outside edge), forward cross over (inside edge and outside edge), top end speed, and/or the like. The performance section 1322 may also include toggle bars a user can manipulate between max grip at a first end (the left side in FIG. 13C) and max glide at an opposite second end (the right side in FIG. 13C).

### D. Additional Measurement Devices

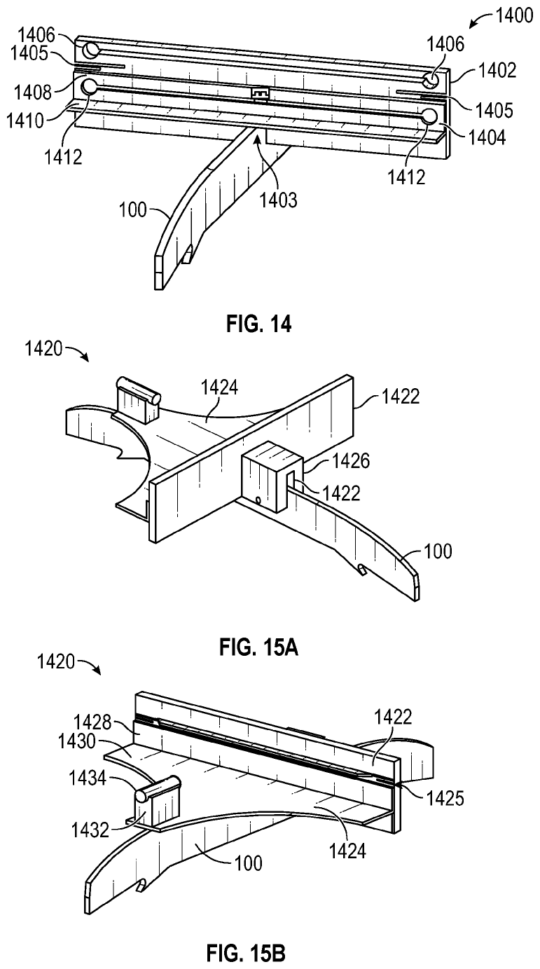

FIGS. 14-16B illustrate additional measurement devices and systems that may be used to determine the delta height H of the edges 116, 118 of the skate blade 100. In some examples, these devices may be used in conjunction with a software application which may be run on a user device, such as the user device 900.

a. Fiducial Measurement Device

FIG. 14 illustrates an embodiment of a measurement device 1400 positioned on the skate blade 100. The measurement device 1400 may include a datum reference plate 1402 and an angle reference plate 1404. The datum reference plate 1402 may comprise a plate of metal or other suitable material that is configured to be mounted to the skate blade 100 via conventional means. The datum reference plate 1402 may include a blade slot 1403 configured to receive the skate blade 100 and a plurality of visual indicators 1405. The datum reference plate 1402 may include datum optical fiducials 1406 positioned near the top corners of the datum reference plate 1402. The angle reference plate 1404 may comprise an L-shaped plate comprising a back plate 1408 and a bottom plate 1410. The angle reference plate 1404 may be configured to rotate freely about an axis relative to the datum reference plate 1402. The bottom plate 1410 may be configured to rest of the edges 116, 118 of the skate blade 100 when the skate blade 100 is secured to the measurement device 1400. The back plate 1408 may include angle optical fiducial 1412 positioned on both sides of the 1408 and vertically aligned with the datum optical fiducials 1406 when the angle reference plate 1404 is in a neutral not rotated position. The datum optical fiducials 1406 and the angle optical fiducial 1412 may provide for an accurate and precise analysis measurement of the delta height H of the edges 116, 118. In some embodiments, including the embodiment illustrated, the fiducials 1406, and 1412 may comprise circles, however, it is recognized that other suitable shapes, geometries and patterns can be used as well.

To determine the delta height H of the edges 116, 118, the user may scan, take pictures, take videos, and/or the like of the measurement device 1400 once positioned on the skate blade 100 using the user device 900. As noted above, the user device 900 may run a software application. The software application may be configured to determine the positions of the angle optical fiducial 1412 relative to the datum optical fiducials 1406. For example, the software application may perform image analysis/processing (e.g., object recognition, image filtering, algorithms, blob analysis, and/or the like) to determine the relative positions. Based on an analysis of the fiducials 1406, 1412, the software application may determine the delta height H of the edges 116, 118. Like the measurement devices described above, the determined delta height H may be used to adjust a skate sharpening machine in a similar manner to the method 800 of FIG. 8B, and the process described with reference to FIGS. 11A-11E.

Generally, the measurement accuracy of the edge height measurement is reliant on the accuracy of the fiducial 1406, 1412 placement with respect to the reference surfaces of the datum reference plate 1402 and angle reference plate 1404. In some cases, it may be possible to improve accuracy with a second set of fiducials (not shown) on the back side of the angle reference plate 1404. In a “calibration mode”, the user may take images of the angle reference plate 1404 in a correct position and in a reversed position with either a sharpened skate or a reference gauge and the application software may then compensate for any small angular mismatch. In some embodiments, there may be more than one fiducial in a given image and the more than one fiducial may be on multiple surfaces that are not all on the same plane and in some instances the planes could be as much as 90 degrees offset from one another in order to provide additional image data to help the image processing performed by the application software to interpret the image data captured of the measurement device 1400. In some examples, the measurement device 1400 may include a machine-readable code (e.g., a barcode, QR code, etc.) such that when the user generates images of the measurement device 1400 using the user device 900, the specific machine readable code may be attributed to the specific measurement device 1400 such that the calibration data may be stored individually for that measurement device 1400.

The fiducials 1406, 1412 may be created in the hardware components (e.g.,) in a number of different ways using conventional manufacturing techniques. For example, one method which can be employed is to manufacture the datum reference plate 1402 and the angle reference plate 1404 using aluminum, anodize these components with a dark color, and remove material to reveal the brighter bare aluminum underneath. This process may be completed through, for example, a physical machining process and/or with a laser etching process. These process(es) may create an accurate and high contrast feature or features that can be easily visualized by image processing using the software application.

b. Laser Line Measurement Device

FIGS. 15A and 15B illustrate an embodiment of a measurement device 1420 positioned on the skate blade 100. FIG. 15A illustrates a back perspective view of the measurement device 1420 and FIG. 15B illustrates a front perspective view of the measurement device 1420. The measurement device 1420 may function in a similar manner to the measurement device 1400 but may include mounted a line laser. The measurement device 1420 may include a datum reference plate 1422 and an angle reference plate 1424. The datum reference plate 1422 may comprise a plate of metal or other suitable material that is configured to be mounted to the skate blade 100 via conventional means, such as the mount 1426. The datum reference plate 1422 may include a blade slot 1423 configured to receive the skate blade 100 and a plurality of visual indicators 1425. The angle reference plate 1424 may comprise an L-shaped plate comprising a back plate 1428 and a bottom plate 1430. The angle reference plate 1424 may be configured to rotate freely about an axis relative to the datum reference plate 1422. The bottom plate 1430 may be configured to rest of the edges 116, 118 of the skate blade 100 when the skate blade 100 is secured to the measurement device 1400. The bottom plate 1430 may include a curved tapered body that extends partially along the length of the skate blade 100. The bottom plate 1430 may include a laser mount 1432 and a laser 1434 (e.g., a line laser). The laser 1434 is configured to project a line onto the datum reference plate 1422, which can allow for more accurate and precise analysis of the images and resulting measurements of the delta height H of the edges 116, 118.

To determine the delta height H of the edges 116, 118, the user may scan, take pictures, take videos, and/or the like of the measurement device 1420 once positioned on the skate blade 100 with the projected laser line using the user device 900. As noted above, the user device 900 may run a software application. The software application may be configured to determine angle of the projected laser line relative to the datum reference plate 1422. For example, the software application may perform image analysis/processing (e.g., object recognition, image filtering, algorithms, blob analysis, and/or the like) to determine the relative angle of the laser line. Based on an analysis of the laser line, the software application may determine the delta height H of the edges 116, 118. Like the measurement devices described above, the determined delta height H may be used to adjust a skate sharpening machine in a similar manner to the method 800 of FIG. 8B, and the process described with reference to FIGS. 11A-11E.

c. Image Analysis

FIG. 16A illustrate an embodiment of a measurement device (e.g., measurement device 1400 or measurement device 1420) being used to illustrate the image processing and analysis to determine the angle between the datum reference plate and the angle reference plate. FIG. 16A illustrates the camera view of the measurement device. FIG. 16C illustrates a close up view of the image analysis of the visual indicators 1405, 1425. As shown, the camera of the user device 900 may identify areas of interest for analysis such as a first detection box 1442 and a second detection box 1442. While not shown in FIG. 16A, the detection boxes 1442, 1444 may detect the plurality of visual indicators 1405, 1425 (see e.g., FIG. 16C). Depending on the embodiment, the detection boxes 1442, 1444 or additional detection boxes may detect the features of the measurement device 1400 and measurement device 1420 such as, for example, the fiducials 1406, 1412, the projected laser line, and/or the like. Based on detecting these features, the software application can determine the delta height H of the edges 116, 118 of the skate blade 100. The software application may perform image analysis by, for example, object recognition, image filtering, algorithms, blob analysis, and/or the like. FIG. 16B illustrates a UI 1460 that may be generated by the software application based on an analysis of the skate blade 100.

In some cases, a user may perform an analysis of a skate blade using the software application and the process described below. The software application may include a skate blade analysis system that may be executed on a mobile computing device, such as the user device 900. The user device 900 may include a user interface for the user to interact with one or more of the systems and devices described herein (e.g., the measurement device 1400, the measurement device 1420, etc.). It is recognized that there are other embodiments of the systems and process which may exclude some of the steps shown and/or may include additional steps not shown. Additionally, the steps discussed may be combined, separated into sub-steps, and/or rearranged to be completed in a different order and/or in parallel.

To begin the process, the user may first open the software application via their user device 900. Next, the user may optionally scan the machine readable code on the skate blade 100 to access additional information as described above. Next, the application may direct the user as to the correct direction/orientation to load the skate blade 100 into the sharpener. In another example, the application may prompt the user to indicate to the application the direction that the skate blade 100 was loaded into the machine, such as during the most recent sharpening. After the user has loaded the skate and/or skate blade 100 in the machine sharpening device, the user may sharpen the skate blade 100. In one embodiment, the user may manually initiate the sharpening operation on machine. In another embodiment, the sharpening operation may be initiated or controlled by the application on the user device 900 such as, for example via Bluetooth, Wi-Fi, a wired connection, and/or the like. It is recognized that the user may skip this step if the skate was already sharpened. Next, the user may remove skate blade 100 from sharpener. In some embodiments, certain models may not require this step to be completed.

Once the skate blade 100 is removed, the user may attach a measurement device (e.g., the measurement device 1400, measurement device 1420, etc.) to the skate blade 100. Next, the user may activate a live view port on the software application, such as, for example, interactively selecting the live view port option in the application. The live view port is a step where the user device 900 camera is made available for use in the application. Next, the user may position the blade relative to the camera such that the camera depth axis is approximately parallel and centered with skate blade 100. In this position, the mobile computing device camera will be directly facing the front of the datum reference plate and angle reference plate of the measurement device, with the camera depth access approximately normal to the face of the datum reference plate. In some embodiments, the application may provide an overlay of graphics and/or helpful pictures/indicators to display on the user interface of the application that may guide the user and ensure correct camera and/or measurement device orientation. For example, the application may help the user ensure that the heel 108 or toe 106 of skate blade 100 is closest to the user and the correct location and orientation of the datum reference plate and angle reference plate. In one example, the user may hold the skate blade 100 in one hand and the camera in another. In other example, one or both the skate blade 100 and/or the camera may be fixtured to a stationary apparatus.

Next, the user may move camera and/or the skate blade 100 until one or both the datum reference plate and angle reference plate are in the field of view and are focused. In some embodiments, a user may utilize guidelines superimposed on the image to help align the image. In some embodiments, the application may be configured to automatically determine and provide user interface information to help a user and ensure correct alignment. In some embodiments, the application may prompt the user to orient the skate blade 100 a certain way, such as, for example heel 108 towards the camera. In other embodiments, the application may determine the orientation of the skate blade 100 through image processing, such as, by analyzing the image for distinctive features of the skate blade 100, which would signal the skate direction. In some embodiments, if the application could not determine the orientation of the skate within a certain threshold of accuracy, such as, for example, 80%, 85%, 90%, 95%, 99%, and/or the like, the application may prompt the user to confirm the orientation.

Next, when the skate blade 100 and measurement device are in focus (e.g., including the fiducials 1408, 1412 or the projected laser like, depending on the embodiment), the application may require a picture by taken via the user device 900. For example, the application may automatically take a picture or may prompt a user to manually take the picture. In some embodiments, the application may guide the user to slowly move the skate blade 100 through a given angular rotation so that the application can take multiple pictures or video.

As an optional next step, the application may first analyze the image(s) to ensure that the measurement device being used is a specific type and or brand of device affiliated with the application, such that the measurement device can properly function and is approved for use with the application. For example, the application may analyze one or more images of a logo or set of logo marks on the measurement device. In another example, a machine-readable code may be used in conjunction with the logo mark to further improve the ability of the application to verify authenticity of the measurement device. Verification may, for example, involve authenticating a serial number for the measurement device with a database via the user's user device 900 and the internet. If this feature is implemented, the application may proceed to the next step once the measurement device is authenticated. In some embodiments, if the measurement device is not authenticated, the application may abort and/or prompt the user to attempt to authenticate again.

Next, the application may analyze the image or video data. Analyzing the data may include determining if the image/video quality is acceptable before continuing analysis. For example, the application may use the known geometry of the datum reference plate and angle reference plate. The application may generate a variety of response using unique and/or proprietary algorithms, such as, for example: data filtering, data compression, data analysis, calibration algorithms, speed enhancement for processing, graphical representations and displays for data visualization, image processing, image recognition, machine learning, artificial intelligence, and/or the like. In some embodiments, the application processing may be completed on the user device 900. In another embodiment, some or all of the application processing may be completed on another computing device. For example, once the image or video data is captured using the user device 900, the data may be transferred to another computing device and/or server for processing, such as by transmitting the data over the internet. The other computing device and/or server would then process the data in a similar manner and transmit data for generating the variety of responses back to the mobile computing device. In some embodiments, both the mobile computing device and other computing devices and/or servers complete the processing together.

When the application has completed the analysis, the application may generate a variety of response, such as, for example, providing the user with results and suggestions. For example, see FIG. 11E. In another example, the application may inform the user that the analysis is complete without providing any results or instructions. Generally, when the application provides the user of one or more adjustment(s), the adjustments are for altering the sharpening machine to achieve the desired results of a sharpening operation. For example, a desired result may be even edges. In some embodiments, the application may prompt the user to select if they would like the application to communicate the adjustment information directly to the machine and to make the adjustments automatically. In some embodiments, the application will automatically make the necessary adjustments at the sharpening machine without prompting the user.

After the adjustments are made, the user may sharpen the skate blade 100 again. In some embodiments, the user may be prompted to repeat the measurement process. The measurement information can serve to feed the machine learning part of the image processing algorithm for calibration of the system (real input to real output) for continuous improvement of the algorithm. In some embodiments, the application may prompt the user to take multiple images or videos from different angles, and/or different datum reference plate attachment locations and analyze multiple images or videos to eliminate erroneous measurements due to user error, burrs under the clamping surface, and/or the like.

In some embodiments, the application may also be used to track critical performance statistics that can be used, sometimes with, for example, machine learning, to provide feedback to the user to optimize skating performance. For example, some of these performance indicators are discussed with reference to FIGS. 13A-13C. These critical parameters to track include, but are not limited to the following. The profile being used on skate blades 100. In some embodiments, the profile can be either entered by user or determined by sensors in the sharpener. The hollow 114 of the skate blade 100. The remaining height of blade 100 material (for example, stainless steel). The material removal rate of blade material. In some embodiments, this information can be used to calibrate/optimize the number of cycles for a desired sharpening (e.g., touch-up sharpening selection). The wear analysis and/or other geometric measurements used on blades. The skate information (e.g., brand, model, size, etc.). The skate blade 100 information (e.g., brand, model, length, thickness, blade material, etc.). The player information (e.g., height, weight, position, etc.). The ice conditions being skated (e.g., temperature, etc.). Game/Practice time information. In some embodiment this information could be tracked real time by interfacing with other applications such as, for example, a fitness tracker or by methods on its own. This could include maximum skating speed, average skating speed, heart rate, shift length, rest length, skating acceleration, stopping distance, goals scored, assists, and/or the like).

In some embodiments, the machine learning algorithm is configured to optimize the system for a specific grinding wheel 150. For example, optimizing may require that the hollow 114 be known in order to convert an edge to edge reading to an amount of adjustment for the sharpener device to restore the edges to even.

### E. Skate Blade Profiling Section

Skate Profiling is a method by which a specific shape or “profile” is created on an ice skate blade, such as the skate blade 100 for the purposes of altering and/or optimizing the performance of the skater. The “profile” refers to the shape of the bottom portion 104 of the blade 100 that is in contact with the ice and is in the plane perpendicular (or normal) to that when looking at the skate and/or skater from the skater's left or right side (i.e., the shape of the blade that touches the ice, from toe 106 to heel 108).

Profiling machines can generally fall into two categories: 1) profiling machines that use templates to create a specific profile for the skate blade and 2) computer-controlled profiling machines that can use selectable programs to create the desired shape in the skate blades. Template-based machines can be simpler to design, less complex on the electrical/software side, and less expensive to fabricate as simpler electronics and controls are needed. A limitation of the template-based system is that a different template is needed for every different shape desired and ideally the template is also different for each size of skate blade. These limitations can result in an exponential number of templates needed to offer a comprehensive profiling machine and service. A limitation of computer-controlled machines on the market today is that they use antiquated electrical and software technology in their implementation, which limits their computing power and analysis. Additionally, the currently marketed machines typically require physical software cards/disks to update the available profiles on these machines.

Current profiling machines and devices have many limitations. It is desirable to have a new system for skate blade profiling.

a. Overview

The systems described herein relate to a system that may be a dedicated profile machine or a machine that performs profiling and sharpening operations. The terms “profiler” and “sharpener” as used herein can refer to the same device. Similarly, the terms “profiling machine” and “sharpening machine/device” as used herein can refer to the same device.

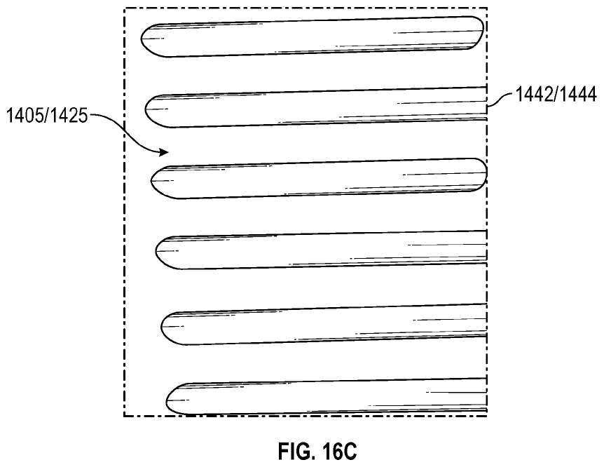

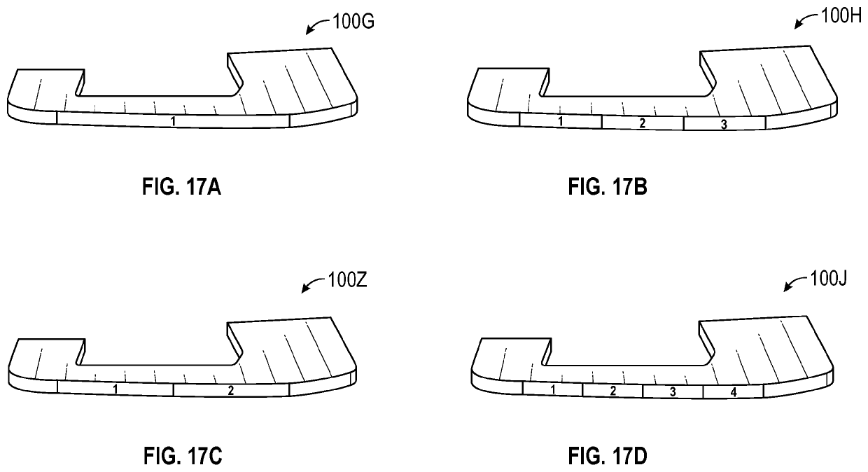

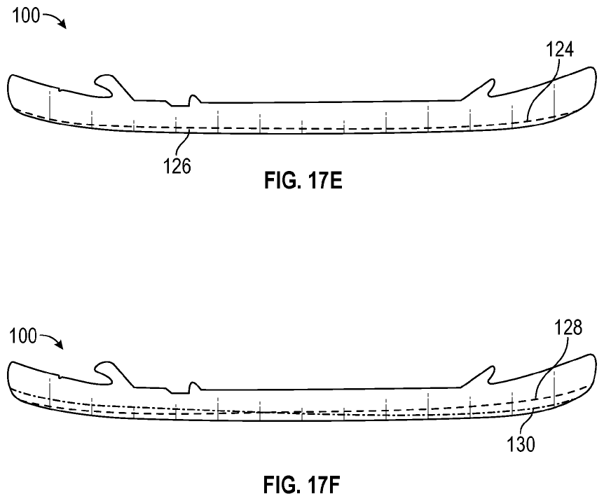

FIG. 17A-17D illustrate skate blades 100G, 100H, 100I, and 100J respectively, to describe the various profiles that can be applied to a skate blade 100. For example, FIG. 17A illustrates the skate blade 100G with a single radius profile 1, FIG. 17B illustrates the skate blade 100H with three radius profiles 1, 2, 3, FIG. 17C illustrates the skate blade 17C with two radius profiles 1, 2, and FIG. 17D illustrates the skate blade 17D with four radius profiles 1, 2, 3, 4. These profiles and an infinite number or combinations of profiles may be available and may be applied to the skate blade 100 using a profiling machine. The profile is distinct from the shape of the hollow 114 ground into the skate blade during routine sharpening. Profiling may provide the advantage of ensuring that a pair of blades 100 have the identical or very similar profile on both the left and right skate blade. Having the same profile for a pair of skates ensures that the athlete feels the same blade interaction with the ice (e.g., grip) on both the left and right foot, which many high-level athletes require and/or desire when skating.

Generally, a profiling system uses similar mechanisms to those found in skate sharpening device. For example, the mechanism may include: an abrasive wheel and/or grinding wheel 150. In order to profile the blade, the abrasive wheel 150 rotates in the plane of the blade 100 and contacts the surface of the blade 100 where blade material is to be removed. The grinding wheel 150 may also translate across the length of the blade 100, either by automated or manual means. It is understood that a manually (by hand) operated profiling machine may only be used with the template style system. In a manual system, the human operator pushes the skate across the grinding wheel with the limit of material removal controlled by a template which has the desired blade shape. For example, FIG. 17E illustrates an embodiment of the skate blade 100, where there dotted line 124 indicates the desired profile of the blade. As shown, the desired profile 124 requires removing some of the blade material 126 from the original profile, such as by, for example, grinding the metal with the grinding wheel 150 of a profiling system.

In some embodiments, the profiling machine described herein may be configured to profile more than one blade at a time. For example, the profiling machine may be configured to profile one blade, two blades, three blades, four blades, five blades, and/or the like at the same time. Profiling more than one blade may be performed by stacking two or more blades together and performing the profiling steps disclosed herein on the multiple blades simultaneously.

b. Computer Controlled Profiling System

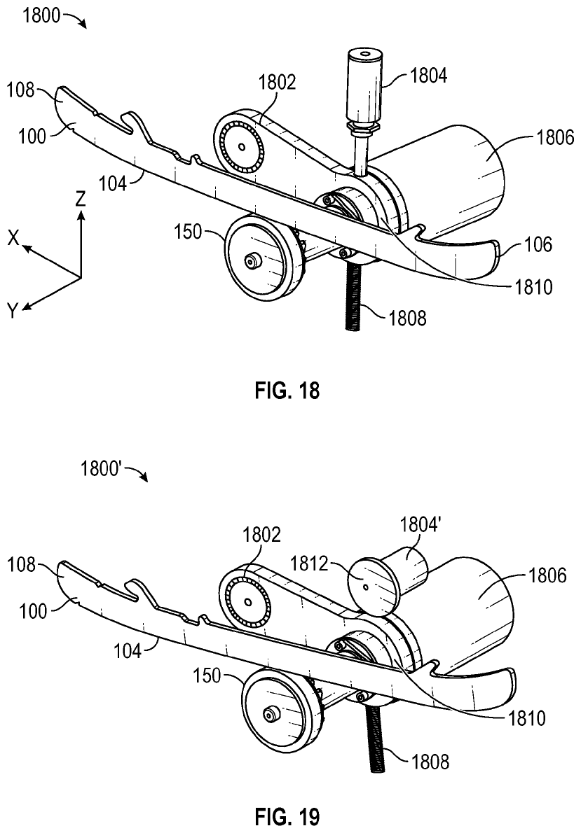

FIG. 18 illustrates an embodiment of the profiling component 1800 of a computer-controlled profiling system/machine. FIG. 18 illustrates an embodiment of the skate blade 100 in contact with the profiling component. The profile component may comprise an encoder 1802, an actuator 1804, the grinding wheel 150, a motor 1806, and a motor arm spring 1808, as well as many other components not illustrated. The encoder 1802 may be attached to a motor arm 1810 to allow the machine's control system to identify the precise position of the grinding wheel 150 at all times. In some embodiments, the machine may include a second encoder (not illustrated). For example, the first encoder 1802 may be used in conjunction with a second encoder (not shown) on the linear translation system (which moves the grinding wheel 150 along the x-axis/along the length of the blade 100, from heel 108 to toe 106) such that the control system can identity the height and/or position of the grinding wheel 150. The encoder(s) 1802 can determine the position of the grinding wheel 150 with a high degree of accuracy, such as, for example, within a threshold of a skate profiles acceptable specification. If the grinding wheel 150 has a known diameter, the shape of a skate blade 100 in the system may also be determined and altered to match any shape desired. The system can alter the profile of the skate blade 100 by controlling the speed and feed of the grinding wheel 150 across the skate blade 100 to remove blade material in certain areas of the skate blade 100 while limiting material removal in other areas.

In one embodiment, the spring 1808 applies upward force on the motor arm 1810 such that the grinding wheel 150 contacts the bottom 104 of a skate blade with a controlled amount of force. In performing a profiling operation, the system may first conduct a measurement step, such as, for example, mapping the existing blade shape. Mapping the blade shape may refer to a process whereby the profiling system 1800 can determine the physical dimensions of the existing blade 100. In some embodiments, during the mapping process, the system can determine whether the existing blade has enough material to be ground into the desired profile. The process may include using the encoder 1802 data for grinding wheel 150 location to record the shape of the blades 100 surface in two dimensions (i.e., height and length). This process allows the profiling system 1800 to compare the physical dimensions of the existing blade 100 to the desired shape that the profiler can create on the blade 100. The first step may be completed without operating the grinding motor 1806, such that the grinding wheel 150 is translated along the bottom 104 of the skate blade 100. In some embodiments, the measurement step may be completed from heel 108 to toe 106, while in other embodiments, the measurement step may be completed from toe 106 to heel 108. In some systems, both measurement directions may be used. While it may be advantageous to perform the measurement step without operating the grinding motor 1806, in some embodiments, measurement may be completed while the grinding motor 1806 is in operation. While performing the measurement operation, the encoder 1802 may record and store data of this movement, such as by, for example, measuring the translation of the mechanical feature carrying the motor arm 1810, the rotation of the motor arm 1810 itself, and/or the like, such that the existing profile of the skate blade 100 can be determined. The profiling machine may include a data storage component, to store pre-programmed blade shapes and profiles, such as, for example, the profiles or similar to profiles discussed with reference to FIGS. 17A-17D. In some instances, the profiling machine may receive the blade shape options from a computing device, such as, for example, a personal computer, laptop computer, desktop computer, smart phone, tablet, smart watch, and/or the like via wired or wireless data transmission.

In some embodiments, the externally sourced profiles may be stored locally on the profiling machine after transmission. In other embodiments, the profile may also be uniquely defined by the computing device after analyzing the inputs to the computing device from the profiling machine itself and/or a user. Following the measurement step, a desired blade shape may then be imparted to the skate blade 100 by operating the grinding motor 1806, translating the grinding wheel 150 back and forth, and using an actuator 1804 to limit the travel of the motor arm 1810 such that only the necessary location and amount of material is removed across the bottom surface 104 of the blade 100 to create the desired profile. In some embodiments, the actuator 1804 may be an electromagnetic, linear, rotary, hydraulic, pneumatic, electric, thermal, magnetic, mechanical, and/or the like actuator.

The profiling system 1800 can be configured to generate and use virtual template to apply to the skate blades 100. Rather than using a physical template, the profiling system 1800 can utilize data for template shapes in order to create and apply a virtual template to the skate blade 100. The virtual template can be a dimensional mapping of the desired profile for the skate blade 100. The profiling system 1800 can compare the virtual template to a mapping of the existing blade 100 in order to determine the material to remove from the blade 100 in order to match the profile of the virtual template. The dimensional mapping of the virtual template can be implemented using the actuators 1804 and encoders 1802 of the profiling system 1800. Such a system may provide a benefit over template-based profiling systems of not requiring a physical template. Rather, the profiling system 1800 can mimic the template by, for example, controlling the vertical stop of the motor arm 1810 of the profiling system 1800. This is a significant improvement over physical template-based systems because a virtual template is effectively created and is therefore infinitely adjustable and configurable for each skate blade 100.

The system 1800 can be configured to record operational data gathered during profiling operations. For example, the system can record the output from the encoders 1802, the motor 1806 (e.g., rpm, current, etc.), sensors not illustrated (e.g., thermal, IR camera, etc.), and other operational parameters before, during and after a profiling operation. The system can analyze the data using one or more operational algorithms or models to determine optimizations associated with the various components and the profiling operations. For example, the system 1800 can determine whether the grinding wheel 150 is capable of removing material at a faster rate based on an analysis of the operational characteristics. In one example, the system 1800 can monitor the temperature of the skate blade 100 during grinding, based on the analysis, the system could determine whether to modify operational parameters of the system 1800 (e.g., grinding wheel speed, etc.) in order to speed up the profiling process. By allowing the system to make these optimizations, the system 1800 becomes faster and more powerful and more valuable.

In some embodiments, the operational characteristics can be recorded and provided to a remote computing system. The remote computing system can be configured to receive operational characteristics from a plurality of profiling systems 1800. The operational data can be aggregated and analyzed by the remote computing system in order to update the operational algorithms/models used by the profiling systems 1800. The remote computing system may execute machine learning processes to analyze the data in order to retrain and or update one or more operational models or algorithms. Such updates can help to optimize material removal quality, accuracy, precision, and speed. In some embodiments, the operational models may be specific to types of profiling operations, grinding wheels 150, and/or other aspects of the profiling process. In some embodiments, the profiling systems 1800 can receive updates that are stored and executed locally on the profiling system 1800, such that the profiling system 1800 is not required to be in communication with remote computing system during a profiling operation. In some embodiments, the remote computing system may control operation of profiling system 1800 in real-time. In some embodiments, a user computing device may be configured to receive updates for the profiling system 1800 and provide the updates directly to the profiling system 1800. For example, the user's smart phone may have an installed application that is configured to provide an interface to select and download a virtual template, which may include an associated operational profile that provides better optimized operational algorithms/models associated the virtual template. The user's smart phone can then be used to transfer the template and/or operational profile directly or indirectly to the profiling system 1800. A direct transfer could be performed using various communication interfaces such as NFC (near field communication), USB, or other type of electronic communication interface. An indirect transfer may be performed by requesting that the remote computing system communicate with and provide the requested information for use on one or more selected profiling systems 1800.

FIG. 19 illustrates an embodiment of a profiling component 1800′ of a computer-controlled profiling system/machine. The profiling component 1800′ may include all the same components of the profiling component 1800, with the exception that the profiling component 1800′ includes a rotary actuator 1804′ fitted with an eccentric cam 1812. The rotational position of actuator 1804′ can then be coordinated by the control system to achieve the desired profile. Some advantages of a rotary actuator over for example, a linear actuator, may be that it is easier to seal a rotary actuator in the dusty environment created by a grinding operation. Additionally, rotary actuators, such as, for example gear motors, are more readily available and often sold at a lower cost. It is understood that the actuator 1804′ could be any number of devices for which the sharpener system could control the position of the vertical height stop, such as, for example, how far the motor arm 1810 could rotate counterclockwise around a pivot point for the motor arm 1810. In some embodiments, the motor arm 1810 may be configured different and/or rotate clockwise around the motor arm pivot.

In some embodiments, the computer-controlled profiling system 1800/1800′ may not require the vertical force spring 1808 which pushes the motor arm 1810 up and into contact with the skate blade 100, and instead may use an actuator and a force sensor on the motor arm 1810 such that contact between the grinding wheel 150 and the skate blade can be prescribed and measured. In this case, the actuator or actuators may generally be required to move the motor arm 1810 in both directions and not rely on the spring 1808 for upward bias to the grinding wheel 150 position. The force of contact between the grinding wheel 150 and blade 100 can then be controlled during the profiling process to control the overall time needed to impart the desired shape to the blade 100. In general, driving the motor arm 1810 with an actuator 1804/1804′ should shorten the time required for profiling because, for example, the system may be able to carefully apply more pressure to specific regions of the skate blade 100 and thus, more material can be removed in a shorter period of time. In another embodiment, a torque actuator and sensor may be employed on the motor arm 1810 at the pivot instead of a force sensor.

In another embodiment, the motor 1806 may be mounted on a stage and the motor 1806 may be driven by a linear actuator (e.g., similar to the actuator 1804) on the stage towards the skate blade 100. In this case, no arm 1810 may be required. Instead, the motor 1806 and/or grinding ring 150 may be vertically translated on the stage similar to a CNC machine with no motor arm. Depending on the force of contact between the grinding ring 150 and the skate blade 100, this embodiment make take more or less time than the spring system.

It should be appreciated that for any of the computer-controlled systems described herein, the capability of creating different profiles may be limitless. Profiles may consist of any number of shapes, such as, for example, flat, radiused, multiple-radius, continuously changing radii, ellipse-shaped composite shapes of any number of flat and radiused sub-sections, and/or the like.

Because the shape of a blade 100 can be measured in the system, primarily to know where to remove material in order to change the shape of the blade 100 to the shape of a desired profile, in some embodiments, the system may also enable the replication of the profile of the blade 100 which has been profiled manually or by a different system. In this case, the skate blade 100 may be placed in the system and the existing profile may be measured. The system may then store the measured profile and the profile may be used to impart an identical profile on a different blade. In some embodiments, the specific profile data may be transferable to another system to create the copied profile on any number of skate blades. The system may also, as part of this profile replication process, scan the blade where the user would like the profile replicated and confirm that the profile can be replicated on the desired blade. If the system determines, for any number of reasons, such as, for example, wrong size blade, insufficient amount of blade material remaining, and/or the like, that the profile cannot be replicated on the desired blade, the system can alert the user and await instructions on how to proceed.

For any profile shape loaded or included in the system, the user may have the capability to tilt the profile either forward or backward to create an angle in the skate profile relative to the skate and skater. Tilting the profile may affect the body's lean, either forward or backward, of the skater on the skate blade. The system must then be able to transform the desired profile by some angle chosen by the user and shift the profile on the blade to ensure that material is removed from the necessary areas of the existing blade, ensuring the accuracy of the desired profile. For example, FIG. 17F illustrates an embodiment of the skate blade 100 that includes example profile lines 128 and 130 that illustrate how a profiler may impart a tilted profile on the blade. The profile lines 128, 130 shown in FIG. 17F are phantom lines that are not actually shown on a skate blade in operation. The lines are intended to illustrate the areas where the profiling machine would remove material from the skate blade in order to change the profile of the skate blade.

An important consideration for any of the systems described herein may be that the blade 100 is positioned in a known and repeatable way in the sharpener. This may be an important consideration because often, any tilting, even minor tilting, of the blade 100 in the profiling system would affect the profiling operation. As such, it may be advantageous to utilize a fixturing method to precisely and repeatably locate the skate blade 100 in the profiling machine. In some embodiments, a precise position may be accomplished by using a fixture in which the blade 100 or blades 100 are loaded in a manner that indexes the blades 100 from the top 102 of the blade shape, such as, for example, through locating dowel pins (not shown), and then these dowel pins have a known position relative to the profiling system itself. It should be appreciated that any mechanical feature that provides interference with features on a skate blade, besides or in addition to dowel pins, could be used to position the skate blade 100 in a fixture which would then be positioned relative to the profiling system itself. The blade fixture may utilize mechanical mating features between the fixture and the profiler to ensure repeatable alignment of the fixture in the profiling machine. Another method would be to secure the skate blade 100 in the profiling system by referencing a feature or features on the skate blade holder of the skate itself. These features may be the lower edge of the blade holder body and the lengthwise centerline of the skate blade or other features which could be consistent from one blade to the next in how the blade is inserted in the profiling machine. In any scenario, it can be appreciated that the profiling system would need to know how the blades 100 are positioned in the profiling machine to provide an accurate profiling operation. The profiling machine may require the user to input the manner in which the blades 100 are secured in the profiling system or the profiling system could use other technologies such as, for example, a mechanical switch tripped by the fixture, a fixture-mounted RFID, a computer-readable images (such as a bar code and/or the like) on a blade fixture, and/or the like to determine if the blade(s) 100 are loaded in the profiling machine in a specific blade fixturing device.

In some embodiments, the profiling systems can be configured to interface with alignment features of the skate blades 100. For example, the skate blades may be manufactured to include fabricated features, such as, for example, semi-circular bumps, circular bumps, square bumps, cut-outs, and/or the like along, for example, a top 102 edge of the skate blade 100. These fabricated features may be configured to mate with similarly shaped features in a fixture or component of the blade clamp/jaws of the profiling system. In some embodiments, the fabricated features may be consistent across all blade sizes, which would ensure that every blade (of the same size) that is profiled in the system is placed in the same location within the jaws of the profiling system. such as in the same position in the y-direction and the same pitch of the blade (rotation along the y-axis).

By including corresponding alignment features on the profiling system and the skate blades 100, the profiling system can replicate the exact same profile on a second blade because the first and second blade can be positioned in the profiling system jaws in the exact same position. When skate blades 100 lack alignment features, a user or operator of the system may be required to manually align the blades 100 in the profiling system, which may not result in the same alignment for each blade 100. The alignment features may be used to apply a profile to be consistently applied across skate blades of different sizes and brands.

In other embodiments, alignment features may be added to the skate blade holder of a skate. For example, the skate blade holder may be manufactured to include one or more protrusions/extrusions that may be configured to key into mating features on the profiling system. In another example, the protrusions/extrusions may be configured to kay into a fixture that is mated with sharpener and/or a reference plan datum that the blade holder includes which may sit on a mating surface of the profiling system or a fixture that goes into the profiling system. These features would ensure a consistent placement of the blade or blade and skate in the profiling system.

### F. Computer Systems

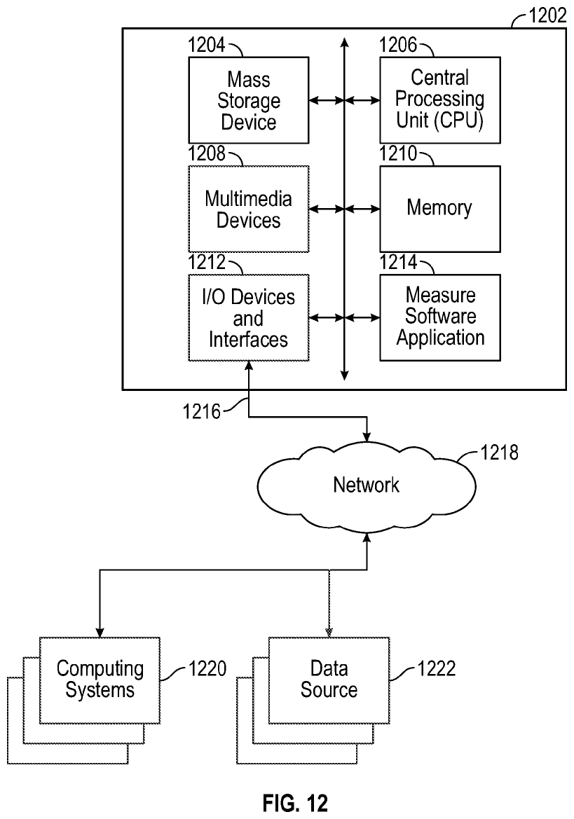

FIG. 12 is a block diagram depicting an embodiment of a computer hardware system configured to run software for implementing one or more embodiments disclosed herein.

In some embodiments, the systems, processes, and methods described herein are implemented using a computing system, such as the one illustrated in FIG. 12. The example computer system 1202 is in communication with one or more computing systems 1220 and/or one or more data sources 1222 via one or more networks 1218. While FIG. 12 illustrates an embodiment of a computing system 1202, it is recognized that the functionality provided for in the components and modules of computer system 1202 may be combined into fewer components and modules, or further separated into additional components and modules.

The computer system 1202 can comprise a programming module 1214 that carries out the functions, methods, acts, and/or processes described herein. The programming module 1214 is executed on the computer system 1202 by a central processing unit 1206 discussed further below.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 1202 includes one or more processing units (CPU) 1206, which may comprise a microprocessor. The computer system 1202 further includes a physical memory 1210, such as random-access memory (RAM) for temporary storage of information, a read only memory (ROM) for permanent storage of information, and a mass storage device 1204, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 1202 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 1202 includes one or more input/output (I/O) devices and interfaces 1212, such as a keyboard, mouse, touch pad, and printer. The I/O devices and interfaces 1212 can include one or more display devices, such as a monitor, which allows the visual presentation of data to a user. More particularly, a display device provides for the presentation of GUIs as application software data, and multi-media presentations, for example. The I/O devices and interfaces 1212 can also provide a communications interface to various external devices. The computer system 1202 may comprise one or more multi-media devices 1208, such as speakers, video cards, graphics accelerators, and microphones, for example.

The computer system 1202 may run on a variety of computing devices, such as a server, a Windows server, a Structure Query Language server, a Unix Server, a personal computer, a laptop computer, a smart phone, a personal digital assistant, a tablet, and so forth. Servers may include a variety of servers such as database servers (for example, Oracle, DB2, Informix, Microsoft SQL Server, MySQL, or Ingres), application servers, data loader servers, or web servers. In addition, the servers may run a variety of software for data visualization, distributed file systems, distributed processing, web portals, enterprise workflow, form management, and so forth. In other embodiments, the computer system 1202 may run on a cluster computer system, a mainframe computer system and/or other computing system suitable for controlling and/or communicating with large databases, performing high volume transaction processing, and generating reports from large databases. The computing system 1202 is generally controlled and coordinated by an operating system software, such as Windows XP, Windows Vista, Windows 7, Windows 8, Windows 10, Windows 11, Windows Server, Unix, Linux (and its variants such as Debian, Linux Mint, Fedora, and Red Hat), SunOS, Solaris, Blackberry OS, z/OS, iOS, macOS, or other operating systems, including proprietary operating systems. Operating systems control and schedule computer processes for execution, perform memory management, provide file system, networking, and I/O services, and provide a user interface, such as a graphical user interface (GUI), among other things.

The computer system 1202 illustrated in FIG. 12 is coupled to a network 1218, such as a LAN, WAN, or the Internet via a communication link 1216 (wired, wireless, or a combination thereof). Network 1218 communicates with various computing devices and/or other electronic devices. Network 1218 is communicating with one or more computing systems 1220 and one or more data sources 1222. The programming module 1214 may access or may be accessed by computing systems 1220 and/or data sources 1222 through a web-enabled user access point. Connections may be a direct physical connection, a virtual connection, and other connection type. The web-enabled user access point may comprise a browser module that uses text, graphics, audio, video, and other media to present data and to allow interaction with data via the network 1218.

Access to the programming module 1214 of the computer system 1202 by computing systems 1220 and/or by data sources 1222 may be through a web-enabled user access point such as the computing systems' 1220 or data source's 1222 personal computer, cellular phone, smartphone, laptop, tablet computer, e-reader device, audio player, or another device capable of connecting to the network 1218. Such a device may have a browser module that is implemented as a module that uses text, graphics, audio, video, and other media to present data and to allow interaction with data via the network 1218.

The output module may be implemented as a combination of an all-points addressable display such as a cathode ray tube (CRT), a liquid crystal display (LCD), a plasma display, or other types and/or combinations of displays. The output module may be implemented to communicate with input devices 1212 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the system 1202 may comprise a physical or logical connection established between a remote microprocessor and a mainframe host computer for the express purpose of uploading, downloading, or viewing interactive data and databases on-line in real time. The remote microprocessor may be operated by an entity operating the computer system 1202, including the client server systems or the main server system, an/or may be operated by one or more of the data sources 1222 and/or one or more of the computing systems 1220. In some embodiments, terminal emulation software may be used on the microprocessor for participating in the micro-mainframe link.

In some embodiments, computing systems 1220 who are internal to an entity operating the computer system 1202 may access the programming module 1214 internally as an application or process run by the CPU 1206.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL ca specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, or the like. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 1202 may include one or more internal and/or external data sources (for example, data sources 1222). In some embodiments, one or more of the data repositories and the data sources described above may be implemented using a relational database, such as Sybase, Oracle, CodeBase, DB2, PostgreSQL, and Microsoft® SQL Server as well as other types of databases such as, for example, a NoSQL database (for example, Couchbase, Cassandra, or MongoDB), a flat file database, an entity-relationship database, an object-oriented database (for example, InterSystems Caché), a cloud-based database (for example, Amazon RDS, Azure SQL, Microsoft Cosmos DB, Azure Database for MySQL, Azure Database for MariaDB, Azure Cache for Redis, Azure Managed Instance for Apache Cassandra, Google Bare Metal Solution for Oracle on Google Cloud, Google Cloud SQL, Google Cloud Spanner, Google Cloud Big Table, Google Firestore, Google Firebase Realtime Database, Google Memorystore, Google MogoDB Atlas, Amazon Aurora, Amazon DynamoDB, Amazon Redshift, Amazon ElastiCache, Amazon MemoryDB for Redis, Amazon DocumentDB, Amazon Keyspaces, Amazon EKS, Amazon Neptune, Amazon Timestream, or Amazon QLDB), a non-relational database, or a record-based database.

The computer system 1202 may also access one or more databases 1222. The databases 1222 may be stored in a database or data repository. The computer system 1202 may access the one or more databases 1222 through a network 1218 or may directly access the database or data repository through I/O devices and interfaces 1212. The data repository storing the one or more databases 1222 may reside within the computer system 1202.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include these features, elements and/or states.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

While the above detailed description may have shown, described, and pointed out novel features as applied to various embodiments, it may be understood that various omissions, substitutions, and/or changes in the form and details of any particular embodiment may be made without departing from the spirit of the disclosure. As may be recognized, certain embodiments may be embodied within a form that does not provide all of the features and benefits set forth herein, as some features may be used or practiced separately from others.

Additionally, features described in connection with one embodiment can be incorporated into another of the disclosed embodiments, even if not expressly discussed herein, and embodiments having the combination of features still fall within the scope of the disclosure. For example, features described above in connection with one embodiment can be used with a different embodiment described herein and the combination still fall within the scope of the disclosure.

It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this disclosure may comprise, additional to its essential features described herein, one or more features as described herein from each other embodiment disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added.

Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

Reference to any prior art in this description is not, and should not be taken as, an acknowledgement or any form of suggestion that that prior art forms part of the common general knowledge in the field of endeavor in any country in the world.

The invention may also be said broadly to consist in the parts, elements and features referred to or indicated in the description of the application, individually or collectively, in any or all combinations of two or more of said parts, elements or features.

Where, in the foregoing description, reference has been made to integers or components having known equivalents thereof, those integers are herein incorporated as if individually set forth. In addition, where the term “substantially” or any of its variants have been used as a word of approximation adjacent to a numerical value or range, it is intended to provide sufficient flexibility in the adjacent numerical value or range that encompasses standard manufacturing tolerances and/or rounding to the next significant figure, whichever is greater.

It should be noted that various changes and modifications to the presently preferred embodiments described herein will be apparent to those skilled in the art. Such changes and modifications may be made without departing from the spirit and scope of the invention and without diminishing its attendant advantages. For instance, various components may be repositioned as desired. It is therefore intended that such changes and modifications be included within the scope of the invention. Moreover, not all of the features, aspects and advantages are necessarily required to practice the present invention. The following lists have example embodiments that are within the scope of this disclosure. The example embodiments that are listed should in no way be interpreted as limiting the scope of the embodiments. Various features of the example embodiments that are listed can be removed, added, or combined to form additional embodiments, which are part of this disclosure:

### First Set of Example Embodiments

Various example embodiments of the disclosure can be described by the following clauses:

Clause 1. An ice skate blade measurement device comprising:
a frame configured to couple to an ice skate blade;
a measurement system configured to obtain measurement data associated with the ice skate blade; and
a control system with computer-executable instructions configured to, when executed:
   determine, one or more measurements associated with geometry of the ice skate blade, and
   generate, an output based at least in part on the one or more measurements.

Clause 2. The measurement device of clause 1, wherein the geometry comprises edges of the ice skate blade.

Clause 3. The measurement device of any preceding clause, wherein the output is displayed on a screen of the measurement device.

Clause 4. The measurement device of any preceding clause, wherein the output comprises a visual indication on the measurement device.

Clause 5. The measurement device of any preceding clause, wherein the output is transmitted to and displayed on a remote computing device.

Clause 6. The measurement device of any preceding clause, wherein the output is transmitted to and displayed on a remote skate sharpening device.

Clause 7. The measurement device of any preceding clause, wherein the computer-executable instructions are further configured to, when executed:
transmit, instructions for adjusting a skate sharpening device, the instructions determined based on the one or more measurements.

Clause 8. The measurement device of clause 7, wherein the instructions include modifications to a position of a grinding wheel of the skate sharpening device.

Clause 9. The measurement device of clause 8, wherein the position of the grinding wheel is determined based on a desired edge modification to the edges of the ice skate blade.

Clause 10. The measurement device of clause 9, wherein the edge modification comprises sharpening the edges of the ice skate blade such that the edges have an equal height.

Clause 11. The measurement device of any preceding clause, wherein the frame further comprises a blade slot, the blade slot configured to receive the ice skate blade.

Clause 12. The measurement device of clause 11, further comprising a securing mechanism, the securing mechanism configured to secure the ice skate blade within the blade slot.

Clause 13. The measurement device of clause 12, wherein the securing mechanism comprises a fastener, the fastener configured to extend through a portion of the frame and into the blade slot, an end portion of the fastener configured to contact a side of the ice skate blade.

Clause 14. The measurement device of clauses 11-13, wherein the measurement system further comprises a tilt bar, the tilt bar comprising a top portion and a bottom portion.

Clause 15. The measurement device of clause 14, wherein the top portion of the tilt bar further comprise a reflective surface.

Clause 16. The measurement device of clauses 14 or 15, wherein the bottom portion of the tilt bar extends into the blade slot in a first configuration.

Clause 17. The measurement device of clause 16, wherein tilt bar is configured to move into a second configuration when the ice skate blade is secured within the blade slot.

Clause 18. The measurement device of clause 17, wherein the tilt bar is supported by the edges of the skate blade via the bottom portion when the tilt bar is in the second configuration.

Clause 19. The measurement device of clauses 14-18, wherein the tilt bar further comprises a magnet.

Clause 20. The measurement device of clause 19, wherein the tilt bar is magnetically coupled to the ice skate blade in the second configuration.

Clause 21. The measurement device of clause 19 or 20, further comprising one or more ferrous pins, wherein the tilt bar is configured to magnetically couple to the one or more ferrous pins in the first configuration.

Clause 22. The measurement device of clause 21, wherein the one or more ferrous pins comprise a first pin and a split pin, the split pin comprising a second pin and a third pin.

Clause 23. The measurement device of clause 21 or 22, wherein the one or more ferrous pins are coupled to the frame near the blade slot.

Clause 24. The measurement device of clause 23, wherein the securing mechanism is configured to extend through a gap between the second pin and the third pin.

Clause 25. The measurement device of any preceding clause, wherein the measurement system further comprises a light emitting source and a sensor.

Clause 26. The measurement device of clause 25, wherein the light emitting source comprises a laser.

Clause 27. The measurement device of clause 26, wherein the laser is configured to direct a laser beam towards the reflective surface of the tilt bar.

Clause 28. The measurement device of clause 27, wherein sensor is configured to receive a reflected laser beam from the tilt bar.

Clause 29. The measurement device of clause 28, wherein the one or more measurements associated with edges of the ice skate blade are determined based on a location of the reflected laser beam on the sensor.

Clause 30. The measurement device of clause 29, wherein the measurement system further comprises one or more of a filter and a lens, wherein the filter is configured to filter at least the laser beam and the lens is configured to receive the reflected laser beam.

Clause 31. The measurement device of clause 30, wherein the one or more measurements comprise an angle of the tilt bar, the angle of the tilt bar determined by a relative height between an inside edge and an outside edge of the skate blade.

Clause 32. The measurement device of any preceding clause, wherein the one or more measurements comprise a relative height between an inside edge and an outside edge of the skate blade.

Clause 33. The measurement device of any preceding clause, further comprising an external housing, the frame positioned at least partially within the external housing.

Clause 34. The measurement device of clause 33, wherein the external housing comprises a plurality of resilient members extending into the frame, wherein the resilient members are configured to allow the frame to move relatively to the external housing.

Clause 35. The measurement device of any preceding clause, wherein the frame further comprises a laser aperture, the laser aperture configured to limit a size of the laser beam.

Clause 36. The measurement device of clause 25, wherein the light emitting source comprises a line laser, the line laser configured generate a line laser beam directed towards the edges of the skate blade, wherein the sensor is configured to receive a reflected line laser beam from the skate blade.

Clause 37. The measurement device of clause 36, wherein the one or more measurements comprises depth information related to the skate blade.

Clause 38. A method of measuring ice skate blade edges, the method comprising:
coupling, an ice skate blade to a measurement device;
determining, one or more measurements associated with edges of the ice skate blade; and
generating, an output including the one or more measurements.

### Second Set of Example Embodiments

Various example embodiments of the disclosure can be described by the following clause:

Clause 1. A method comprising:
obtaining one or more images of a skate blade, wherein the skate blade includes one or more removable devices;
analyzing the one or more images of the skate blade based at least in part on the one or more removable devices;
determining one or more sharpener modifications for a skate blade sharpener based at least in part on the analysis; and
outputting the one or more sharpener modifications.

Clause 2. The method of clause 1, further comprising:
generating instructions for displaying the one or more sharpener modifications on a user computing device;
manually applying the one or more sharpener modifications to the skate blade sharpener.

Clause 3. The method of clause 1, further comprising:
generating instructions for displaying the one or more sharpener modifications on a user computing device;
receiving user input selecting the one or more sharpener modifications; and
transmitting instructions corresponding to the selected one or more sharpener modifications to the skate sharpener device.

Clause 4. The method of clause 1, wherein analyzing the one or more images is completed on the user computing device or a computing device in communication with the user computing device.

Clause 5. The method of clause 1, further comprising:
loading the skate blade into the skate sharpening device to perform an operation.

Clause 6. The method of clause 1, wherein the operation includes sharpening the skate blade.

Clause 7. A skate sharpening system comprising:
a skate blade positioned within the skate sharpening system;
a skate sharpening device; and
a removable device.

Clause 8. The system of clause 7, wherein the one or more removable devices comprises an edge checker.

Clause 9. The system of clause 8, wherein a user computing device is configured to interpret a visible feature on the edge checker and generate an authenticity indication.

Clause 10. The system of clause 7, wherein the skate blade is coupled to a skate and the skate includes one or more computer-readable images that, when scanned by a user computing device provide information about the skate.

Clause 11. The system of clause 7, wherein the skate blade includes one or more computer-readable images that, when scanned by a user computing device provide information about the skate blade.

Clause 12. The system of clause 7, wherein the removable device provides a visual representation of one or more geometric characteristics of the skate blade.

Clause 13. The system of clause 7, further comprising a user computing device for running a software application, wherein the user computing device may interact with the skate blade, removable device, and skate sharpening device to provide unique and valuable information to a user of the skate sharpening device.

Clause 14. The system of clause 7, wherein the user computing device is configured to acquire images of the skate or skate blade, alone or in combination with the removable device, where user computing device is configured to align and calibrate the image to be useful for analysis.

Clause 15. The method of clause 3, further comprising:
generating and transmitting to the user computing device, presentation instructions for overlaying alignment graphics on a live image display on the user computing device, along with real time feedback for the user, in order to accurately align the desired field of view of the skate or skate blade with a camera of the user computing device.

Clause 16. The system of clause 7, wherein a user computing device is configured to communicate with the skate sharpening device via wireless or wired connection.

Clause 17. The system of clause 8, wherein the edge checker comprises a multi-piece device comprising:
a datum reference plate that is configured to attach to a vertical plane of the skate blade; and
an angle plate that is configured to attach to a bottom of the skate blade, wherein the angle of which, relative to the datum reference plate, provides a visual indication of an evenness of edges of the skate blade.

Clause 18. The system of clause 17, wherein at least one of the datum reference plate or the angle plate is configured to attach to the skate blade by one or more magnets.

Clause 19. The system of clause 17, wherein the datum reference plate includes lines that are etched on a surface.

Clause 20. The system of clause 17, wherein the datum reference plate includes graduated lines that are extruded through areas to allow for backlighting.

Clause 21. The system of clause 17, wherein the datum reference plate includes lines that are etched on a surface.

Clause 22. The system of clause 17, wherein the datum reference plate includes graduated lines that vary in horizontal length in sequence to allow a vision application to identify unique line locations.

Clause 23. The system of clause 17, wherein the datum reference plate includes graduated lines that are either barcodes themselves or have a matching barcode (1D or 2D) next it to allow for unique identification of the graduated line location.

Clause 24. The system of clause 17, wherein the datum reference plate includes optical fiducials, wherein the optical fiducials can be extruded through, imprinted, or engraved on the Datum Reference Plate.

Clause 25. The system of clause 17, wherein the datum reference plate includes optical fiducials, wherein the optical fiducials are created by adding material or molding on top of the datum reference plate.

Clause 26. The system of clause 17, wherein the angle plate includes optical fiducials, wherein the optical fiducial can be extruded through, imprinted, or engraved on the Angle Plate.

Clause 27. The system of clause 17, wherein the angle plate includes optical fiducials, wherein the optical fiducials are created by adding material or molding on top of the angle plate.

Clause 28. The system of clause 17, wherein the angle plate comprises a mounted laser to project a laser mark onto the Datum Reference Plate.

Clause 29. The system of clause 28, wherein the laser mark comprises a line or dot.

Clause 30. The system of clause 17, wherein the datum reference plate includes optical magnification optics mounted to the datum reference plate for higher precision image acquisition.

Clause 31. The system of clause 7, wherein the skate sharpening device further comprises a mounting piece for removably mounting a user computing device.

Clause 32. The system of clause 13, wherein the user computing device further comprises a camera, wherein the camera is configured to acquire images of one or more of removable device designs.

Clause 33. The method of clause 1, further comprising acquiring multiple images using a user computing device, wherein the multiple images improve image the precision and/or accuracy of the analysis by providing additional images or by improving image.

Clause 34. The method of clause 1, wherein a user computing device is configured to generate guidance indicators superimposed on a live image for helping the user align the one or more removable devices in the camera field of view.

Clause 35. The method of clause 1, wherein a user computing device is configured to run a software application, wherein the application is configured to analyze images and image fiducials to determine geometric information associated with the skate blade.

Clause 36. The method of clause 1, wherein the sharpener modifications include instructions to instruct the user of one or more modifications or adjustments that need to be made on the skate sharpening device to achieve the desired sharpening results on the blade.

Clause 37. The system of clause 13, wherein the user computing device is configured to analyze images using object detection, edge analysis, blob analysis, filters, and/or segmentation.

Clause 38. The system of clause 13, wherein the user computing device is configured to use LIDAR to acquire image and spatial information.

Clause 39. The system of clause 36, wherein the user computing device is configured to measure one or more different designs of the removable device.

Clause 40. The system of clause 36, where the user computing device is configured to image and analyze the skate blade for direct measurement, bypassing and/or augmenting the information from the user computing device or skate sharpening device.

Clause 41. The system of clause 13, wherein the software application is configured to use image(s) of calibration fiducials to calibrate pixel/mm ratio.

Clause 42. The system of clause 13, wherein the software application is configured to use image(s) of calibration fiducials to account for keystone or non-orthogonal images relative to fiducials, wherein the software application is configured to auto calibrate and correct for any misalignment of the image acquisition.

Clause 43. The system of clause 13, wherein the user computing device is configured to display to a user information calculated from the software application, wherein the information provides the user with instruction for manual adjustment.

Clause 44. The system of clause 13, wherein the user computing device is configured to communicate information calculated from the software application to the sharpening machine for automated adjustment.

Clause 45. The system of clause 44, wherein the software application comprises a machine learning algorithm configured to calculate adjustments for the skate sharpening device.

Clause 46. The system of clause 45, wherein the machine learning algorithm is configured to become more accurate over time through use.

Clause 47. The system of clause 45, wherein after an adjustment is calculated and displayed to the user, the user can make a suggested adjustment and re-sharpen the skate.

Clause 48. The system of clause 47, wherein after the user re-sharpens the skate, the user can use the user computing device again to measure the skate blade and the user computing device is configured to use this information to continually improve the machine learning algorithm.

Clause 49. The system of clause 45, wherein the machine learning algorithm is configured to optimize the system for a specific grinding wheel.

Clause 50. The system of clause 13, wherein the software application is configured to track historical data, wherein the historical data comprises measurement results, skater information, skate information, blade information, sharpening information, skating performance information (real time and entered), vital body statistics during skating, and game time statistics.

Clause 51. The system of clause 7 wherein the skate blade is coupled to a skate.

Clause 52. The system of clause 50 wherein the software application can analyze the historical data and provide feedback to the user to optimize skating performance.

Clause 53. The system of clause 8, wherein the edge checker comprises a multi-piece device comprising:
a datum reference plate that is configured to attach to a vertical plane of the skate blade which registers it as the zero datum; and
an angle plate that is configured to attach to a face of the skate blade, wherein the angle of which, relative to the datum reference plate, provides a visual indication of the squareness that the datum reference plate relative to the skate blade.

Clause 54. The system of clause 53, wherein the angle plate is configured to attach to the face of the skate blade by one or more magnets.

Clause 55. A method comprising:
obtaining one or more images of a skate blade, wherein the skate blade includes one or more removable devices;
analyzing the one or more images to measure a flatness of the skate blade based at least in part on the one or more removable devices;
determining whether the one or more removable devices are square to the skate blade;
generating one or more recommended modifications based at least in part on the determination; and
outputting the one or more recommended modifications.

Clause 56. The method of clause 55, wherein the recommended modifications include at least one of: recommending the user reattach the one or more removable devices or recommending a misalignment calculation.

Clause 57. The method of clause 56, wherein the misalignment calculation comprises determining how far off the one or more devices are from square and calculating an adjustment for the skate sharpener device.

Clause 58. The method of clause 55, wherein the method is performed by a user computing device.

Clause 59. The method of clause 55, further comprising generating instructions for displaying the one or more recommended modifications on a user computing device.

### Third Set of Example Embodiments

Various example embodiments of the disclosure can be described by the following clause:

Clause 1. A computer-controlled skate blade profile system comprising:
a carriage;
a motor connected to the carriage;
a grinding wheel mounted to the motor;
one or more encoders, wherein the one or more encoders are coupled to the carriage;
at least one actuator configured to control position of the motor;
at least one actuator configured to control position of the carriage;
a data storage component; and
a computer control system configured to:
   map a blade shape of a skate blade, and
   perform a profile operation, wherein the profile operation comprises translating the grinding wheel along the bottom of the skate blade to selectively remove material from the skate blade to match a defined blade shape.

Clause 2. The system of Clause 1, wherein the motor is connected to a motor arm on the carriage.

Clause 3. The system of Clause 1, wherein the motor is connected to a stage.

Clause 4. The system of Clause 1, wherein the data storage component is configured to store blade profiles and blade shapes.

Clause 5. The system of Clause 1, wherein the one or more encoders are configured to communicate with and transmit data to the control system to identify a position of the grinding wheel.

Clause 6. The system of Clause 1, wherein one encoder is configured to determine a vertical displacement of the grinding wheel and another encoder is configured to determine a horizontal position of the grinding wheel, wherein vertical displacement is a distance of the skate blade from a skate blade holder to ice and horizontal position is a location on the skate blade between a heel and toe of the skate blade.

Clause 7. The system of Clause 1, wherein the actuator is an electromagnetic actuator.

Clause 8. The system of Clause 1, wherein the actuator is a rotary actuator and includes a fitted eccentric cam.

Clause 9. The system of Clause 1, wherein the computer control system is configured to control a rotational position of the actuator during a profiling operation.

Clause 10. The system of Clause 1, wherein the system is configured to perform a profile operation, wherein a profile operation comprises grinding the skate blade with the grinding wheel.

Clause 11. The system of Clause 1 further comprising a fixture component.

Clause 12. The system of Clause 11 further comprising one or more locating features, wherein the fixture component is configured to use the locating feature to index the skate blade to the computer-controlled skate blade profiling system.

Clause 13. The system of Clause 12, wherein the one or more locating features comprise dowel pins.

Clause 14. The system of Clause 12, wherein the one or more locating features comprise half round extrusions.

Clause 15. The system of Clause 12, wherein the one or more locating features comprise cut outs.

Clause 16. The system of Clause 1 further comprising a motor spring arm and wherein a spring is configured to apply a force on the motor spring arm such that the grinding wheel contacts a bottom of a skate blade.

Clause 17. A method of profiling a skate blade, the method comprising:
mapping a blade shape of a skate blade, wherein mapping comprises translating a grinding wheel along a bottom of the skate blade;
selecting a blade shape; and
performing a profile operation, wherein the profile operation comprises translating the grinding wheel along the bottom of the skate blade to selectively remove material from the skate blade.

Clause 18. The method of clause 17, wherein an encoder records the blade shape of the skate blade during the mapping and a data storage component is configured to store the blade shape.

Clause 19. The method of clause 17, wherein a data storage component is configured to store blade profiles and blade shapes.

Clause 20. The method of clause 17, wherein an encoder is configured to transmit data to a control system to identify a position of the grinding wheel.

Clause 21. The method of clause 17, wherein a first encoder is configured to provide height data for the grinding wheel and a second encoder is configured to provide linear position data for of the grinding wheel.

Clause 22. A computer-controlled skate blade profile system comprising:
a carriage;
a stage configured to carry a motor and travel in a linear direction;
a grinding wheel mounted to the motor; one or more encoders, wherein the one or more encoders are coupled to the carriage and sled;
at least one actuator configured to control position of the sled;
at least one actuator configured to control position of the carriage;
a data storage component; and
a computer control system configured to:
   map a blade shape of a skate blade, and
   perform a profile operation, wherein the profile operation comprises translating the grinding wheel along the bottom of the skate blade to selectively remove material from the skate blade to match a defined blade shape.

Clause 23. The computer-controlled skate blade profile system of clause 22, wherein the computer control system is further configured to store operational data associated with a profile operation.

Clause 24. The computer-controlled skate blade profile system of clause 23, wherein the computer control system is further configured to analyze the operational data based at least in part on an operational algorithm, and modify one or more operational parameters associated with the profile operation based at least in part on the analysis.

Clause 25. The computer-controlled skate blade profile system of clause 23, wherein the computer control system is further configured to provide the operational data to a remote computing system.

Clause 26. The computer-controlled skate blade profile system of clause 25, wherein the remote computing system is configured to:
aggregate operational data from a plurality of profile systems
analyze the aggregated operational data; and
update one or more operational algorithms or models.

What is claimed is:

1. An ice skate blade measurement device comprising:
a frame configured to couple to an ice skate blade;
a measurement system configured to obtain measurement data associated with the ice skate blade; and
a control system with computer-executable instructions configured to, when executed:
determine, one or more measurements associated with geometry of the ice skate blade, and
generate, an output based at least in part on the one or more measurements.

2. The measurement device of claim 1, wherein the geometry comprises edges of the ice skate blade.

3. The measurement device of any preceding claim, wherein the output is displayed on a screen of the measurement device.

4. The measurement device of any preceding claim, wherein the output comprises a visual indication on the measurement device.

5. The measurement device of any preceding claim, wherein the output is transmitted to and displayed on a remote computing device.

6. The measurement device of any preceding claim, wherein the output is transmitted to and displayed on a remote skate sharpening device.

7. The measurement device of any preceding claim, wherein the computer-executable instructions are further configured to, when executed:
transmit, instructions for adjusting a skate sharpening device, the instructions determined based on the one or more measurements.

8. The measurement device of claim 7, wherein the instructions include modifications to a position of a grinding wheel of the skate sharpening device.

9. The measurement device of claim 8, wherein the position of the grinding wheel is determined based on a desired edge modification to the edges of the ice skate blade.

10. The measurement device of claim 9, wherein the edge modification comprises sharpening the edges of the ice skate blade such that the edges have an equal height.

11. The measurement device of any preceding claim, wherein the frame further comprises a blade slot, the blade slot configured to receive the ice skate blade.

12. The measurement device of claim 11, further comprising a securing mechanism, the securing mechanism configured to secure the ice skate blade within the blade slot.

13. The measurement device of claim 12, wherein the securing mechanism comprises a fastener, the fastener configured to extend through a portion of the frame and into the blade slot, an end portion of the fastener configured to contact a side of the ice skate blade.

14. The measurement device of claims 11-13, wherein the measurement system further comprises a tilt bar, the tilt bar comprising a top portion and a bottom portion.

15. The measurement device of claim 14, wherein the top portion of the tilt bar further comprise a reflective surface.

16. The measurement device of claim 14 or 15, wherein the bottom portion of the tilt bar extends into the blade slot in a first configuration.

17. The measurement device of claim 16, wherein tilt bar is configured to move into a second configuration when the ice skate blade is secured within the blade slot.

18. The measurement device of claim 17, wherein the tilt bar is supported by the edges of the skate blade via the bottom portion when the tilt bar is in the second configuration.

19. The measurement device of claims 14-18, wherein the tilt bar further comprises a magnet.

20. The measurement device of claim 19, wherein the tilt bar is magnetically coupled to the ice skate blade in the second configuration.

21. The measurement device of claim 19 or 20, further comprising one or more ferrous pins, wherein the tilt bar is configured to magnetically couple to the one or more ferrous pins in the first configuration.

22. The measurement device of claim 21, wherein the one or more ferrous pins comprise a first pin and a split pin, the split pin comprising a second pin and a third pin.

23. The measurement device of claim 21 or 22, wherein the one or more ferrous pins are coupled to the frame near the blade slot.

24. The measurement device of claim 23, wherein the securing mechanism is configured to extend through a gap between the second pin and the third pin.

25. The measurement device of any preceding claim, wherein the measurement system further comprises a light emitting source and a sensor.

26. The measurement device of claim 25, wherein the light emitting source comprises a laser.

27. The measurement device of claim 26, wherein the laser is configured to direct a laser beam towards the reflective surface of the tilt bar.

28. The measurement device of claim 27, wherein sensor is configured to receive a reflected laser beam from the tilt bar.

29. The measurement device of claim 28, wherein the one or more measurements associated with edges of the ice skate blade are determined based on a location of the reflected laser beam on the sensor.

30. The measurement device of claim 29, wherein the measurement system further comprises one or more of a filter and a lens, wherein the filter is configured to filter at least the laser beam and the lens is configured to receive the reflected laser beam.

31. The measurement device of claim 30, wherein the one or more measurements comprise an angle of the tilt bar, the angle of the tilt bar determined by a relative height between an inside edge and an outside edge of the skate blade.

32. The measurement device of any preceding claim, wherein the one or more measurements comprise a relative height between an inside edge and an outside edge of the skate blade.

33. The measurement device of any preceding claim, further comprising an external housing, the frame positioned at least partially within the external housing.

34. The measurement device of claim 33, wherein the external housing comprises a plurality of resilient members extending into the frame, wherein the resilient members are configured to allow the frame to move relatively to the external housing.

35. The measurement device of any preceding claim, wherein the frame further comprises a laser aperture, the laser aperture configured to limit a size of the laser beam.

36. The measurement device of claim 25, wherein the light emitting source comprises a line laser, the line laser configured generate a line laser beam directed towards the edges of the skate blade, wherein the sensor is configured to receive a reflected line laser beam from the skate blade.

37. The measurement device of claim 36, wherein the one or more measurements comprises depth information related to the skate blade.

38. A method of measuring ice skate blade edges, the method comprising:
coupling an ice skate blade to a measurement device;
determining one or more measurements associated with geometry of the ice skate blade; and
generating an output based on the one or more measurements.

39. The method of claim 38, wherein the geometry comprises edges of the ice skate blade.

40. The method of any of claim 38 or 39 further comprising displaying the output on a screen of the measurement device.

41. The method of any of claims 38-40, wherein the output comprises a visual indication on the measurement device.

42. The method of any of claims 38-41 further comprising transmitting and displaying the output on a remote computing device.

43. The method of claim 42, wherein the output is transmitted to and displayed on a remote skate sharpening device.

44. The method of any of claims 38-43 further comprising transmitting, instructions for adjusting a skate sharpening device, the instructions determined based on the one or more measurements.

45. The method of claim 44, wherein the instructions include modifications to a position of a grinding wheel of the skate sharpening device.

46. The method of claim 45, wherein the position of the grinding wheel is determined based on a desired edge modification to the edges of the ice skate blade.

47. The method of any of claims 38-46, wherein determining the one or more measurements comprises:
directing a light beam towards the reflective surface of a tilt bar,
receiving, by a sensor, a reflected light beam from the tilt bar, and
determining the one or more measurements associated with edges of the ice skate blade based on a location of the reflected light beam on the sensor.

48. The method of any of claims 38-46, wherein the one or more measurements comprises depth information related to the skate blade.
